(19) United States
(12) Patent Application Publication
(10) Pub. No.: US 2016/0232546 A1
(43) Pub. Date: Aug. 11, 2016

(54) COMPUTER PROCESSING OF FINANCIAL PRODUCT INFORMATION AND INFORMATION ABOUT CONSUMERS OF FINANCIAL PRODUCTS

(71) Applicant: Connect Financial LLC, Wellesley, MA (US)

(72) Inventors: Joseph Thomas Ranft, Brookline, MA (US); Sean Collins, Wellesley, MA (US); Kerri Ann Moriarty, Brookline, MA (US); Charles F. Baker, IV, Brookline, MA (US)

(21) Appl. No.: 14/989,935

(22) Filed: Jan. 7, 2016

Related U.S. Application Data
(63) Continuation-in-part of application No. 14/304,633, filed on Jun. 13, 2014.

(51) Int. Cl. G06Q 30/02; G06Q 40/02

(52) U.S. Cl. CPC G06Q 30/0206; G06Q 40/025

(57) ABSTRACT

Among other things, there is regularly received through a communication network from providers of financial products or from an aggregator or both, current information about transactions that occur in accounts of consumers of financial products that are maintained with providers of the financial products. The received current transaction information is stored in a database of information about the respective consumers. Machine learning is applied to the stored transaction information and other information about the consumers in the database to generate model profiles of transactions in accounts of corresponding categories of consumers for corresponding financial products. As current information about transactions is received, transactions that have occurred in the accounts of the consumers of the financial products are analyzed using the model profiles for the applicable categories of customers and financial products. Each of the consumers for whom transactions occurred that did not conform to the corresponding model profile is alerted through a communication network.

### CROSS-REFERENCE TO RELATED APPLICATIONS

This application is a continuation-in-part of application Ser. No. 14/304,633, filed Jun. 13, 2014, the entire contents of which are incorporated here by reference.

### BACKGROUND

A financial product includes a good or a service connected with a way in which an individual manages and uses money. There are various types of financial products, including, e.g., checking and saving accounts, investment accounts, credit cards, mortgages, home, auto, and renters insurance, cell phone devices and plans, cable, internet, and phone plans, health insurance, loan products (e.g., student, personal, auto), and other household utility bills.

### SUMMARY

In general, in an aspect, there is regularly received through a communication network from providers of financial products or from an aggregator or both, current information about transactions that occur in accounts of consumers of financial products that are maintained with providers of the financial products. The received current transaction information is stored in a database of information about the respective consumers. Machine learning is applied to the stored transaction information and other information about the consumers in the database to generate model profiles of transactions in accounts of corresponding categories of consumers for corresponding financial products. As current information about transactions is received, transactions that have occurred in the accounts of the consumers of the financial products are analyzed using the model profiles for the applicable categories of customers and financial products. Each of the consumers for whom transactions occurred that did not conform to the corresponding model profile is alerted through a communication network.

Implementations may include one or combinations of two or more of the following features. The analyzing of transactions includes analyzing large transactions. The alerting of each of the consumers includes prioritizing the large transactions for action by the consumer. The alerting of each of the consumers includes delivering at least one of email, text, push notification, or other messaging medium, or a combination of any two or more of them. It is confirmed with each of the consumers that the transactions are for accounts of the consumer. The analyzing of the transactions includes generating a profile of the consumers based on the database of information about the respective consumers and comparing the profiles of the consumer with the corresponding model profile. The model profiles reflect prices paid by consumers in the respective categories for particular products. The storing of the received transaction information in the database includes identifying financial product providers and transactions that are expected to correspond to the respective consumers and storing those transactions in the database in association with the respective consumers. The categories of the consumers are based on spending behaviors, locations, situations, other attributes, or combinations of two or more of them. The analyzing of the transactions includes identifying an appropriate one of the model profiles that corresponds to each of the consumers. There is training or tuning of a machine learning environment to improve accuracy of the identification of the appropriate model profile. Based on changes in the information about the respective consumers, transactions that have occurred in the accounts of the consumers of the financial products are again analyzed using the model profiles for the applicable categories of customers in financial products.

In general, in an aspect, current data related to prices available in a competitive market for a financial product is regularly received through a communication network. Information about a prospective customer of the financial product is stored in a database. The information includes attributes of the consumer that relate to the financial product. Based on the attributes of the consumer with respect to the market prices for the financial product, a putative price for the financial product is generated by computer. The putative price represents a price that the consumer ought to be willing to pay for the product in the competitive market.

Implementations may include one or combinations of two or more of the following features. The price includes fixed and variable costs to engage in a transaction for the financial product. The information about attributes of the consumer that relate to the financial product includes current products held by the consumer, credit characteristics of the consumer, or anonymized characteristics and needs of the consumer, or combinations of any two or more of them. The putative price includes an optimum or likely lowest price. The putative price is regenerated as current data about prices is received. The regular receiving of current data includes receiving current data from multiple sources, the current data including market surveys, purchased data, wholesale prices, proprietary research data, or a combination of two or more of them. The regular receiving of current data includes use of an API, episodic direct file transfer, a software bridge, manual input, or a combination of any two or more of them. The storing in a database of information about a prospective consumer of the financial product includes receiving information from multiple sources, the information including credit bureau data, underwriting criteria, the consumer's product and personal preferences, data provided from third parties concerning the consumer's financial condition and preferences, location-based information about the consumer, or a combination of any two or more of them. The stored information is transformed by computer into pricing factors based on the financial product. The transforming includes quantifying and weighting parts of the information and combining them into a score. The score is applied by a computer to a table to select the putative price. The generating of the putative price includes applying machine learning processes to cluster and group financial products and profiles of consumers.

In general, in an aspect, information is received from a consumer through a communication network that is indicative of a request for a putative underwriting decision on a financial product. An access is made as a non-provider of the financial product, through a communication network, to a credit bureau, for certain information that a provider of the financial product would use in making an actual underwriting decision on the financial product for the consumer. The putative underwriting decision is generated by a computer using the information from the credit bureau and personal information about the consumer that has been stored in a database. The putative underwriting decision simulates aspects of the actual underwriting decision in the financial product for the consumer. A report of the putative underwriting decision is reported to the consumer through a communication network.

Implementations may include one or combinations of two or more of the following features. The accessing of the credit bureau as a non-provider of the financial product does not affect a credit reputation of the consumer. The financial product includes credit and the underwriting decision includes whether to extend the credit to the consumer. The personal information of the consumer that has been stored in the database includes name, address, income, last four digits of the Social Security number, or a combination of two or more of them. The putative underwriting decision is based on underwriting criteria that include debt to income ratio, past payment performance, credit score, open credit lines, number of inquiries from potential providers of the financial product, or a combination of two or more of them. The putative underwriting decision is generated algorithmically. A machine learning process is applied to cluster and group profiles of consumers and credit reports, and the profiles are matched to approval probabilities. The putative underwriting decision is made by matching an optimal product to a profile of the consumer. The personal information about the consumer that has been stored in a database includes information provided by the consumer required to access a credit bureau, information about the consumer's incumbent product and personal preferences, information about the consumer's financial condition and preferences, location-based data, or a combination of two or more of them.

In general, in an aspect, current information is maintained in a database about a particular consumer. The current information is related to transactions in financial products in which the consumer has engaged or indicative of suitable future transactions in which the consumer may engage. A database of current information is maintained about financial products that are available in a competitive market. The information includes prices and features. A computer is used to generate current putative prices for financial products. The putative price for each of the financial products represents a price that the consumer ought to be willing to pay for the financial product in a competitive market. A selection is made by computer, from the database of current information about financial products that are available in the competitive market, of a set of financial products that conform to the generated putative prices and to the current information about the particular consumer. Information about the selected set of financial products and their putative prices is provided to the consumer through a communication network.

Implementations may include one or combinations of two or more of the following features. The selecting of a set of financial products includes selecting financial products that have the lowest prices, or the best features, or are otherwise optimal. The selecting of the set of financial products is repeated in response to changes in information about the particular consumer or changes in financial products available in the competitive market, or both. The information about the particular consumer includes credit worthiness, geographic location, demographics, or a combination or two or more of them that correspond to possible selections of the set of financial products. The information about the particular consumer includes information about the situation of the consumer including needs for financial products, changes in financial situation, changes in financial products that belong to the consumer. The providing of the information to the consumer includes sending a text, email, push in-application message, or a combination of two or more of them. The selecting of a set of financial products includes matching a combination of preferences and putative prices to optimize putative prices and features of the financial products. The information about the particular consumer is indicative of the suitability for the consumer of certain products available in the competitive marketplace. The selecting of a set of financial products is done algorithmically. The selecting of a set of financial products includes applying a machine learning process to cluster and group profiles of consumers and products, and matching the profiles to products.

In general, in an aspect, interactive user interface elements are served from a server through a communication network to users of two different respective websites. The user interface elements portray financial products that are available on the market to particular customers, the suitability of the financial products for the particular customers, and putative prices for the financial products. The interactive user interface elements are presented with an appearance that conforms to respective branded appearances of other user interface elements that are presented by the respective websites, the respective branded appearances being associated with two different host entities.

Implementations may include one or combinations of two or more of the following features. The relationship between each of the host entities and its particular customers include employer and employee, financial advisors and customers being advised, or an entity whose purpose is to save money for its customers. The user interface elements included within the interactive of user interface are determined at least in part by each of the host entities. The server is operated so that personal information about customers using the websites cannot be accessed by or delivered to third parties. A secured API is exposed through which each of the host entities can access information stored at the server.

In general, in an aspect, input data is maintained that represents known characteristics of consumers of financial products. Output data is generated that represents synthetic good decisions about acquiring or using available financial products or product features. The synthetic good decisions correspond to respective clusters of the consumers based on the input data. Machine learning techniques are applied to develop matching algorithms to match the input data to the output data that represents synthetic good decisions. The developed matching algorithms are used to suggest good decisions about financial products to consumers based on their characteristics.

These and other aspects, features, implementations, and combinations of them will become apparent from the following description and from the claims.

These and other aspects, features, implementations and combinations of them can be expressed as methods, systems, components, methods of doing business, software products, user interfaces, databases, and in other ways.

### DESCRIPTION

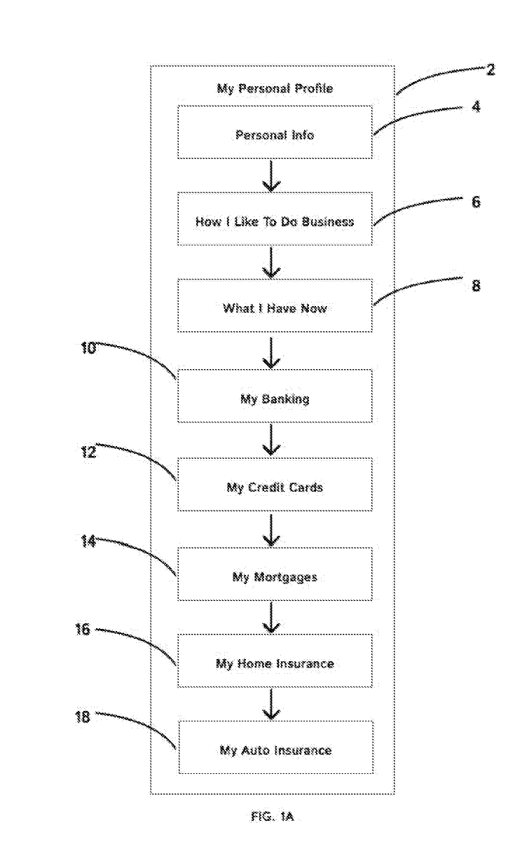

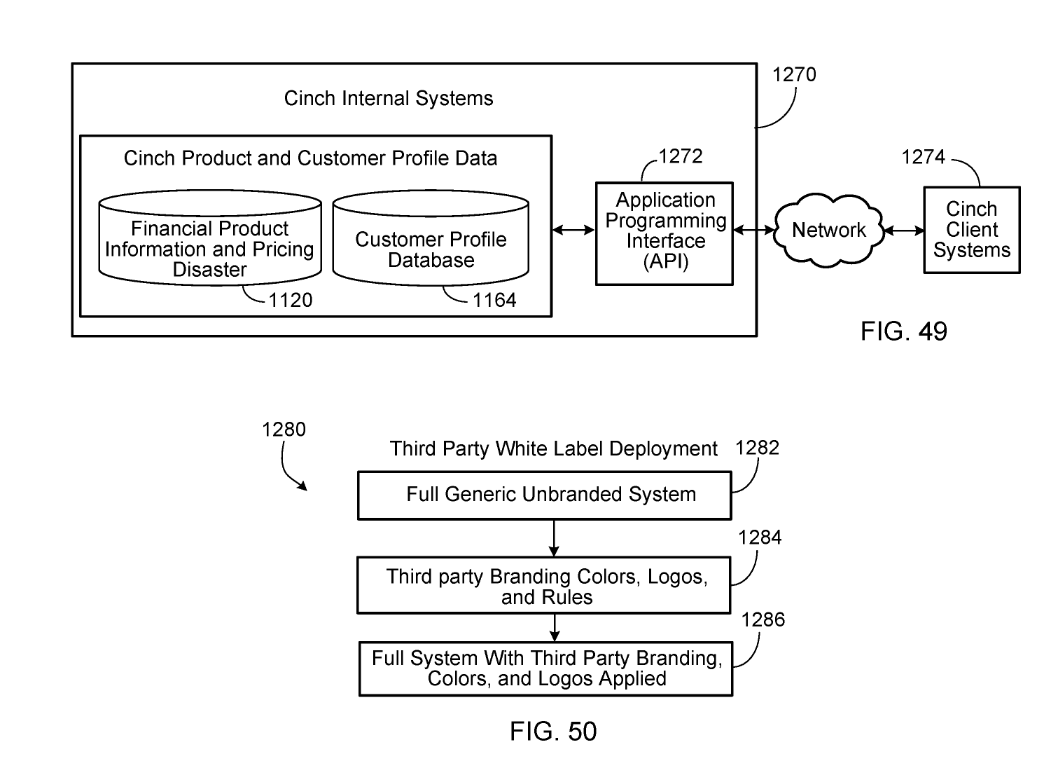

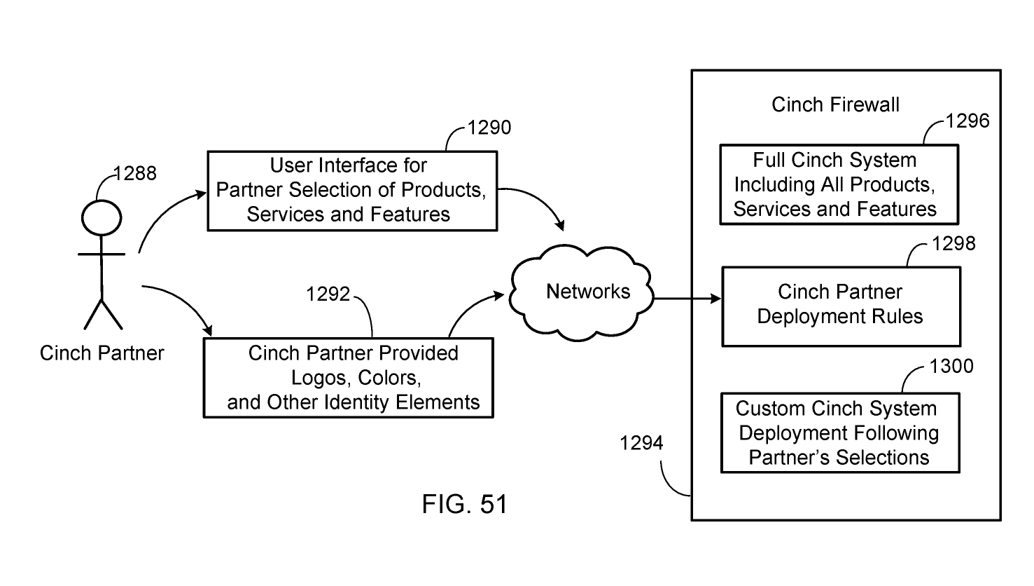

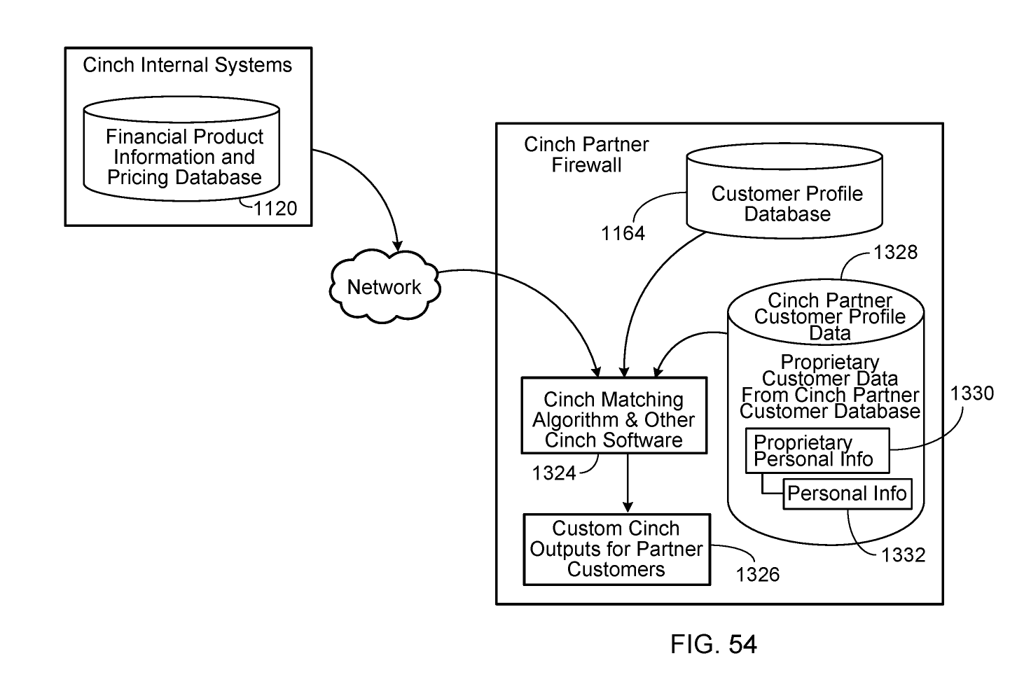

FIGS. 1A-12, 36-43, 49, 51, and 54 are diagrams of environments for providing users with financial product information.

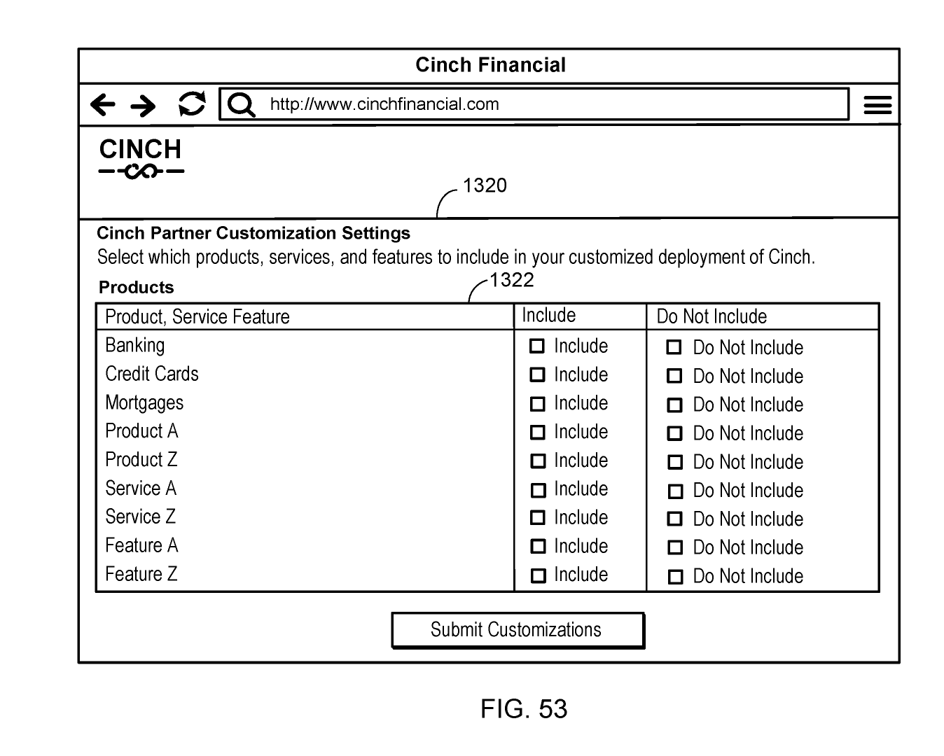

FIGS. 13-28, 45-48, and 53 are diagrams of graphical user interfaces for providing users with financial product information.

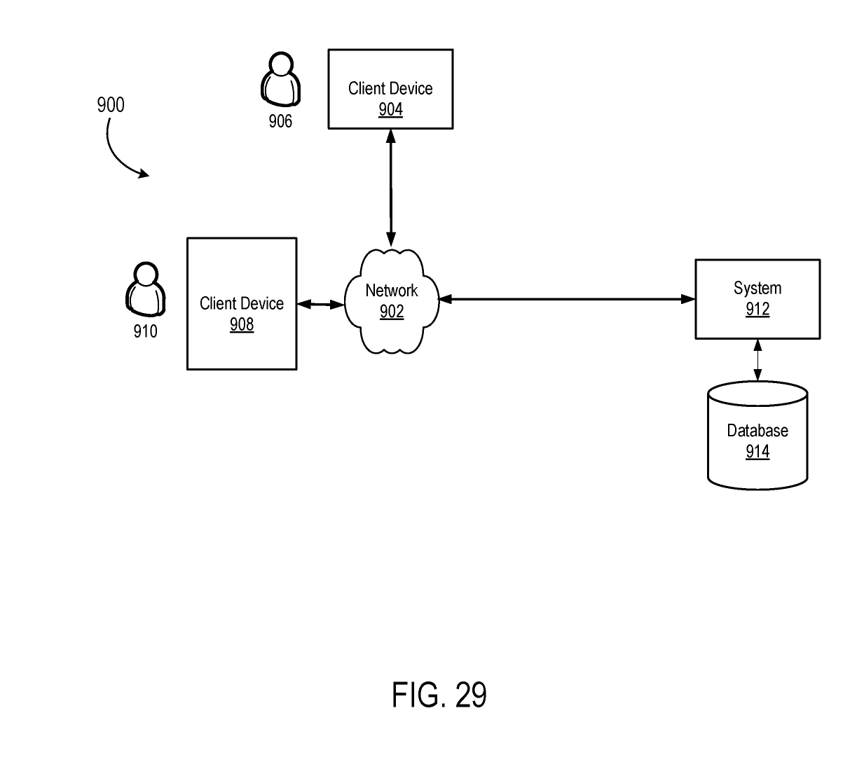

FIG. 29 is a block diagram of a system for analyzing financial products.

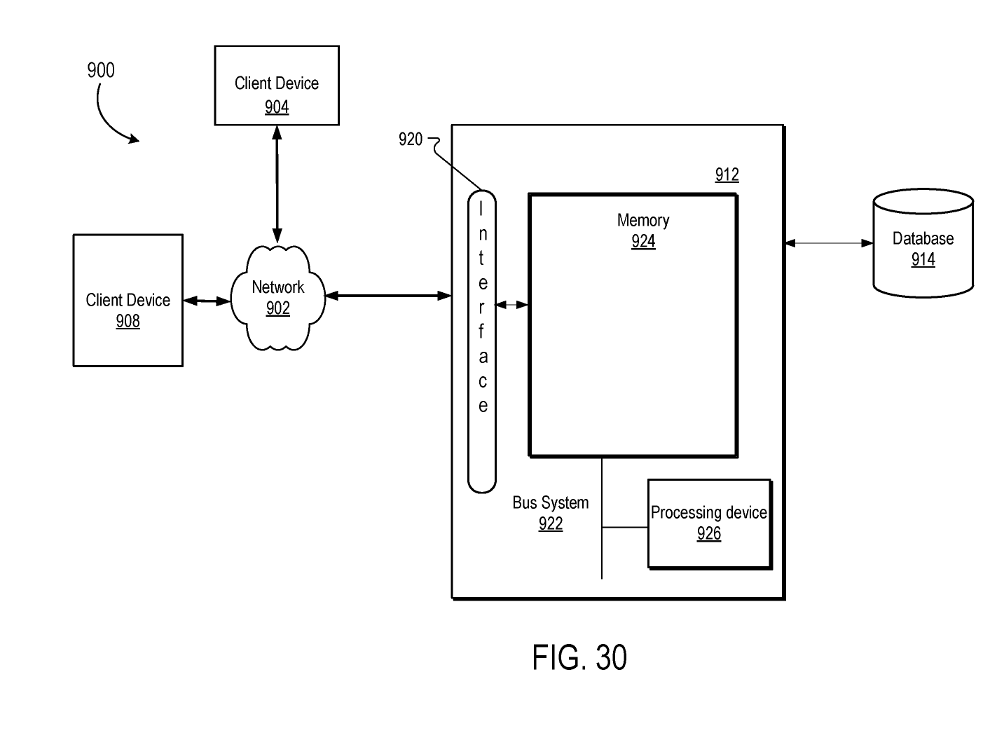

FIG. 30 is a block diagram of components of a system for analyzing financial products.

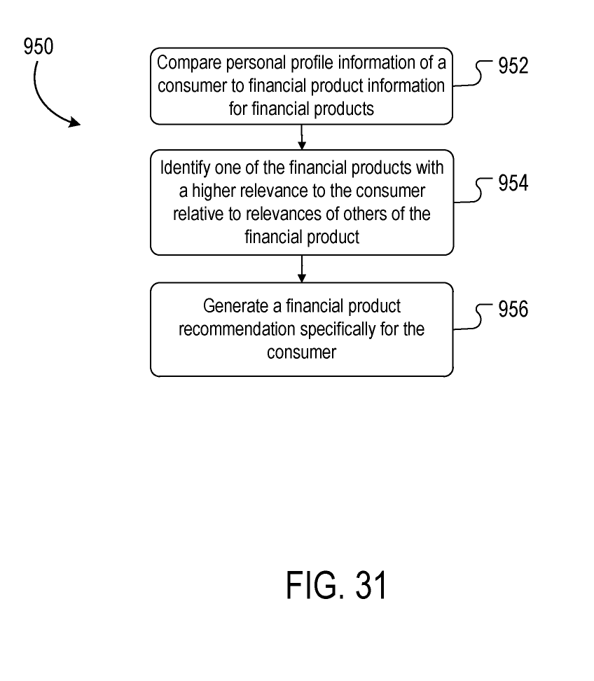

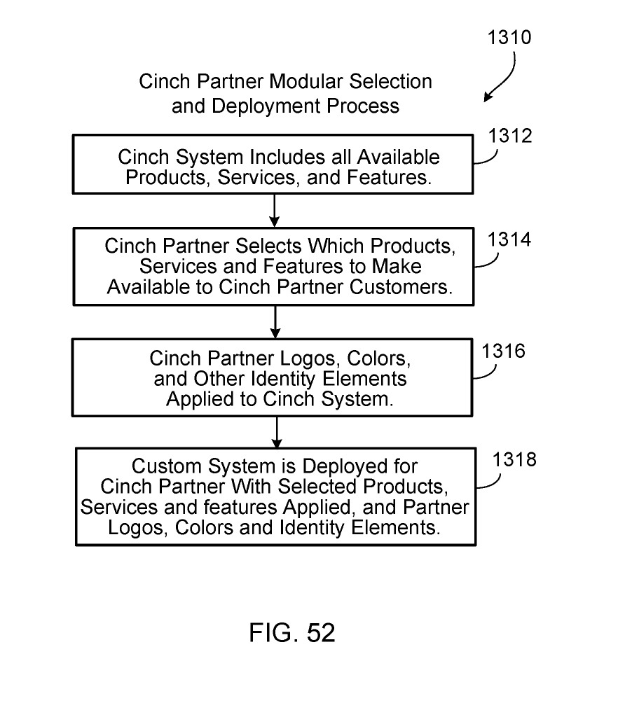

FIGS. 31-35, 44, 50, and 52 are flow charts of processes executed by a system for analyzing financial products.

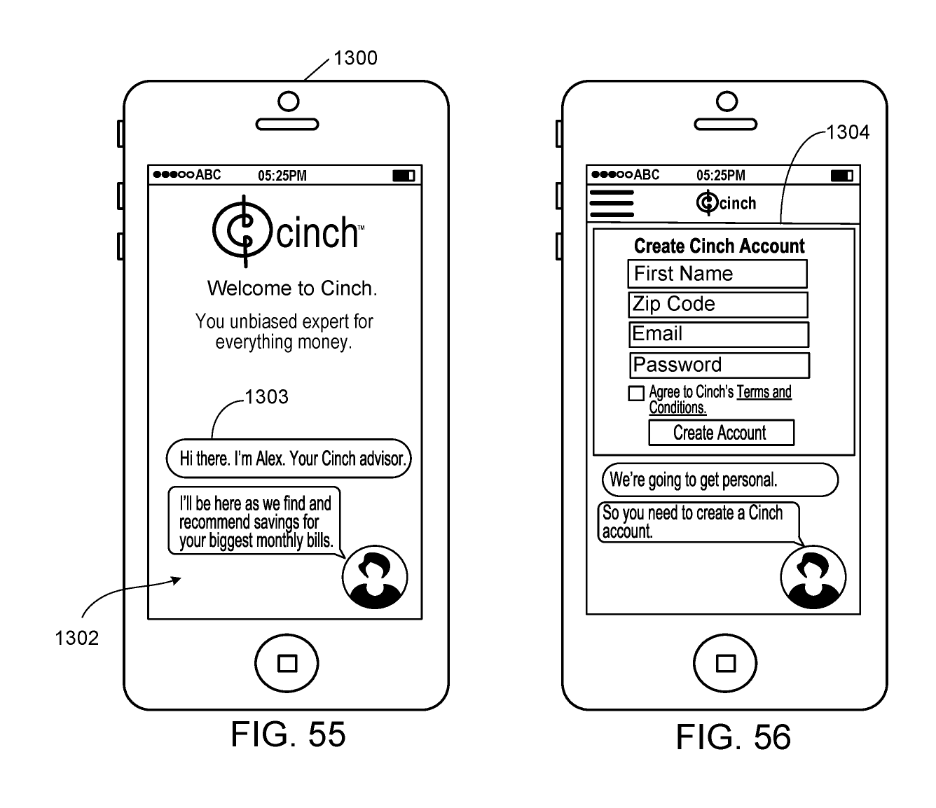

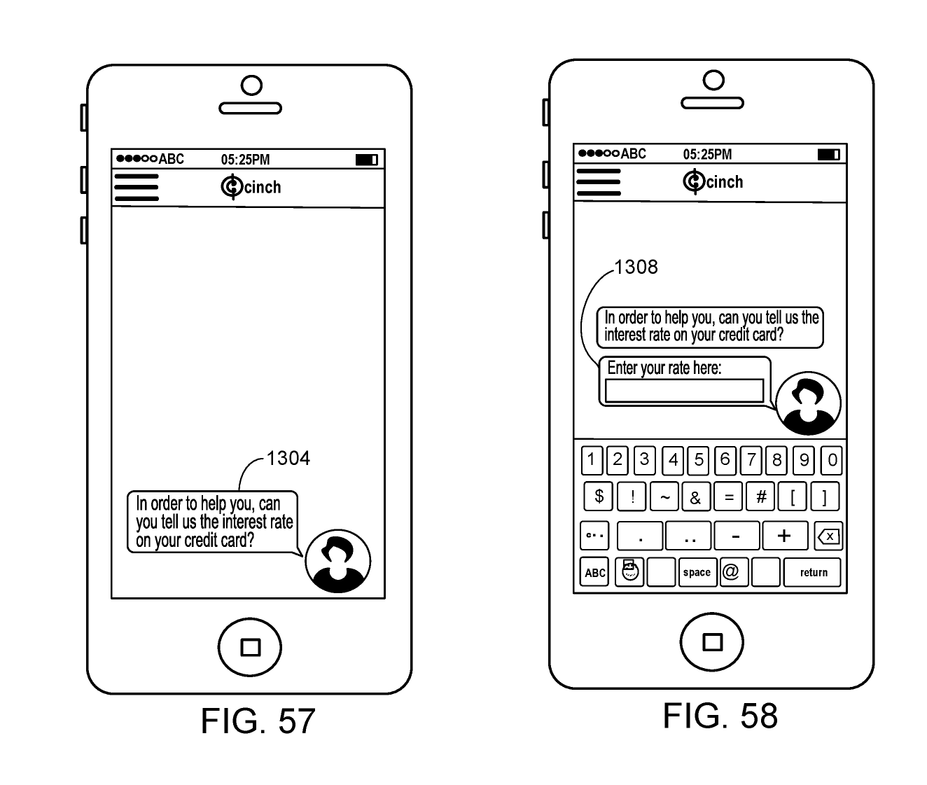

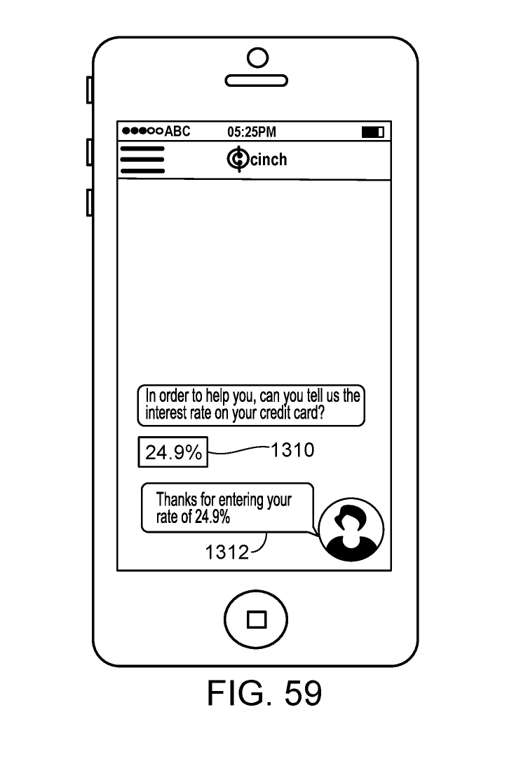

FIGS. 55 through 59 are screen shots of a mobile device.

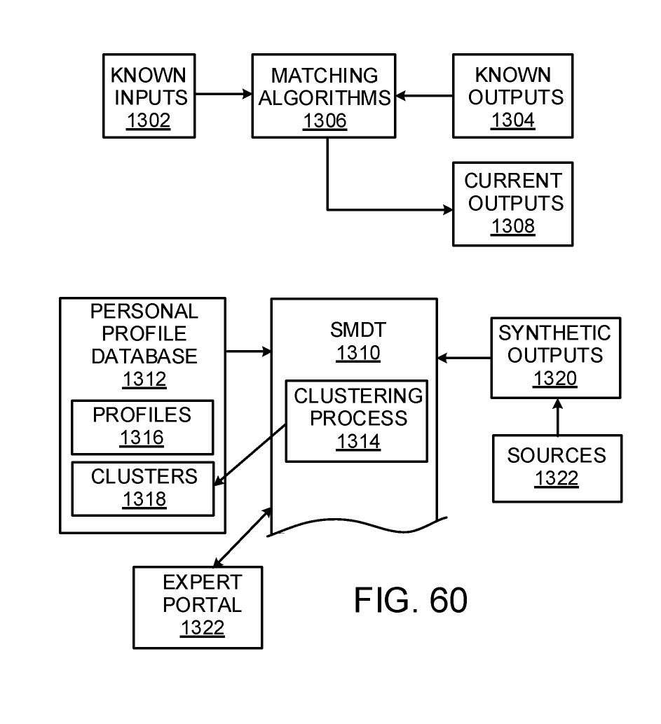

FIG. 60 is a block diagram of machine learning.

In some implementations of what we describe below, users are provided with automated, unbiased curating, matching, rating, or scoring (or combinations of those) for financial products and providers of financial products. In some implementations, the features or functions or applications (or combinations of them) described below serve as an automated, unbiased, and expert financial advisor or robot for users. In some cases, the features, functions, or applications are exposed to the user on a mobile device through a mobile app. In some examples, the automated, unbiased, and expert financial advisor or broker can be personified as a personified smart robot, for example, a robot called Alex who engages in a natural interaction with the user.

Thus, while some of what we describe below relates fundamentally to matching of financial products to characteristics of users, these matching functions can be incorporated in and part of the foundation for the automated, unbiased, and the first financial advisor or robot mentioned above.

Referring to FIG. 1, graphical representation 2 of a personal profile is shown. Graphical representation 2 displays the various types of information that are included in a personal profile, including, e.g., personal information 4, business preference information 6, current holding information 8, banking information 10, credit card information 12, mortgage information 14, home insurance information 16, and auto insurance information 18.

In an example, a user completes a personal profile through a series of graphical user interface (GUI) screens. A personal profile includes information related to a user's personal information, information indicative of financial products associated with the user, and preferences for how the user likes to do business.

We use the term “financial products” broadly to include for example, any product or service offered to or used by consumers that involve, for example, ongoing periodic payments by consumers to suppliers, or financial characteristics, or ongoing transactional relationships between consumers and suppliers or of any combination of two or more of them. Financial products, e.g., checking and saving bank accounts, investment accounts, credit cards, insurance policies, mortgages, home, auto, and renters insurance, cell phone devices and plans, cable, internet, and phone plans, health insurance, loan products (student personal, auto), and other household utility bills, to name a few.

Preferences include what products the user currently has, what the user needs at a given moment in time, how he/she likes to do business with current financial product providers, and how he/she would like to do business with financial product providers in the future. We use the term financial product providers broadly to include, for example, any party that provides any kind of financial product, or a financial product embedded within another product (e.g. a cell phone financing offer tied to the service; a financing offer tied to the purchase of a vehicle, etc.), not limited to banks, insurance companies, lenders, or other financial services companies and institutions.

The first GUI screen is for entering personal information 4, such as name, address, zip code, occupation, income, and similar information that is independent of financial products.

On the next GUI screen, the user enters business preference information 6, e.g., information specifying how the user likes to do business with financial companies. This type of information specifies whether the user prefers to do business in person, at a branch office, over the phone, via the Internet, etc.

The next GUI screen is for the user to enter current holding information 8 that indicates which financial products the user currently holds. Financial products would include their current credit cards, bank accounts, mortgages, home insurance, auto insurance, and other financial products. Next, the user would enter banking information 10 about the user's current bank accounts. This type of information would include the name of the banking institution, how they use their bank, and other details about the banking services the user currently receives. Next, the user enters credit card information 12 about the user's current credit cards. This type of information includes the name of the credit card and credit card institution, interest rates, current balances, rewards systems, how they use their credit cards, and other details about the credit cards the user currently uses.

The next GUI screen is for entering mortgage information 14 about the user's current mortgages. Mortgage information includes property information including address and property value, mortgage information including lending institution, original mortgage amount, interest rate, mortgage terms, amount currently remaining on mortgage, and other related mortgage information.

The next GUI screen in the process is for the user to enter home insurance information 16 about the user's current home or renter's insurance. This type of information includes the name of the insurance provider, the current premium, and the current coverage.

The next GUI screen is for the user to enter current auto insurance information 18, including the name of the insurance provider, the premium amount, and the current coverage. In a variation, the personal profile includes other types of information, including, e.g., information about other products, such as investments, health insurance, utilities, and cell phone plans.

In some implementations, the kinds of information that are described above as being entered by a user through a GUI screen need not be manually entered but can be picked up automatically by the system connecting to, for example, online accessible accounts of the user, with authorization from the user.

As shown in FIG. 1B, after some or all of the personal profile information is completed by the user, this information is stored in a customer profile database 22. The schema for this database includes tables that correspond to each of the types of information included in the personal profile, including e.g., a personal information table 24 for storing personal information 4, business preference table 26 for storing business preference information 6, current holding table 28 for storing current holding information 8, banking information table 30 for storing banking information 10, credit card table 32 for storing credit card information 12, mortgage information table 34 for storing mortgage information 14, home insurance information 36 for storing home insurance information 16, and auto insurance information 38 for storing auto insurance information 18. As discussed later, in some implementations, additional or different information related to personal profiles can be stored in tables of the customer profile database 22 and used by the system for various purposes. Such information can be gathered from different or other sources than the consumers themselves, as also discussed later.

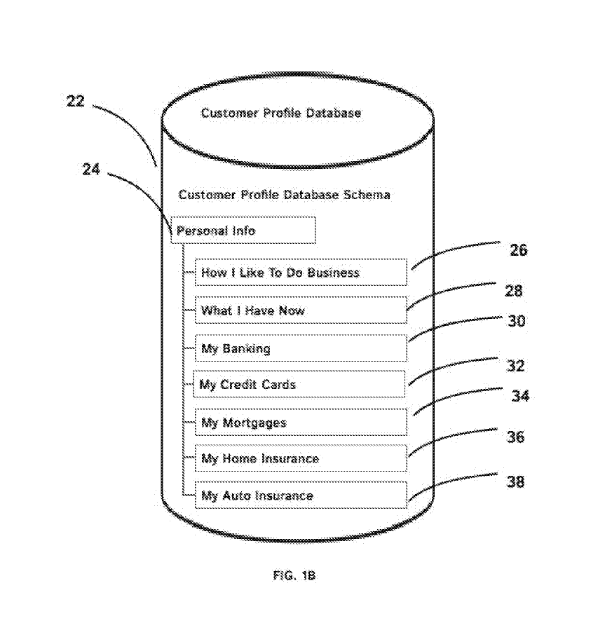

Referring to FIG. 2, data about financial products is collected from multiple external data sources 50, transferred via a network 54, and stored in a financial product information database 56 (through a system). In operation, a system (not shown) collects external financial product data 52 from various external and internal data sources. This data includes information about the products and pricing currently offered to consumers for bank accounts, credit cards, mortgages, home insurance, auto insurance, and other financial products. The system used to collect the data depends on its source. External data providers providing information about a specific product (e.g. taxes and fees on a specific mortgage in a specific location) may offer an API link to call the required data into the system, where it is stored and presented to the user through a database and computing software. Some information sources may be delivered as a Common Separated Values (CSV) file, which allows column-based data sorting by a spreadsheet package or similar software program. Information collected manually (as described below) may be entered into electronic forms, which are then arrayed through a software interface into a relational database or CSV file. Each of these source inputs on a given product or provider are then transmitted to a centralized data storage through a network for further analysis and eventually, to be added to an inventory database as potential matches for the recommendation engine.

There are various types of data sources, including, e.g., databases purchased from third parties, data collected independently by staff, data gathered from customers of financial providers via surveys, telephone calls, and interviews, data gathered from interviews of financial product providers, data gathered from social media sentiment, and data from independent news and information sources. As discussed later, additional or other data sources can be used to obtain information about financial products and the parties who provide them.

The network 54 includes the Internet and any other means of transferring this data into a financial product information database 56.

This financial product information database 56 includes the following scheme for an individual financial product: a product name table 58, a product provider table 60 for specifying the name of the provider, address, contact information, and unique internet link to the provider's product webpages, a product pricing information table 62, which includes the current and historical pricing or rate information for a product, a description of product table 66, which includes an overview about the product, its unique characteristics designed for specific users, and any other information that a consumer may find interesting about the product, and other product information table 68, which would include other information from internal and external financial product data sources that contain information required to or useful in making a specific match to a specific user, e.g., the availability of a branch office, which on the one hand, may be a requirement for User A, or alternatively, for User B, may be something she neither needs nor values.

There are various types of financial products including bank accounts, credit cards, mortgages, home insurance, and auto insurance, as mentioned earlier. Financial products can include, for example, a financial product embedded within another product (e.g., a cell phone financing offer tied to the service; a financing offer tied to the purchase of a vehicle, etc.). In some implementations, discussed later, additional or other tables can be part of the product information database and be used for a variety of purposes.

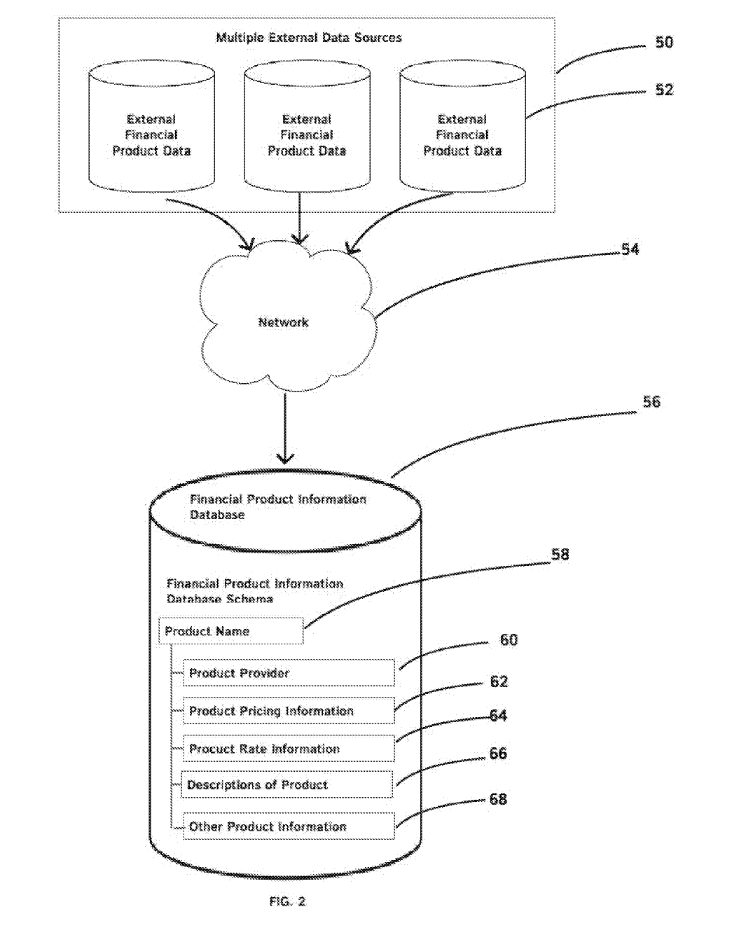

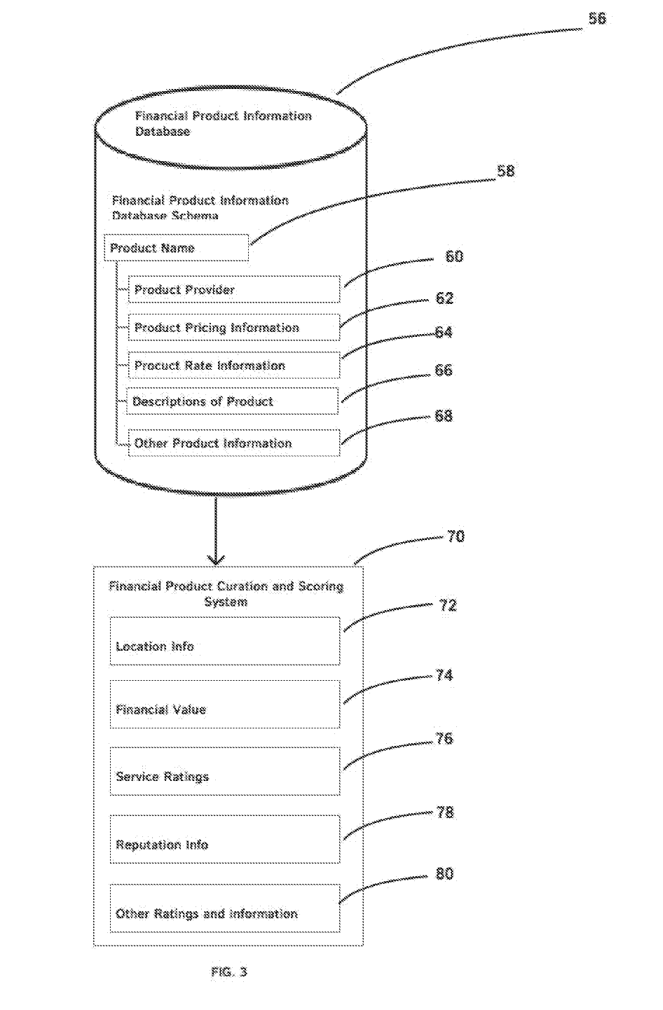

Referring to FIG. 3, the information found in the financial product information database 56 is appended (e.g., by a system) with scores and ratings from a financial product curation and scoring system 70, which is used later for generating a unique rating for each financial product. Financial product curation and scoring system 70 includes a rating and score for attributes of individual financial products and financial product providers, including but not limited to ratings for location, financial value, service ratings, reputation, product features, and will go other ratings information. Significantly, the financial product curation and scoring is done without bias towards any type of product, any product provider, or any other factor or parameter unrelated to the consumer. For that reason, the curation and scoring, and the resulting scores and ratings can garner a high level of trust in the marketplace and among users and provide useful and credible information for the marketplace and those users.

Location information rating 72 includes a rating score indicative of how appropriate the product or provider being rated is for a consumer based on the consumer's location.

Financial value rating 74 is a rating score based on the financial value related to pricing, rate and other financial considerations for the product that would be relevant to a consumer.

Service ratings 76 are ratings and scores related to how well the company performs customer service over the telephone, in person, at branches and offices, over the internet, and any other service channels at which the company does business and which are determined that consumers find value.

Reputation information rating 78 includes rating and scores based on the provider's reputation as determined by what other customers of a company say about that company and how it is to do business with the company, as well as third-party ratings systems and how they rate the company.

Other ratings information 80 includes ratings that are specific to product types, such as rating categories specific for a credit card that would not be appropriate for other financial products, or rating categories for a mortgage that might not be appropriate for other products.

Referring to FIG. 4, curated and scored financial product information database 84 is an updated version of database 56 (FIG. 3), in which the curation, scoring and ratings have been added. The system curates, scores, and rates products by starting with the universe of thousands of available products and providers in each product category. These are then filtered according to which locations (states, zip codes, counties, cities) in which each product is offered, then apply a filter through which pass only the established and legitimate providers, then we apply a further filter to identify companies that do a significant amount of business in a given geographic location, and then we filter on criteria that determine customer value, such as price, interest rates, fees, etc. Other filters are also applied, including product incentives offered consumers, benefits such as warranties and insurance, and the overall reputation of the product and provider. A scoring rubric is then applied to determine a score on a scale of 0 to 100, as described in further detail below.

The curated and scored financial product information database 84 includes the following tables for a particular financial product and/or financial product provider. These tables include: the product name table 84, the product provider table 86 for storing the product provider name and information such as address and contact information, product pricing information table 88 for storing information indicative of rates and prices, product rate information table 90 for storing information including interest rates and fees charged for a product, description of product table 92 for storing information indicative of an overview description about a financial product or provider, location information table 94 for storing information specifying geographical locations such as states, cities and zip codes that the product is of the highest value and the rating for this product in certain geographical locations, the financial value rating table 96 which specifies how the product has been scored and rated, a service ratings table 98, which includes the service ratings, a reputation info ratings table 100, which would include the rating and scoring information entered into the system for a product reputation, and other ratings and information table 102 which would include any other ratings entered into the system.

This information from the curated and scored financial product information database 82 is displayed on a client device as a consumer GUI 104 via a network, which may include the Internet or other networks that convey information to the user. This consumer GUI 104 is rendered via web pages, mobile phone applications and website, and other content accessible by consumers over public networks. Consumer GUI 104 displays highly rated financial products 106, e.g., financial products with increased relevance to the consumer, relative to relevance of other financial products to the consumer. In an example, a rating for a financial product is determined by summing or averaging a service rating or a financial value rating, as described in further detail below. Highly rated products and companies are determined by a blended rating of the product and company value, incentives for consumers, benefits and perks for consumers, and overall reputation based on consumer opinions and expert ratings. The content pages listing highly rated financial products include the information stored in the curated and scored financial product information database 82 for the particular financial product that is highly rated. Depending on the user's specific needs, preferences, and situation, these provider and product ratings may have no, some, or significant impact to the matching system (described below). For example, a provider may be highly rated because it offers face-to-face services in branch locations, but that high rating is relevant only to those users that value face-to-face service interactions. The matching and recommendation system renders and displays to the user those idiosyncratic selection factors based on her preferences and situation.

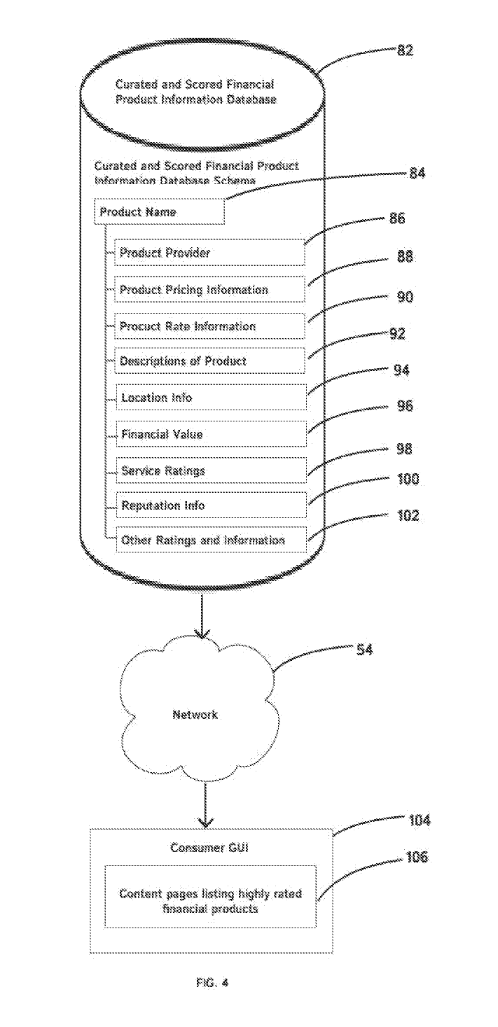

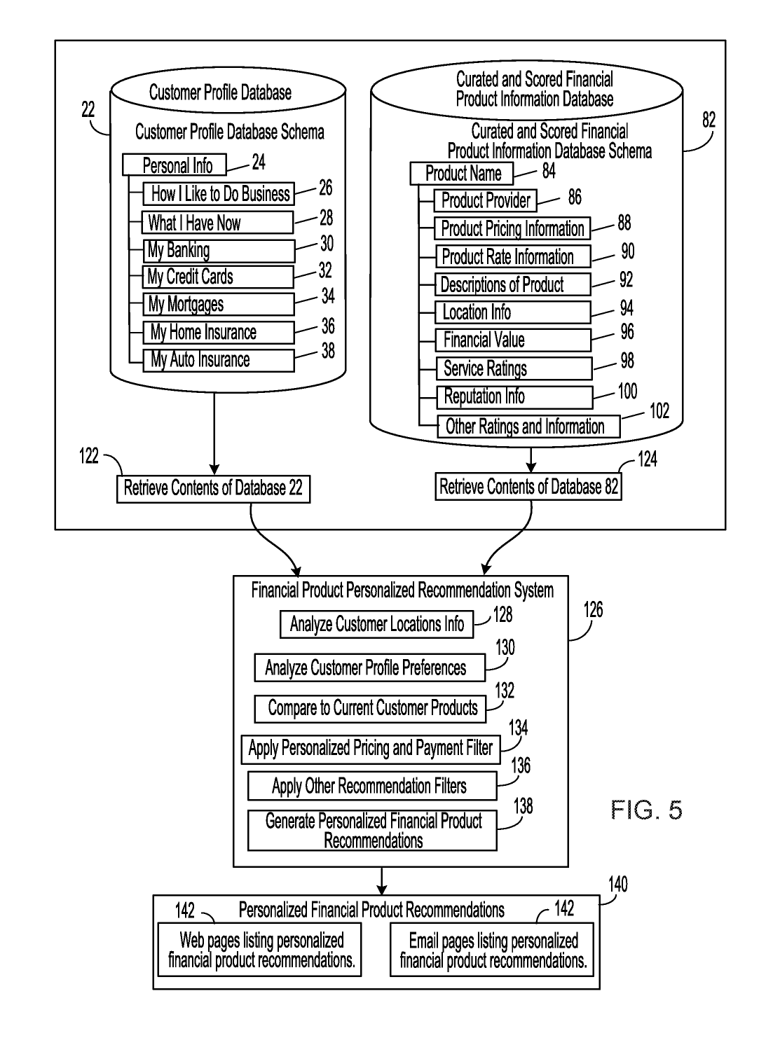

FIG. 5 shows a financial product recommendation process 120 in which the customer profile database 22 and the curated and scored financial product information database 82 are combined through a financial product personalized recommendation system or engine 126 (including one or more algorithms), which in turn generates financial product recommendations and the reasons they were chosen, for a specific consumer.

Process 120 is implemented by a system (not shown). In operation, the system retrieves (122) the attributes in the customer profile database 22 and retrieves (124) attributes of the curated and scored financial product information database 82, eliminating products in the curated and scored financial product information database 82 that are not appropriate for the consumer based on their customer profile database 22, as described in detail below. The resulting set of personalized financial product recommendations 140 is a customized subset of the original curated and scored financial product information database 82.

Financial product personalized recommendation engine 126 generates these recommendations 140. In operation, engine 126 analyses (128) customer location information (for example, where the consumer lives and works as specified in personal information table 24) and analyses (130) the customer profile preferences (as specified in business preference table 26). Engine 126 compares (132) customer location information and profile preferences to current customer products (if entered by the consumer and as specified in table 28) and attributes of various financial products and applies (134) a personalized pricing and credit filter, which eliminates products based on the pricing and credit situation and needs completed by the consumer and stored in the customer profile database 22 and the attributes of the financial products.

In this example, products are eliminated when there is a mismatch between a consumer preference and an attribute of a financial product, e.g., when a financial product is unable to meet the needs and/or preferences of the consumer. In an example, financial products that the consumer does not currently or that the consumer has indicated a need for are recommended. Pricing needs may include the minimum savings required by the consumer to change product providers or product types, or modifications to the current product the consumer has, or other thresholds.

Matching is generated by an algorithm that takes into account the consumer's location, budget, spending habits, credit score, family situation, preferences for conducting business both online and in person, occupation, age, debt situation, and other personal financial situations. This recommendation process would also be duplicated according to a schedule determined the consumer. For example, a consumer could choose to have products recommended monthly. This process, which is a monitoring process, would then occur each month, with the consumer receiving a notification that new recommendations have been generated by the system. Alternatively, based on information provided by a mobile application, or through other data linked to the user (e.g., a change in shopping habits, or change in product usage perceived by the system via linkage to the account), the system will determine that the current products held by the user are a mismatch, perhaps resulting in a too-high price given the change in location or situation, of which the user may be totally unaware. The system perceives that mismatch and alerts the user proactively based on inputs the system has passively collected to help optimize the user's situation.

Engine 126 also applies (136) other recommendation filters. Based on application of the filters, engine 126 generates (138) a personalized financial product recommendation 140, which may be presented or transmitted to consumers on web pages listing personalized financial product recommendations 142, e-mail pages listing personalize financial product recommendations 144 as well as other software applications listing these recommendations. Process 120 is implemented periodically (e.g., on an ongoing basis), based on the preferences of the consumer, changes to the customer profile database described above, changes to the curated and scored financial product information database, and the logic programmed into the system.

Other approaches can be used to match the consumer's interests and needs to products and services and to filter information to be presented to the consumer, including machine learning implementations that we describe later.

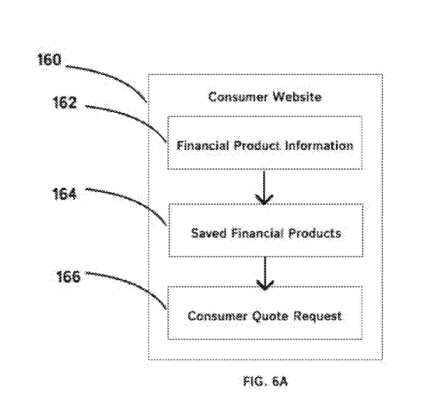

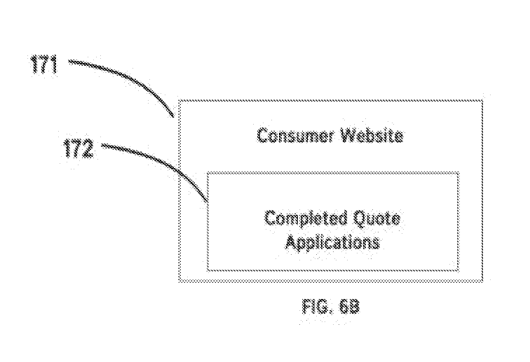

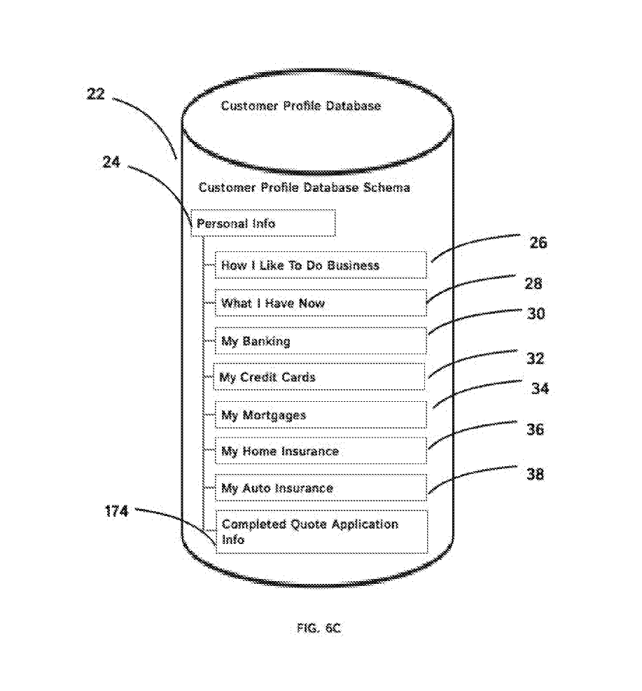

Referring to FIG. 6A, a graphical representation 160 of a consumer website or a mobile application (hereinafter “consumer website 160”) is shown. (In many cases, when we refer to websites we also intend to refer to mobile applications.) Consumer website (or mobile application) 160 allows consumers to maintain their anonymity and avoid providing contact information to financial product providers while they secure accurate quotes, quote estimates, and product pricing details that are necessary to make an informed final decision for those products that require an underwriting (e.g., insurance and loan products) in which the provider determines the final price based on user inputs, such as location and creditworthiness, for example, user provided creditworthiness. In existing systems, users must provide personal details and contact information to providers, which in turn can be used to abuse the user's privacy with telemarketing calls, spam emails and texts, and inclusion into the provider's database of prospects.

Consumer website 160 allows consumers to receive multiple price quotes at once, without filling out multiple forms or providing personal contact details. A price quote is the cost or payment for a financial product. For example, a price quote includes the monthly payment amount for auto insurance, or the payment information for a new mortgage. In this example, a consumer visits a consumer website 160 (or similar software application) to provide personal information to receive a price quote on a financial product from a financial product provider. For returning consumers, some or all of this information may be stored in the customer profile database 22 (FIG. 1B), so that the consumer can avoid re-entering information, or sharing personal contact information directly with a provider. This website 160 lists financial product information 162 for individual financial products. The website 160 also lists saved financial products 164, which are products the consumer has indicated an interest in during this or previous usage of the consumer website or similar software application. The consumer website 160 will also generate a request 166, or multiple requests, for a personal price quote from a financial provider. This request is sent over a network to a recommendation system. The recommendation system associates, in database 22, the request with the consumer's profile. The system sends an email or text notification to a client device used by the consumer.

Referring to FIG. 6B, through the notification, the consumer is alerted to visit a consumer website 171 or similar software application to view the completed quote application 172. The consumer approves the completed quote application, which may be for multiple quotes. Information for these consumer quote applications is sent to the recommendation system, which stores the completed quote application in database 22. Referring to FIG. 6C, customer profile database 22 is updated with, complete quote application information table 174 to store the complete quote application information. As described later, in some implementations additional or other features can enable the consumer to provide other information that is stored in other tables in the customer profile database.

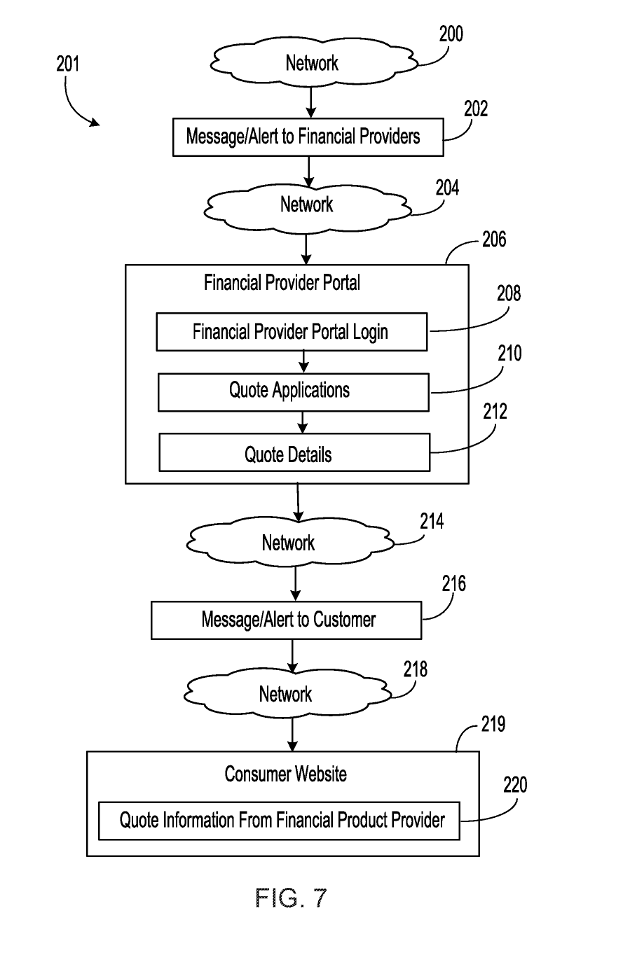

Referring to FIG. 7, networked environment 201 includes a financial provider portal 206 that enables financial product providers to view anonymous consumer quote applications, and to append these quote applications with quotes and pricing information for the user's review, but without revealing the user's identity or contact information as described above. The recommendation system generates data for the financial provider portal 206, that when rendered on a display device of a financial product provider displays the portal. The recommendation system also sends messages to consumers about the status of financial quote requests, and allows consumers to review quote and pricing information provided by providers all in one place, and using a common set of consumer preferences. In this example, the recommendation system sends (via network 200) a message or alert 202 to specific financial providers selected by a consumer. For example, the consumer can specify which providers are to provide quotes. This message may be an e-mail message or an alert visible on a website or software application.

The provider connects over a network 204 to the financial provider portal 206. The financial provider portal includes a secure financial provider portal login 208 process. After logging into the portal 206, the financial provider can view completed consumer quote applications 210. Next, the financial provider can add quote details 212 for the consumer to view.

The consumer is notified over the network 214 via a message or alert 216, which may be delivered via email, text, or instantly while the consumer is still on the website or consumer application described in the process on FIG. 6. This message will instruct the consumer to view their quote and other pricing information from the financial provider. The consumer visits a consumer website 219 or a mobile or other software application (as noted earlier, whenever we mention web sites we also intend to include software applications including mobile applications). The consumer then views his/her completed financial product quote information 220 that is received from the provider. In this example, networks 200, 204, 214, 218 include a same network, e.g., the Internet. In another example, networks 200, 204, 214, 218 may include differing networks.

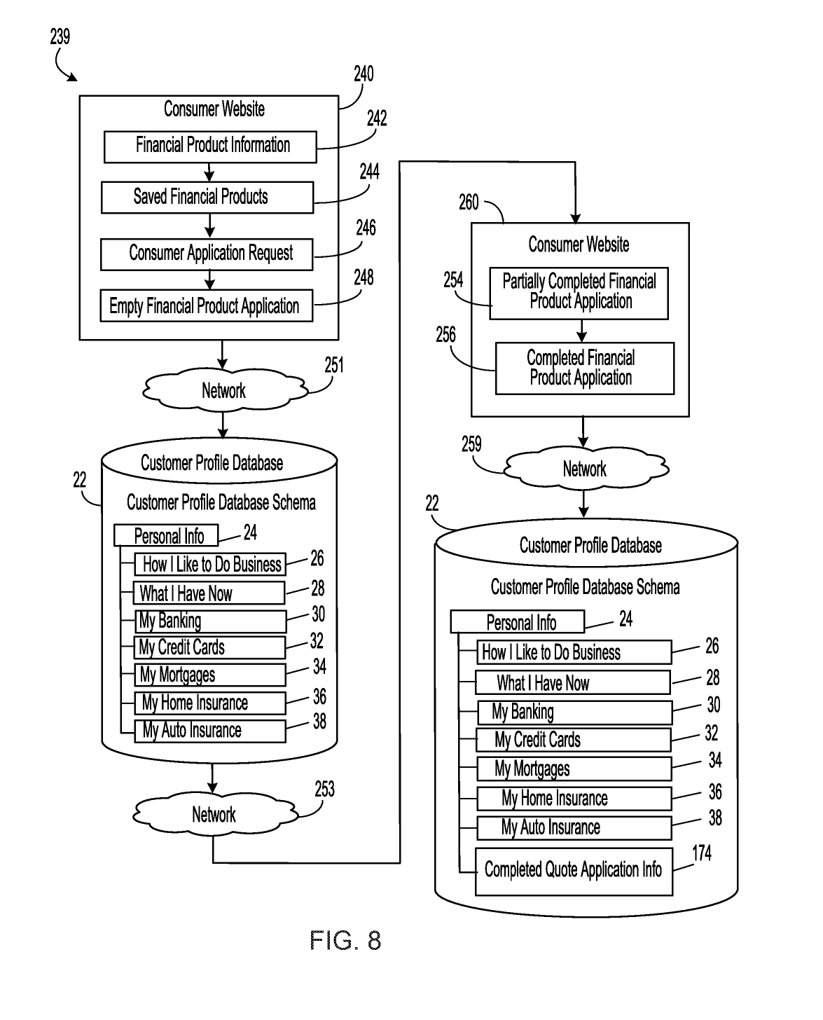

Referring to FIG. 8, networked environment 239 enables a consumer to visit a consumer website 240 (or use a consumer software application) to make a full application for a specific product selected by the consumer. Full applications convey consumer information required to secure a product and includes information for a provider to approve, deny, and price a consumer application. This recommendation system allows consumers to apply for multiple financial products at once, without filing out multiple forms or sharing sensitive, personal information across multiple provider application websites leading to abusive situations described above. The consumer is able to apply for these financial products by providing less additional information about himself/herself because most of his/her information is already stored in the customer profile database 22.

This process begins when a consumer visits a customer website 240 or similar software application. This website includes financial product information for individual financial products 242. The website 240 also includes information representing saved financial products 244, which is a list specifying products that have been reviewed by the consumer (e.g., either currently or previously). The consumer website 240 enables a consumer to request 246 a consumer application for one or more financial products. In response, consumers are presented with an unpopulated (e.g., empty) financial product application 248 and the option to fill the application using the information in the customer profile database 22, which has been saved by the consumer previously. In an example, a portion of the empty application is completed using contents of the consumer profile database 22, shared via the network 251. In this example, a partially completed application is transmitted via network 253 to a client device of the consumer, e.g., for display in consumer website 260. Through consumer website 260 (which is an updated version of consumer website 240), the consumer views the partially completed financial product application 254 and completes the application with extra information needed to complete the application. This completed financial product application 256 is sent via network 259 and new information is stored in the customer profile database 22, in new tables for completed quote and application info 174.

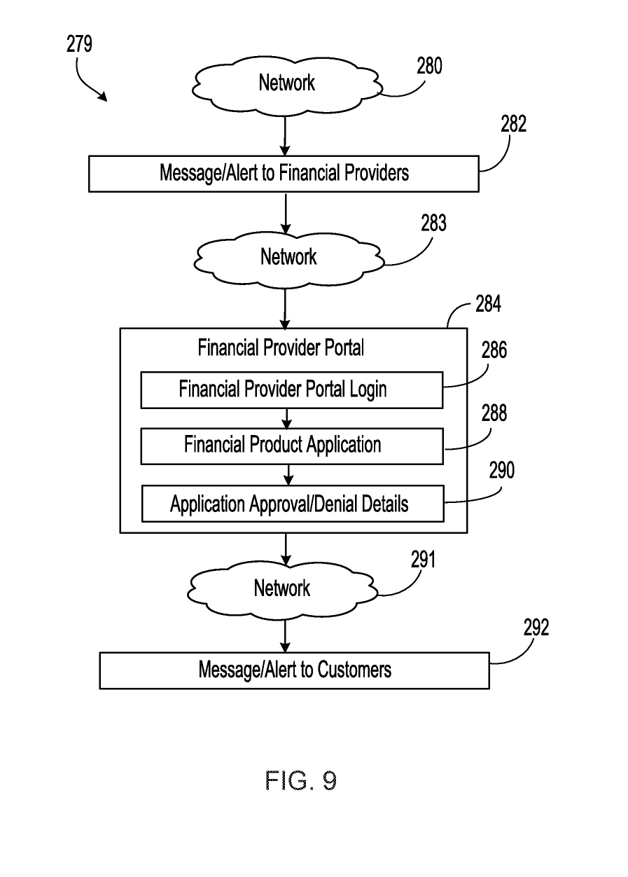

Referring to FIG. 9, networked environment 279 enables a financial product provider to interact with a provider portal and view full product applications, approve, deny, and price these applications, as well as provide information for consumers about the application status and decision. The recommendation system (not shown) also allows for messaging to consumers about the status of a full application over a network. The system transmits a message or alert 282 to financial providers sent over a network 280 indicating a consumer has completed a full application for a specific financial product. This message may be an email message or an alert visible on a website or software application. The provider connects over a network 283 to a financial provider portal 284. The financial provider portal includes a secure financial provider portal login 284 process. After logging into the recommendation system, the provider can view completed consumer financial product applications 288 for that provider's products. The provider can approve, deny, and/or price full applications and enter application approval/denial details 290 for the consumer to view. The consumer is notified over the network 291 via a message or alert 292, which may be delivered via email, text, or instantly while the consumer is still on the website or consumer application described in the process on FIG. 8. This message will instruct the consumer to view application information from the financial provider.

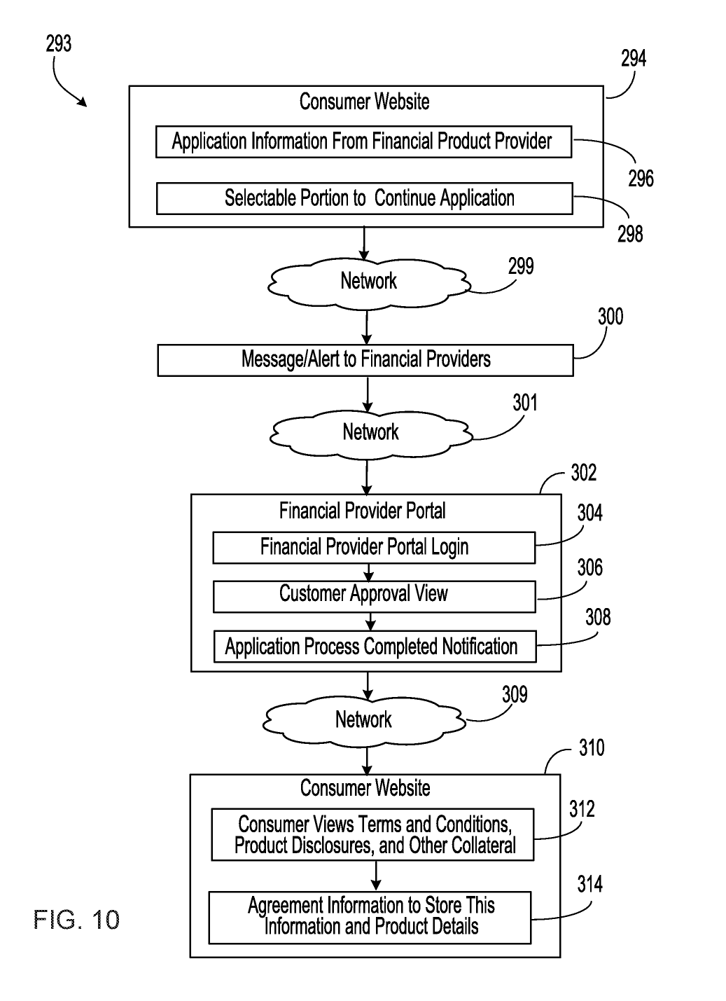

Referring to FIG. 10, networked environment 293 provides for a consumer to receive approval from one or more financial product applications. In this example, the consumer selects (in a GUI) information indicative of the financial product, and is connected to the provider to complete the application process and to obtain the financial product.

On consumer website 294, the customer may view his/her application information from financial product providers 296 and also decide (e.g., via selectable portion 298) if he/she would like to continue with an approved application. When the customer decides to continue with an application the financial provider is notified via the network 299 by receiving a message or alert 300 that the consumer would like to continue the process.

The financial provider visits a financial provider portal 302 via the network 301, logs into the financial provider portal using a secure financial provider portal login 304. Next, the financial provider views the consumer's approval details 306. The application process is now complete and the website is updated to display an application process complete notification 308. Following completion, the consumer may obtain the financial product. Via the network 309, the provider conveys the terms and conditions, product disclosures, and other collateral 312 through the system to the consumer website 310. The consumer website 310 provides a choice to the consumer to store this information 314 and product details in the consumer profile database 22 (FIG. 1B).

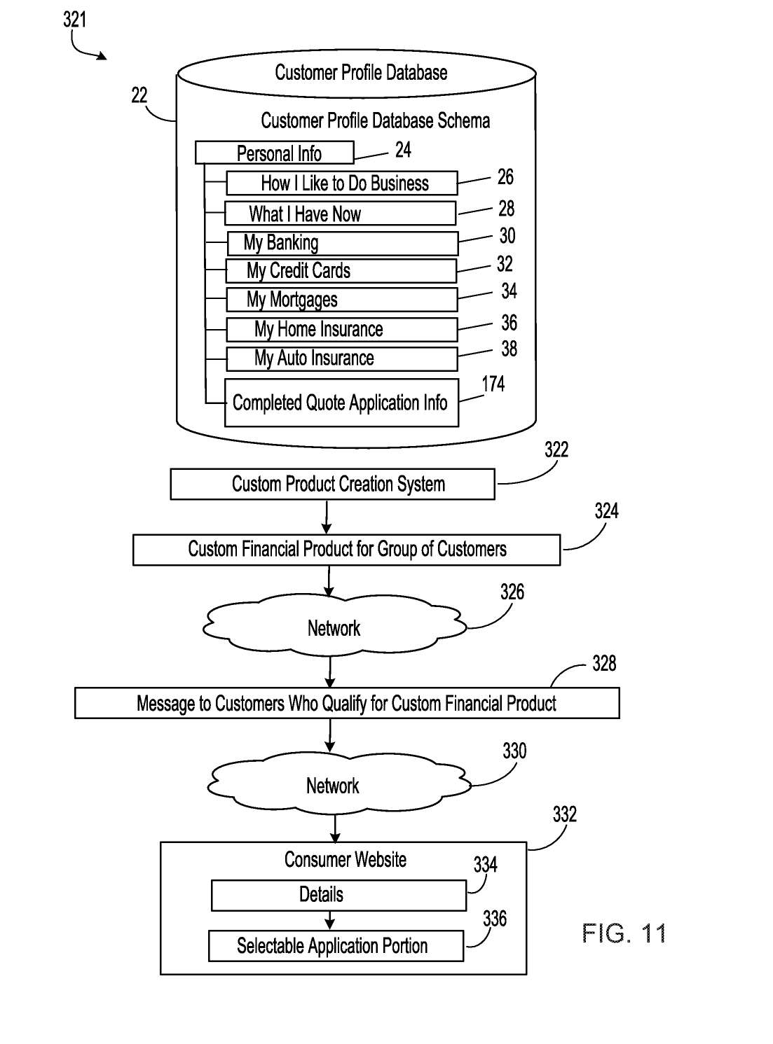

Referring to FIG. 11, networked environment 321 enables generation of custom financial products, based on the consumer's specific situation and needs. Networked environment 321 includes recommendation system 322 for generating custom financial products. For example, the recommendation system 322 determines that various customers in the customer profile database 22 (FIG. 1B) live in the same zip code and needed to renew auto insurance. In this example, recommendation system 322 generates a custom auto insurance policy with a discount for this group of consumers and/or special localized features for this group. Financial products eligible for customization include bank accounts, credit cards, mortgages, home insurance, auto insurance, and other financial products.

In operation, recommendation system 322 analyzes consumer information stored in the customer profile database 22. Based on the analysis, recommendation system 322 identifies common characteristics of consumers and common product needs of consumers through a software matching algorithm. For example, recommendation system 322 may determine a group of consumers with a car insurance deductible (as specified in auto insurance table 38) that is above a threshold amount and that live in a particular geographic location (e.g., as specified by personal information 24). Once a need is discovered (e.g., a need for car insurance with a lower deductible in a particular geographic location) for one or many customers in the system, recommendation system 322 generates custom financial product 324, e.g., by facilitating with insurance providers a group discount.

Custom products may be generated in many different ways based on the needs of a group via computer algorithm to determine common characteristics in the base of consumers. For example, a single auto insurance product may be created for a group of consumers who all need to renew their auto insurance at the same time and/or same general location or type of auto. Or a credit card could be created for a group of consumers interested in the same type of rewards. Or the system could create a product that would receive the highest possible score in the rating system. Qualifying consumers are notified over a network 326 with a message 328 to customers who qualify for custom financial products 324. This message could be delivered as email, text message, or other communication methods. Consumers access a consumer website 332 or client software application to view details 334 about the custom financial product 324. Consumer website 332 includes a selectable portion 336, selection of which enables consumers interested in the custom financial product to apply for the product.

In some implementations, other approaches, such as machine learning, can be used to determine common characteristics in the base of consumers.

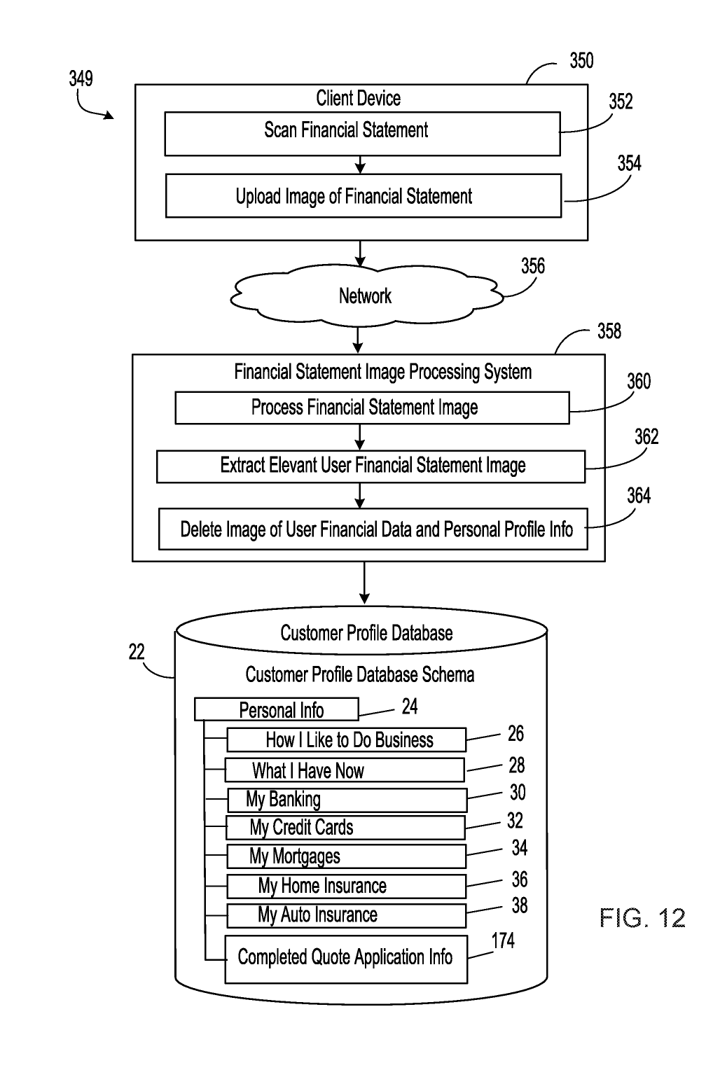

Referring to FIG. 12, networked environment 349 enables a consumer to generate a digital image of a financial product statement or other consumer bill and upload the image of the financial statement through a network, where the image is then processed through a financial statement imaging process, relevant data is extracted from the image, the image is deleted and the relevant data is stored in the customer profile database. This allows the consumer to simplify the process of determining if a different product would better suit his or her needs.

Networked environment 349 includes client device 350 (e.g., a mobile phone or personal computer device). Using client device 350, the consumer scans (352) or takes the photograph of a financial statement. Financial statements include bank account statements, credit card statements, mortgage statements, auto and home insurance policy statements and coverage details, and other similar financial statements, as well as periodic bills for consumer services such as mobile phone bills and plans.

Once the consumer has created an image of the statement, client device 350 uploads (354) the image of the financial statement over the network 356 and into a system 358 for financial statement image processing (e.g., the recommendation system). In a variation, the consumer uses a mobile phone application to convey the image to the system.

This financial statement image processing system 358 processes (360) the user's financial image statement, extracts (362) relevant user financial data and personal profile information 362, and deletes (364) the financial statement image 364. The extracted relevant consumer profile information is stored in the customer profile database 22 in the appropriate tables in the customer profile database schema. This information can then be used in the future to help consumers find better financial products related to the financial product for which the original image statement was processed. The multiple networks included in each of FIGS. 7-12 may be a same network or different networks.

Referring to FIG. 13, GUI 400 enables a consumer to enter personal information, which is stored and used in the system described in FIG. 1 in which consumer personal and financial information is stored in a customer profile database 22. In some instances (not shown) a user can select to link and upload (via an API) to those third parties (and third party aggregators of information) her checking and credit card account information and transactions, her credit report, her household makeup and cars owned, and other accounts; this action reduces the manual entry of the user's information required by the matching engine. A software application would convey this information to the appropriate section of the customer profile database 22. GUI 400 includes a section labeled my profile 402, which includes an about me section 404, a personal information section 406, a how I like to do business section 408, a what I have now section 410, a my banking section 412, a my credit cards section 414, a my mortgages section 416, a my home insurance section 418, and a my auto insurance section 420. In a variation, a GUI could also include sections for other financial products similar to bank accounts, credit cards, mortgages, home insurance, and auto insurance.

Using personal info section 406, a consumer enters in personal information, such as name 422, email address 424, zip code 426, occupation or job information 430, home ownership status 430, credit score estimate 431 and events that may happen in the future 432, such as purchasing a home, getting married, having children, starting a new job, moving, etc. GUI 400 is used to generate a profile of a consumer that will be analyzed via a computer algorithm to recommend financial products to the consumer. A personal profile is information specific to that consumer that promotes determination of correct financial product for his or her needs. Data entered into this GUI 400 would not be limited to the data fields illustrated here. These have been placed here for examples, but other general information about consumers could be added. Once a consumer completes this profile, he/she saves this information with the “next” button. This personal information is saved, by a recommendation system, in a customer profile database 22 for later use in assisting and recommending bank accounts, credit cards, mortgages, home insurance, auto insurance, and other financial products (and financial products embedded into another product offer, like cell phone financing offered through cell phone service agreements, or financing offers for a specific car) to the consumer.

Referring to FIG. 14, GUI 439 is an updated version of GUI 400 in which the how I like to do business section is selected. GUI 439 enables a consumer to indicate the consumer's preferences when doing business with financial service providers. GUI 439 includes portion 440 and controls 442 for consumers to specify a level of financial organization. GUI 439 also includes section 444 for a consumer to rank various attributes 444a-444d. Section 444 includes ranking list 445 for a consumer to rank attributes 444a-444d. Here the consumer would arrange the most important elements from top to bottom, most important to least important in terms of preference. Ranked attributes would include face to face interactions, highly recognized brands or companies, great customer service, and lowest prices. Data entered into this GUI 439 would not be limited to the data fields illustrated here. These have been placed here as examples, but other attributes measuring consumer preferences in selecting and working with financial product providers could be added. Once a consumer completes this profile, the consumer saves this information with the Next button 452. Following section of the Next button 452, the recommendation server receives a request to store the information entered into GUI 439 and saves this information in the customer profile database 22 for later use in recommending bank accounts, credit cards, mortgages, home insurance, auto insurance, and other financial products (and financial products embedded into another product offer, like cell phone financing offered through cell phone service agreements, or financing offers for a specific car) to the consumer.

Referring to FIG. 14, GUI 439 is an alternative or complementary method for consumers to define their financial product needs by selecting a specific situation (e.g. having a baby, moving, traveling overseas) or lookalike profile (e.g. single with new job, newly married couple, first baby on the way, family starting a home search, etc.) that will determine needs and preferences in a financial product. Data entered into this GUI 439 would not be limited the data fields illustrated here. These have been placed here as examples, but other attributes measuring consumer preferences in selecting and working with financial product providers could be added. Once a consumer completes this profile, the consumer saves this information with the Next button 452. Following section of the Next button 452, the recommendation server receives a request to store the information entered into GUI 439 and saves this information in the customer profile database 22 for later use in recommending bank accounts, credit cards, mortgages, home insurance, auto insurance, and other financial products (and financial products embedded into another product offer, like cell phone financing offered through cell phone service agreements, or financing offers for a specific car) to the consumer.

Referring to FIG. 15, GUI 455 shows the elements that are displayed, following selection of what I have now section 410. GUI 455 includes section 460 for specifying the consumer's current financial products via controls 462a-462e. Through selection of one or more of controls 462a-462e, the consumer indicates if the consumer currently has a bank account, credit cards, mortgages, home insurance, and/or auto insurance, respectively. This would enable this system to ask questions about these financial products later to enrich the profile. Alternatively, (not shown) a user can select to link and upload (via API) to those third parties (and third party aggregators of information) her checking and credit card account information and transactions, her credit report, her household makeup and cars owned, and other accounts; this action reduces the manual entry of the user's information required by the matching engine. A software application would convey this information to the appropriate section of the customer profile database 22. Data entered into this GUI 455 would not be limited to the financial products illustrated here. These have been placed here as examples, but other financial product types could be listed in the future. Once a consumer completes GUI 455, the consumer causes the recommendation system to save this information through selection of next button 464. Information specifying the products selected is saved in a customer profile database 22 for later use in assisting and recommending bank accounts, credit cards, mortgages, home insurance, auto insurance, and other financial products (and financial products embedded into another product offer, like cell phone financing offered through cell phone service agreements, or financing offers for a specific car) to the consumer.

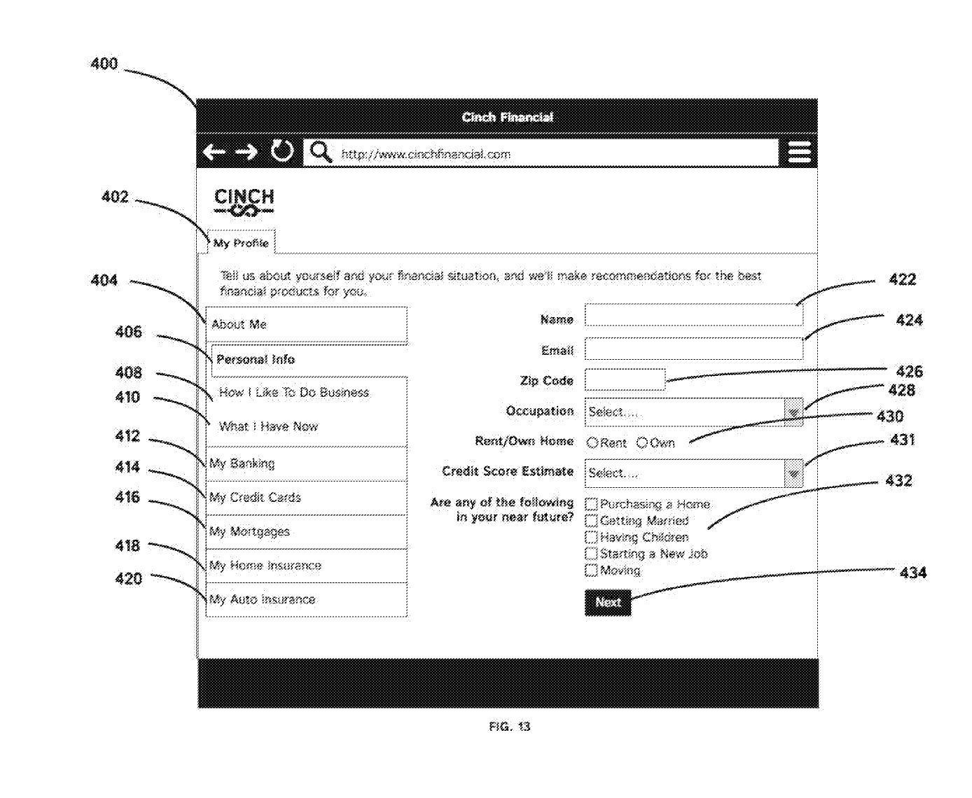

Referring to FIG. 16, GUI 465 is displayed, following selection of my credit cards section 414. GUI 465 includes section 470 for entering details about a consumer's current credit cards. Section 470 includes field 474 for entering information specifying a name of a credit card provider, field 476 for entering information specifying amount spent per month in dollars, field 478 for entering information specifying current balance in dollars, field 480 for entering information specifying current interest rate in percentage, selectable control 482 for selection a type of card rewards 482 (e.g., rewards given when a credit cards is used, including, e.g., cash rebates, airline mile points, hotel points, etc.), and selectable control 483 for specifying credit card features that are most important, including, e.g., low interest rate, low annual fee, no foreign transaction fees, and so forth. Once a consumer completes this GUI 465, the consumer could finish entering credit cards by selecting finished control 486 or enter information about another credit card by selecting add another card control 484. The information entered here by the consumer is saved via a network in a customer profile database 22 for later use in assisting and recommending credit cards to the consumer. In some cases, for users who have chosen to link (via an API) provider accounts (and third party aggregators of information) containing his/her checking and credit card account information and transactions, credit report, household makeup and cars owned, and other product and information accounts, logic powered by one or more software algorithms aided by machine learning software can determine those products most in need of review. This will reduce the reliance of the system on user self-diagnosis and could reveal problems unknown to the user. A software application would convey this information to the appropriate section of the customer profile database 22. In a variation, there are similar GUI screens for the consumer to enter information about current bank accounts, debit card, mortgages, home insurance, auto insurance, and other financial products (and financial products embedded into another product offer, like cell phone financing offered through cell phone service agreements, or financing offers for a specific car).

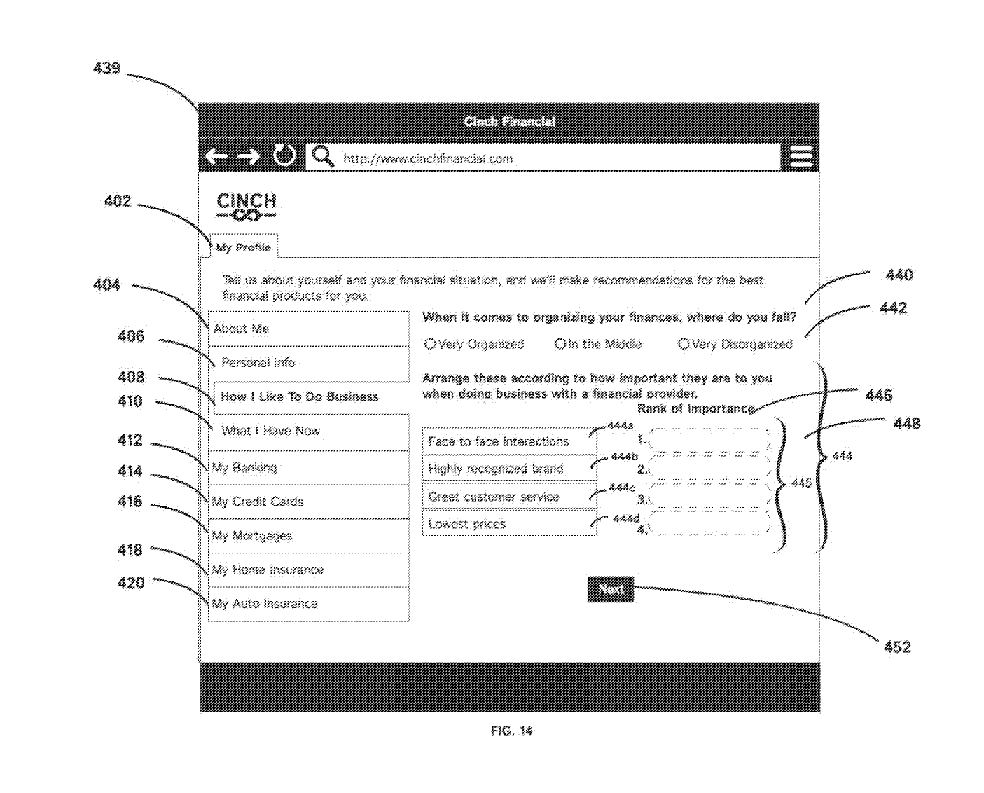

FIG. 17, GUI 500 displays information to aid the consumer in selecting the right product (and is used by analysts researching and scoring products). GUI 500 includes title portion 502 to specify that GUI 500 displays information that is based on ranking data for financial products that is entered into a financial products scoring & ranking system. GUI 500 includes menu 501 for selecting various types of products for which scores and ranks are displayed. In this example, menu 501 displays scores and ranks for various mortgage products, following selection of mortgage section 508 of menu 501. Menu 51 also includes banking section 504, credit card section 506, home insurance section 510, auto insurance section 512, and other products section 514, selection of which displays rankings and scores for bank accounts, credit cards, home insurance, auto insurance, and other financial products, respectively (and financial products embedded into another product offer, like cell phone financing offered through cell phone service agreements, or financing offers for a specific car).

In this example, GUI 500 includes product section 516 that lists various products 516a-516n, e.g., mortgage products. A mortgage product is evaluated across multiple variables, including, e.g., price and so forth. For mortgages, variables include: the quality of the website, phone service, ease of application, quality of phone service, availability of local offices, closing rates, closing costs, denial rate, amount of loans the provider sells to third parties, percentage of customers who leave provider for another provider, customer reviews and commentary on other websites, expert opinions, percentage of complaints to the Consumer Finance Protection Board (CFPB), interest rates, among other mortgage attributes.

For credit cards, variables include, quality of credit card rewards, annual percentage rate, annual fees, length of billing grace period, other fees, additional incentives, promotional interest rates, warranties, purchase protection, EMV chip presence, merchant acceptance, car rental insurance, travel insurance, CFPB complaints, expert reviews from third parties, and consumer reviews from social networks and websites.

For home and auto insurance variables include pricing, customer retention, flexible claims procedures, location convenience, website quality, local agent availability, reviews and commentary from customers on other websites and social media, expert ratings, and state agency ratings.

Variables for checking and savings bank accounts include monthly fees, minimum balance requirements, ATM fees, check ordering fees, overdraft fees, interest earned, only bill payment and check writing, website quality, ATM availability, local branch hours, phone service hours, CFPB complains expert reviews, and reviews and comments on other websites and social media.

In this example, GUI 500 includes variable portion 518 with fields 518a-518n for entry of values for the variable specified by variable portion 518 (i.e., price). For example, a user enters a score in field 518a for product 516a, field 518b for product 516b and so forth. In an example, for each mortgage, analysts enter several scores that are values for the variables, ranking each mortgage for that scoring attribute. GUI 500 also includes variable portions 520, 524, 526 and 528 and 529, each of which includes associated fields for entering values of the respective variable. Using the values for the various variables (as specified by the values entered into the fields of variable portions 518, 520, 524, 526 and 528), the recommendation system calculates a propriety score for each of products 516a-516n. GUI 500 includes proprietary score section 522 for display of a calculated proprietary score, for each of products 516a-516n.

For example, the proprietary score may be based on a summation, an average, a mean and so forth, of the scores of the variables for a product. Mathematical formulas are applied (by a system) to the values of the variables to generate the proprietary score, as described in further detail below. This score would be used to assist consumers in understanding which products are highly rated. Ranking and scoring systems are associated with each financial product type, including bank accounts, credit cards, mortgages, home insurance, auto insurance, and other financial products (and financial products embedded into another product offer, like cell phone financing offered through cell phone service agreements, or financing offers for a specific car).

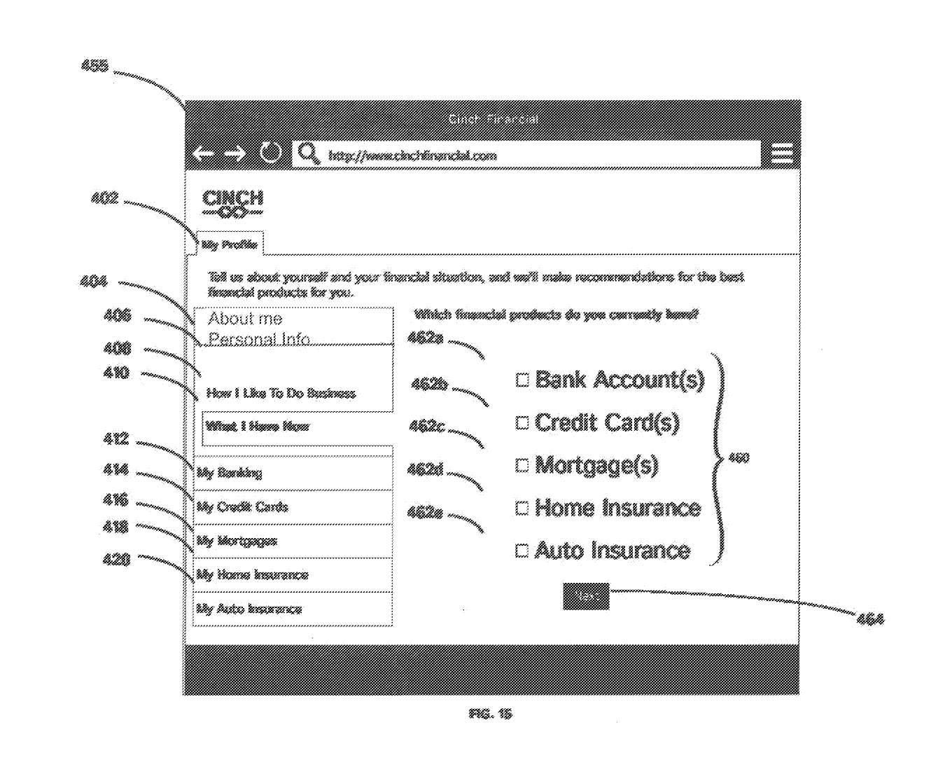

Referring to FIG. 18, GUI 530 displays a consumer view of highly ranked mortgages, e.g., mortgages with proprietary scores that exceed a threshold value and/or a predefined number of mortgages that are associated with the highest propriety score, relative to proprietary scores of other mortgages. GUI 530 includes product section 540 for display for highly ranked products (e.g., mortgages). Product section 540 includes proprietary picks section 542 for displays of the highest rated mortgages from the ranking and scoring process shown in FIG. 17.

Proprietary picks section 542 includes product information 544a, 544b, 544c. (For implementations that use mobile apps, the pics may be handled in other ways.) Using product information 544a, 544b, 544c, consumers can view multiple mortgages with details for each mortgage to allow side-by-side comparison. Details include the name of the mortgage provider, details about the mortgage terms, and the proprietary scores 546a-546c, as determined by the scoring and ranking process described in FIG. 17. FIG. 18 shows this arrangement for showing highly ranked mortgages, but this view would also be available for other financial products such as bank accounts, credit cards, mortgages, home insurance, auto insurance, and other financial products (and financial products embedded into another product offer, like cell phone financing offered through cell phone service agreements, or financing offers for a specific car).

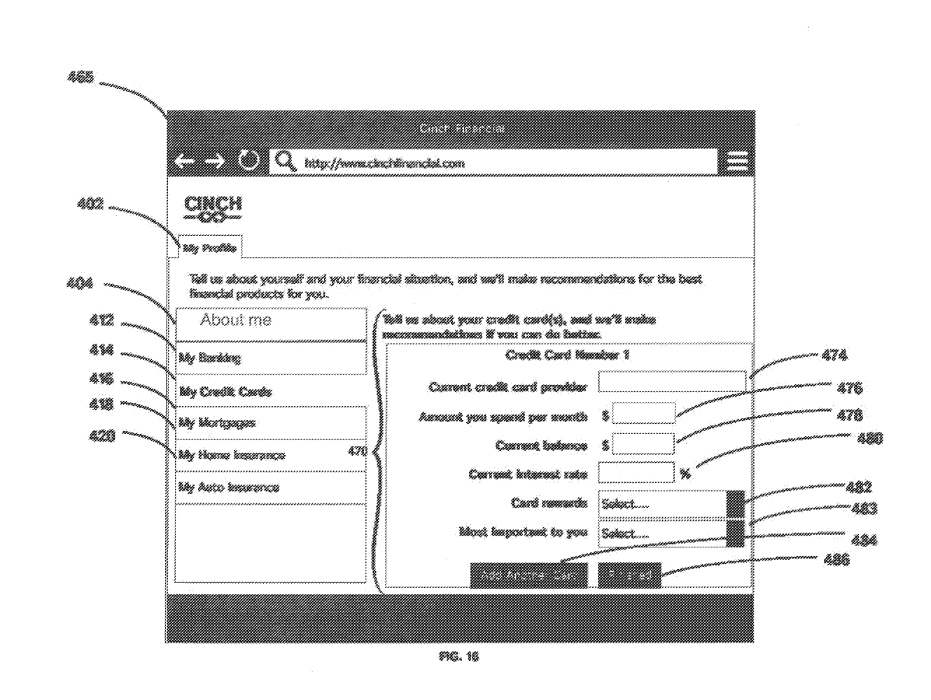

Referring to FIG. 19, GUI 560 displays tab 570 of a consumer view of highly ranked recommended financial products. These recommendations are created based on the information completed by the consumer in the personal profile described in FIGS. 13, 14, 15 and 16, and ranked and scored products described in FIG. 17. In some examples (not shown) a user can select to link and upload (via an API) to those third parties (and third party aggregators of information) her checking and credit card account information and transactions, her credit report, her household makeup and cars owned, and other accounts; this action reduces the manual entry of the user's information required by the matching engine. A software application would convey this information to the appropriate section of the customer profile database 22. The consumer is shown recommended products in a bank account category 574, a credit card category 586, and a mortgage category 588. Categories for recommended products include bank accounts, credit cards, mortgages, home insurance, auto insurance, and other financial products (and financial products embedded into another product offer, like cell phone financing offered through cell phone service agreements, or financing offers for a specific car). For recommended product information 578 that represents a particular recommended product, GUI 560 displays product names and details 577 and proprietary score information 582 that specifies the calculated proprietary score for the product. Consumers also have the ability to save a product to view later by selecting a save for later element 580 in the GUI 560. This would enable consumers to save multiple products to request pricing and to apply for the products. GUI 560 shows this arrangement for bank accounts, credit cards, and mortgages, but these recommendations are available for other financial products such as home insurance, auto insurance, and other financial products (and financial products embedded into another product offer, like cell phone financing offered through cell phone service agreements, or financing offers for a specific car).

Referring to FIG. 20, GUI 600 displays a graphical representation 602 of a consumer email message (hereinafter “email message 602”). This email message 602 includes header information 604 and communicates the consumer financial product recommendations described in FIG. 19. This message is sent when there were new recommendations to communicate to the consumer, or periodically, as set by the consumer. In some implementations, based on information provided by a mobile application, or through other data linked to the user (e.g., a change in shopping habits, or change in product usage perceived by the system via linkage to the account), the system will determine that the current products held by the user are a mismatch, perhaps resulting in too-high price given the change in location or situation, totally unbeknownst to the user. The system perceives that and alerts the user proactively based on inputs the system has passively collected to help optimize the user's situation. The email message 602 includes a message to the consumer 606 about the recommendations. These recommendations are generated based on the information completed by the consumer in the personal profile described in FIGS. 13, 14, 15 and 16 and matched with attributes of the ranked and scored products described in FIG. 17.

A financial product is associated with various attributes, including, e.g., a price, a payment (a monthly payment), a product type, a geographic location, an income requirement to qualify for the product and so forth. The body of email message 602 includes contents from GUI 560 (FIG. 19). For example, the consumer is shown recommended products in each product category 574, 586, 588. Categories for recommended products include bank accounts, credit cards, mortgages, home insurance, auto insurance, and other financial products. This figure shows this arrangement for bank accounts, credit cards, and mortgages, but these recommendations are available for other financial products such as home insurance, auto insurance, and other financial products (and financial products embedded into another product offer, like cell phone financing offered through cell phone service agreements, or financing offers for a specific car). Selecting any of these individual product recommendations would take the user to the consumer website or software application described in FIG. 19.

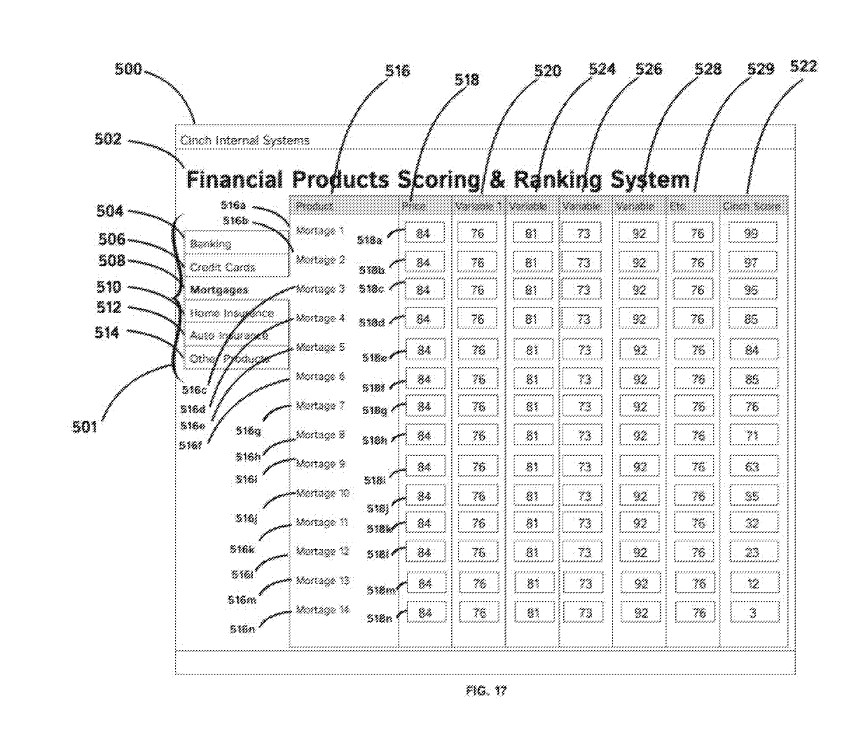

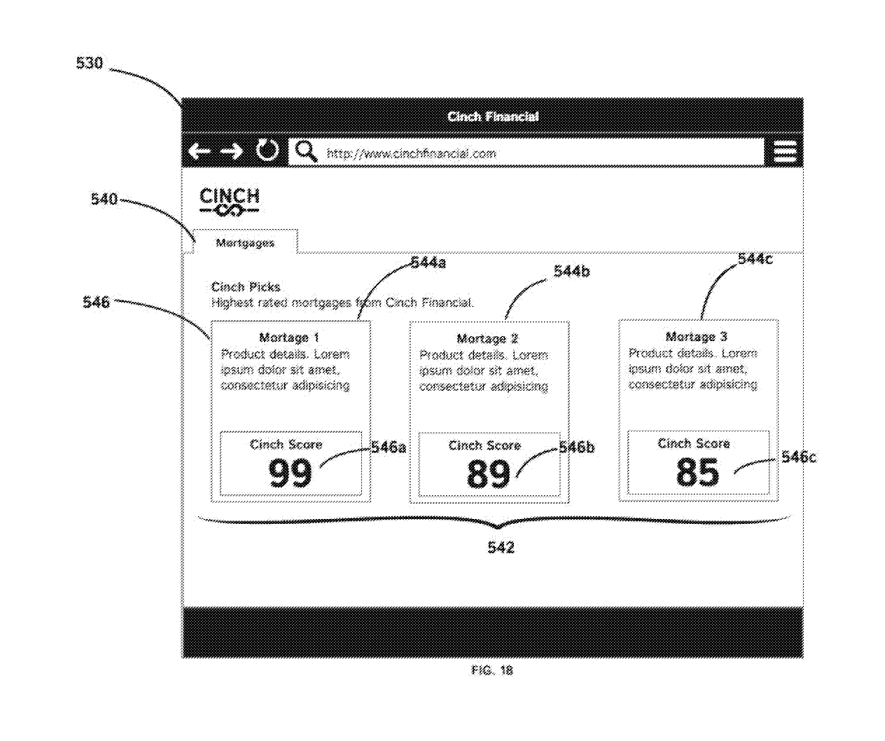

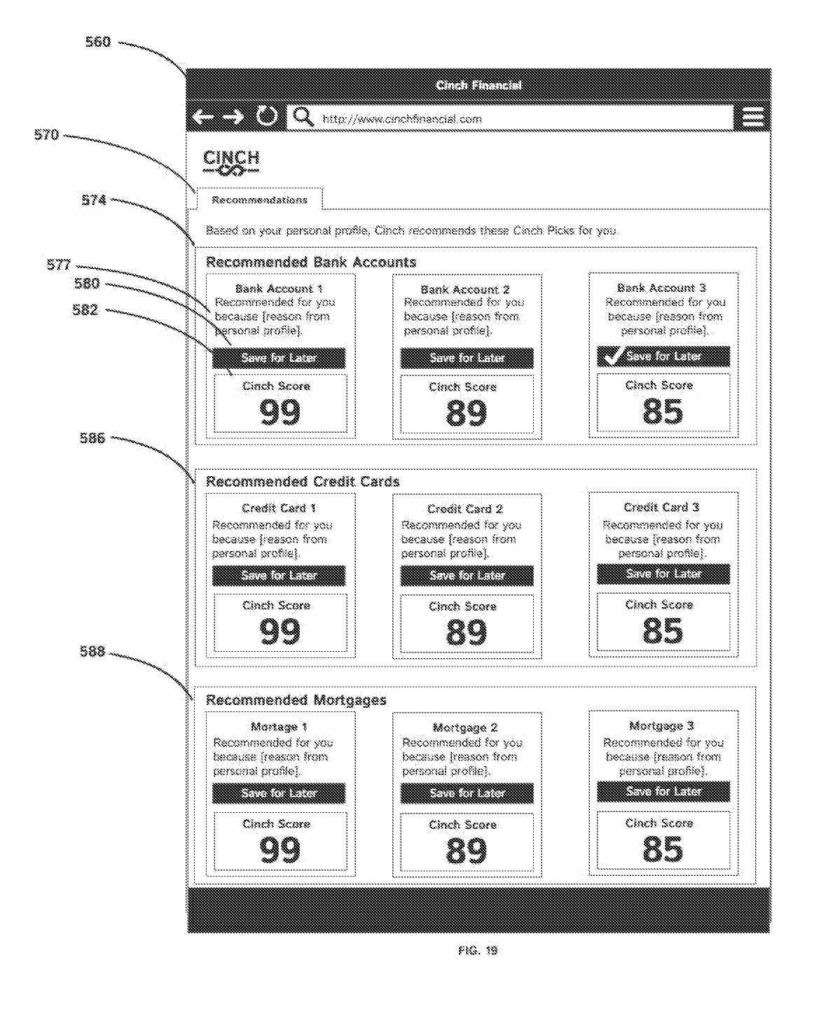

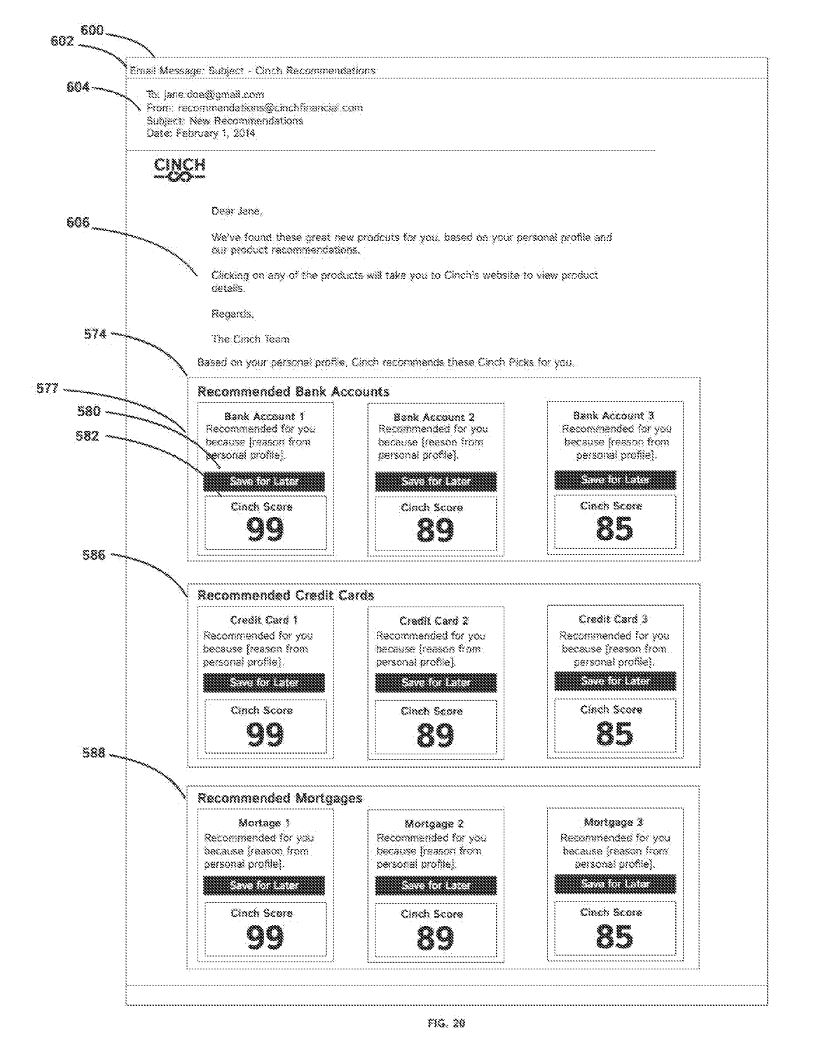

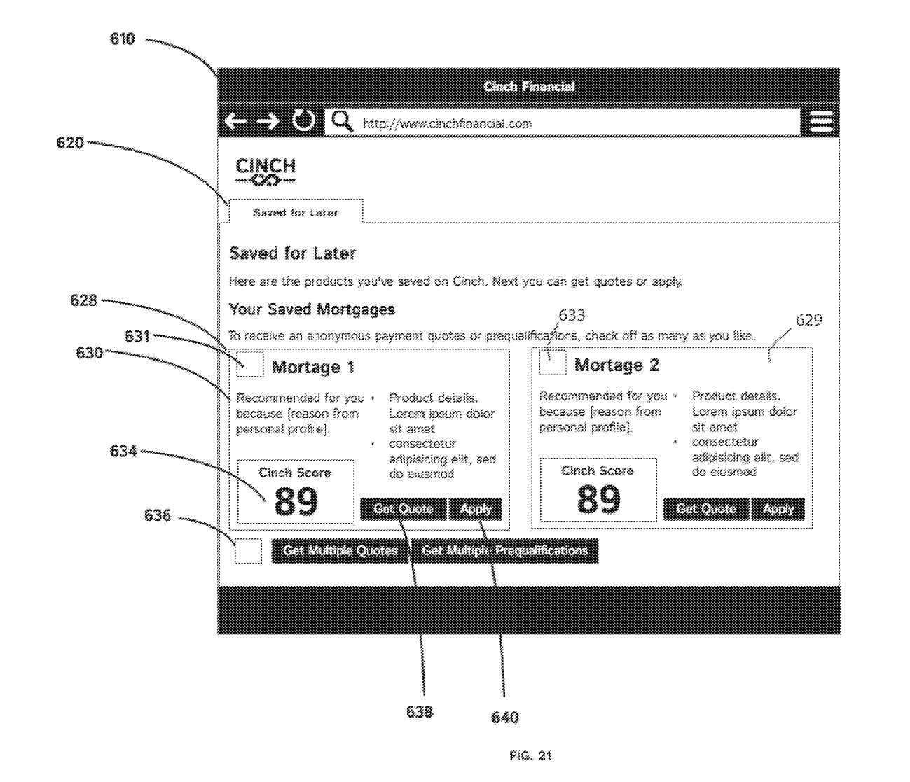

Referring to FIG. 21, GUI 610 shows a listing of financial products which have been saved for later by a consumer who has previously used this website or software application. GUI 610 includes saved for later tab 620 for display of products that were previously saved. In this example, saved for later tab 620 displays mortgage information 628, 629. In this example, saved mortgages are shown, but other products including bank accounts, credit cards, home insurance, auto insurance, and other financial products could also be included (and financial products embedded into another product offer, like cell phone financing offered through cell phone service agreements, or financing offers for a specific car). For mortgage information 628, product name information and other details 630 are displayed, along with a proprietary score 634 for the product. Mortgage information 628 includes checkbox 631, selection of which specifies that the consumer requests payment quotes or prequalification information for the product represented by mortgage information. Mortgage information 629 includes checkbox 633, selection of which specifies that the consumer requests payment quotes or prequalification information for the product represented by mortgage information. GUI 610 includes graphical representation 636 for display of information specifying a number (if any) of products for which a user has requested (via selection of one or more of checkboxes 631, 633) to receive payment quotes or prequalifications. In this example, a user has not requested to receive payment quotes or prequalifications for any of the saved product information. Via control 638, consumers could choose to receive a pricing quote from a financial provider for the product. Via control 640, a consumer selects to apply for the product.

FIG. 22 shows GUI 642, which is an updated version of GUI 610. GUI 642 displays a listing of financial products, which have been saved for later by a consumer who has previously used a website or software application that displays GUI 642. In this example, the consumer selects checkboxes 631, 633. The number of checkboxes selected is tallied and information indicative of the tallied number is displayed in graphical representation 636. Selection of one or more of checkboxes 631, 633 enables the consumer to choose to receive pricing quotes from financial providers and/or apply for multiple financial products by selecting the get multiple quotes button 654 and the get multiple prequalifications buttons 656. A prequalification includes an application for mortgages. GUI 641 shows saved mortgages information but this process would also be available for other financial products including bank accounts, credit cards, home insurance, auto insurance, and other financial products (and financial products embedded into another product offer, like cell phone financing offered through cell phone service agreements, or financing offers for a specific car).

Referring to FIG. 23, GUI 660 is displayed in a consumer website or a software application. Through a process, a consumer initiates a request for a quote or an application to receive a financial product. This process includes single-source quote and application anonymous processing for multiple providers. GUI 660 includes section 670 that displays information describing a type of action (i.e., the process for applying or for receiving a quote) to be performed via GUI 660. To promote completion of the process, GUI 660 includes personal information section 672 with necessary data fields required for the particular financial product for which the consumer is requesting a price quote or applying, labeled your info 672. These fields would first be filled automatically for the consumer by using the consumer's data stored in the customer profile database 22. The consumer would then complete other fields if necessary. Some or all of this data could also be stored in the customer profile database 22. In some cases (not shown) a user can select to link and upload (via an API) to those third parties (and third party aggregators of information) her checking and credit card account information and transactions, her credit report, her household makeup and cars owned, and other accounts; this action reduces the manual entry of the user's information required by the matching engine. A software application would convey this information to the appropriate section of the customer profile database 22.

This example shows fields for a mortgage quote, but this process would also apply to products such as bank accounts, credit cards, home insurance, auto insurance, and other financial products (and financial products embedded into another product offer, like cell phone financing offered through cell phone service agreements, or financing offers for a specific car), with the data fields changing for each product type. In this GUI 660, personal information section 672 includes field 674 for a consumer to indicate which product he/she is applying for, field 676 for the consumer to specify which products are of interest, field 678 to specify an amount in dollars the consumer wants to borrow, field 680 to specify the value of the home, field 682 to specify the consumer's zip code, field 684 for entry of the consumer's estimated credit score, control 686 for the consumer to specify whether or not the consumer is applying with a spouse or partner, and field 688 for the consumer to specify the consumer's email address. GUI 660 displays a temporary email address 690 that is generated by a system (e.g., the recommendation system), so that the consumer's actual email address remains private in this system. GUI 660 displays next control 692 for saving this entered data in the customer profile database 22, and for notifying the financial providers that the consumer has applied for their products.

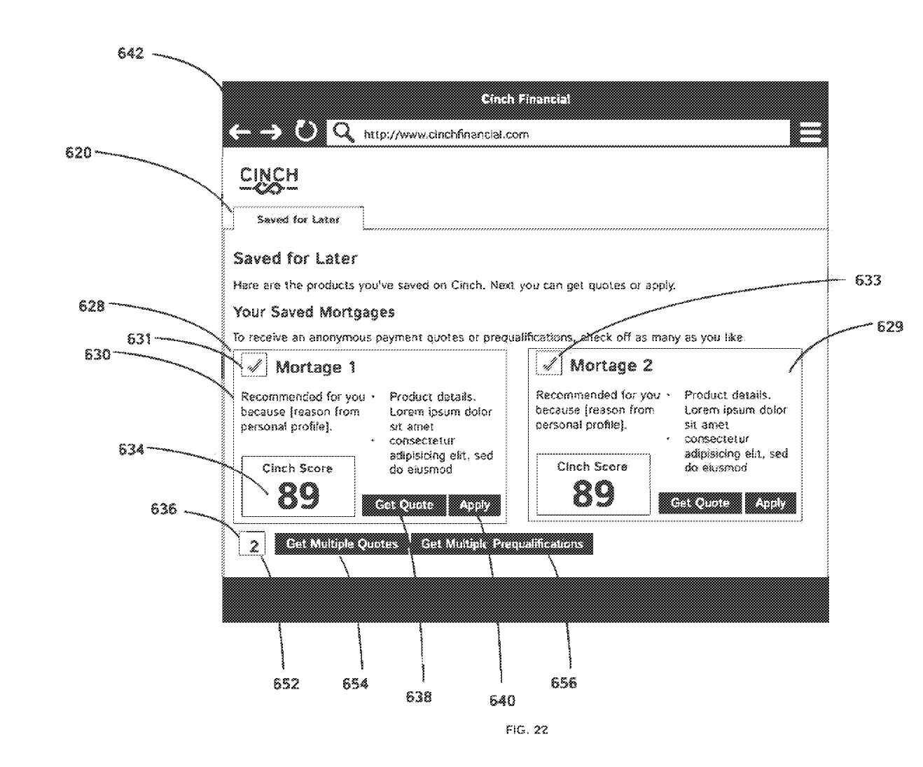

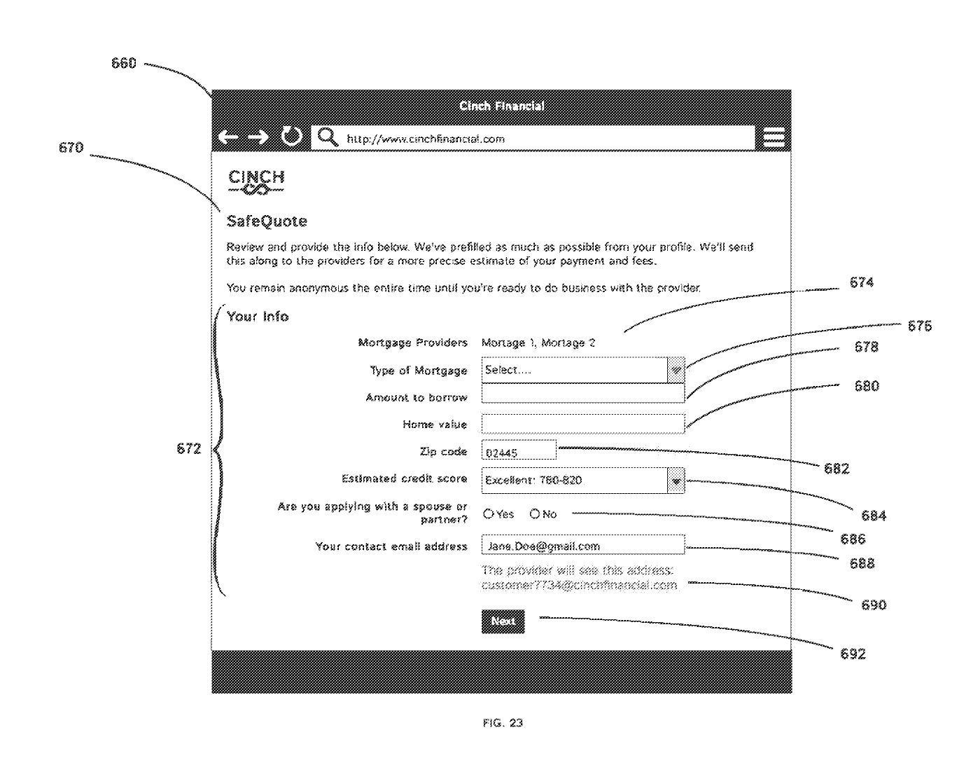

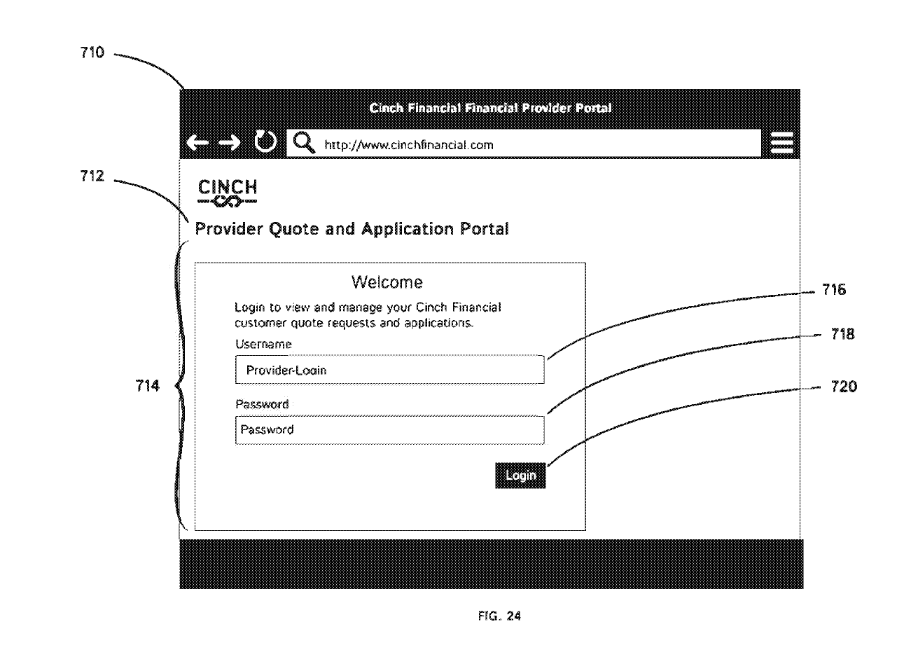

Referring to FIG. 24, GUI 710 is rendered through a website or software application for financial service providers. This website or software application would enable financial service providers to view, approve, deny, provide details, and communicate with consumers who have applied for price quotes and completed applications for the financial service provider's products. Products include bank accounts, credit cards, mortgages, home insurance, auto insurance, and other financial products. GUI 710 provides login section 714 that enables a service provider to log into a financial service provider portal. Each financial service provider is given a unique login identifier and password to log in and view consumer quote requests and completed applications for their products. Login section 714 includes fields 716, 718 for entry of username and password information, respectively. Selecting login control 720 would log the financial service provider into the portal.

Referring to FIG. 25, GUI 730 is rendered by a website or software application for financial service providers. This website or software application enables financial service providers to view, approve, deny, provide details, and communicate with consumers who have initiated price quote requests and completed applications for the financial service provider's products. Products include bank accounts, credit cards, mortgages, home insurance, auto insurance, and other financial products. GUI 730 includes pending quotes section 740 and pending applications section 752 that lists quotes and/or applications by consumers for the products offered by the financial service provider who is using this website or software application.

Pending quotes section 740 lists information indicative of quotes that have been sent to various consumers. Pending quotes section 740 includes summary information, such as dates of quote information 744, application type information 742, amounts applied for information 746 and links 748 for selection of other options, e.g., the ability to view details, approve or deny a quote or application, or communicate with the consumer who has applied.

Pending applications section 752 lists information indicative of applications for the financial service provider to review. Pending applications section 740 includes summary information, such as dates of quote information 756, application type information 754, amounts applied for information 758 and links 760 for selection of other options, e.g., the ability to view details, approve or deny a quote or application, or communicate with the consumer who has applied.

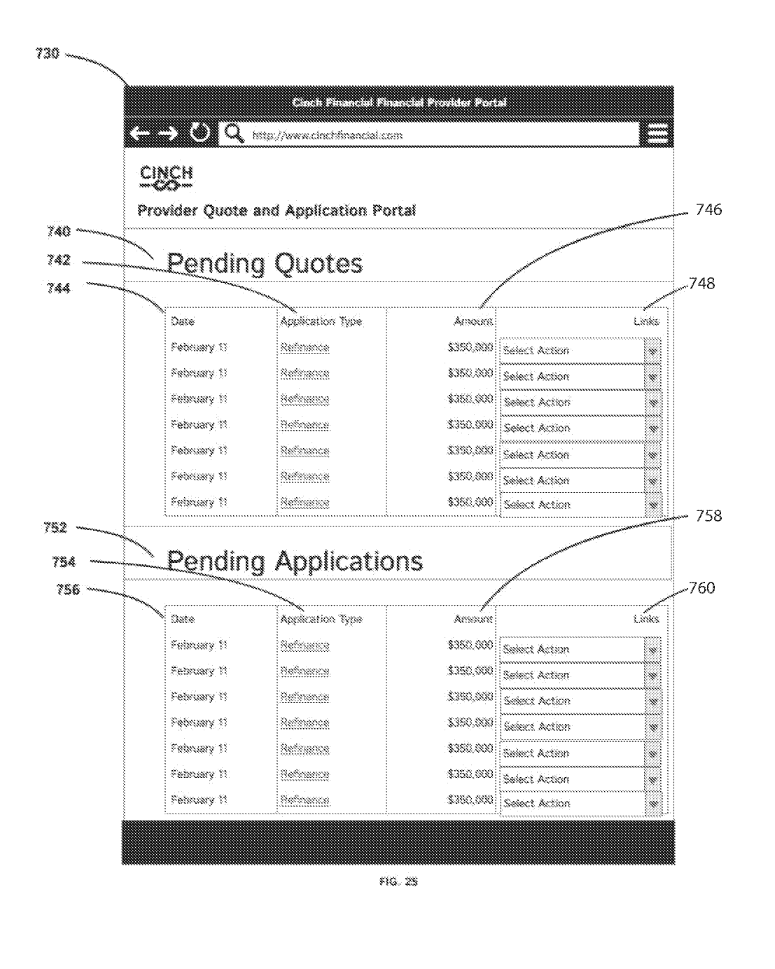

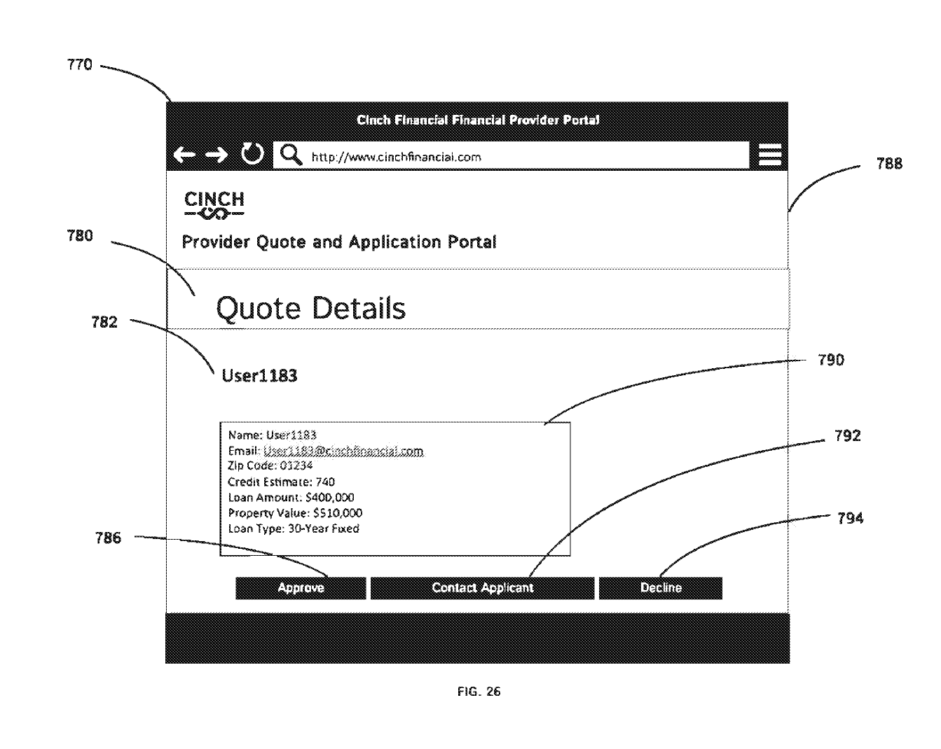

Referring to FIG. 26, GUI 770 is rendered by a website or software application for financial service provider employees. This website or software application would enable financial service providers to view, approve, deny, provide details, and communicate with consumers who have initiated price quotes requests and completed applications for the financial service provider's products. Products include bank accounts, credit cards, mortgages, home insurance, auto insurance, and other financial products. GUI 770 shows the details of a single consumer's request for a price quote or completed product application. GUI 770 includes details for a quote or application. In this example, GUI 770 includes quote details section 780 to display the details of a quotation, including, consumer user name information 782. The consumer's real name and/or contact information would not be revealed to financial service providers until the consumer approved doing so. Other details 790 include the anonymous email address, and other details necessary for the financial provider to approve or deny a consumer quote application or product application. A consumer's actual email address, phone number, and physical address would not be provided unless approved by the consumer.

From here, a financial service provider could approve an application via approval control 786, contact the applicant via contact control 792, or decline the application via decline control 794. These actions would take place while keeping the real identity of the applicant anonymous. Although this example shows a mortgage pricing quote example, this process would also be developed for other financial products and processes, appropriate for giving price quotes and starting the application process for bank accounts, credit cards, mortgages, home insurance, auto insurance, and other financial products (and financial products embedded into another product offer, like cell phone financing offered through cell phone service agreements, or financing offers for a specific car).

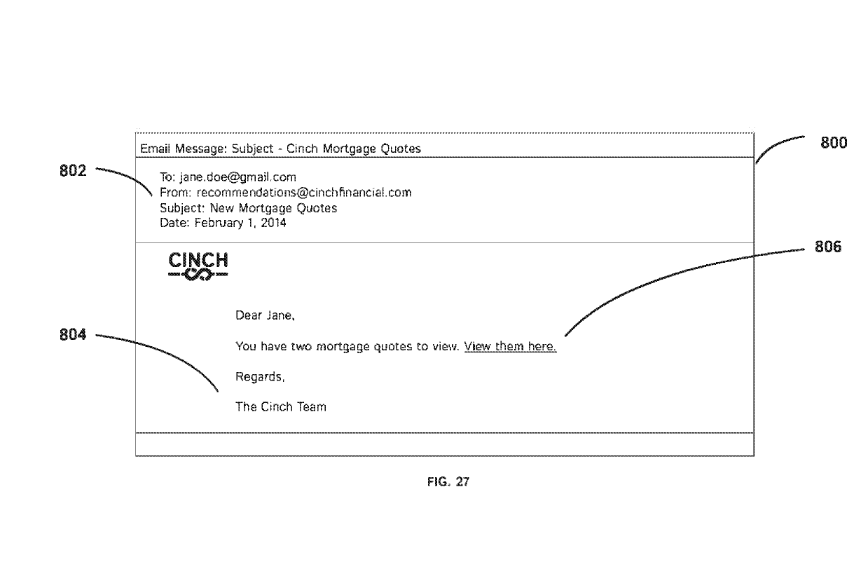

Referring to FIG. 27, GUI 800 displays a consumer email message. This email message communicates the status of a consumer quote request or application described in FIG. 26. This message is sent when a financial provider has completed a quote request or has processed a financial product application. The email message is sent to a consumer specified by recipient information 802. The email message includes link 806, selection of which enables a user to view the status of a quote request. Email message also include body portion 804 to display the contents of the email. Although this example shows a mortgage pricing example, this process would also be developed for other financial products and processes, appropriate for communications about price quotes and applications for bank accounts, credit cards, mortgages, home insurance, auto insurance, and other financial products.

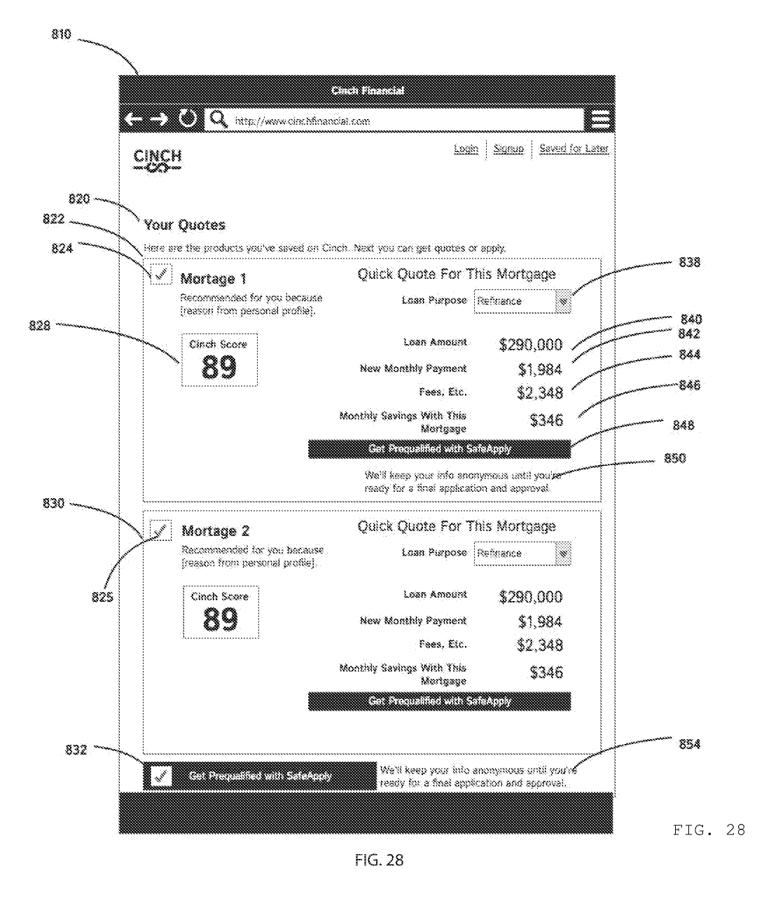

Referring to FIG. 28, GUI 810 is displayed in a consumer website or software application. GUI 810 shows the consumer the response from a financial service provider for a quote and financial product applications submitted by the consumer. The consumer could view multiple quote and application responses at once and in one simple format, versus responses from multiple providers, multiple formats, and multiple calculation methods. GUI 810 includes your quotes section 820 for display of information indicative of quotes that are provided to the viewer. Your quotes section 820 includes mortgage quote information 822, 830. Details for each quote shown here are examples, and actual quotes may show different data.

In this example, mortgage quote information 822 displays mortgage name and summary information 822, a proprietary score 828 (as computed from a scoring and ranking system), control 838 for selection of information specifying a purpose of the mortgage, the amount of the loan application information 840, information 842 specifying the monthly payment quoted by the financial product provider, information 844 specifying the fees quoted by the financial product provider, and information 846 specifying a calculated savings about for this product, which is the amount the consumer would save each month if the consumer replaced an existing product with this one.

Mortgage quote information 822, 830 includes checkboxes 824, 825, respectively, selection of which enables the user to specify the products for which the consumer request prequalification via button 832, e.g., in order to continue the process and apply for multiple financial products at once—independent of individually and separately filling out each application. Upon selection of button 832, the system provides single-source application anonymous processing for multiple providers by: accessing, from a data repository, personal profile information of the consumer, generating anonymous consumer information by removing, from the personal profile information, identifying information of the consumer, and transmitting to the providers the anonymous information for application processing. As specified by information 850, 854, the consumer's name, address, email and other personally identifiable information remains anonymous as part of this process. Although this example shows a mortgage quote process, this would also be the same process for pricing quotes and applications for other financial products, including bank accounts, credit cards, mortgages, home insurance, auto insurance, and other financial products (and financial products embedded into another product offer, like cell phone financing offered through cell phone service agreements, or financing offers for a specific car). In another example, system 912 creates recommendations automatically by monitoring, e.g., at specified time intervals. In some implementations, based on information provided by a mobile application, or through other data linked to the user (e.g., a change in shopping habits, or change in product usage perceived by the system via linkage to the account), the system will determine that the current products held by the user are a mismatch, perhaps resulting in too-high price given the change in location or situation, totally unbeknownst to the user. The system perceives that and alerts the user proactively based on inputs the system has passively collected to help optimize the user's situation.

Referring to FIG. 29, networked environment 900 includes network 902, client devices 904, 908, system 912 and data repository 914. In this example, client device 904 is associated with a user who is a financial service provider 906. For example, financial service provider 906 uses client device 904 to access the financial service provider portal and to view applications. Client device 908 is associated with user 910, e.g., a consumer. In this example, user 910 uses client device 908 to view recommendations of financial products that are specific to the consumer, to request quotations of financial products, to view quotations of financial products, to request applications for financial products, to view applications for financial products, to apply for financial products, and so forth.

System 912 is a system for generating recommendations of financial products and for implementing the techniques and operations described herein. For example, system 912 includes the various systems described herein, e.g., financial product curation and scoring system 70, the recommendation system 126 and other systems described herein. The various systems included in system 912 may be implemented as an engine. For example, recommendation system 126 may be implemented as a recommendation engine within system 912. In this example, system 912 generates the provider portal and transmits information to client device 904 to promote approval of application requests and quotations. System 912 also transmits to client device 908 various types of information, including, e.g., information indicative of a recommended financial product, a score (e.g., a proprietary score) for the financial product, approval of various financial products, specialized offers for financial products, and so forth.

Database 914 includes the various databases that are described herein, including, e.g., customer profile database 22, curated and scored financial product information database 82, and so forth. In an example, the contents of customer profile database 22 and curated and scored financial product information database 82 are integrated into a single database and are included in database 914.

Referring to FIG. 30, client devices 904, 908 can be any sort of computing devices capable of taking input from a user and communicating over network 902 with system 912 and/or with other client devices. For example, client devices 904, 908 can be mobile devices, desktop computers, laptops, cell phones, personal digital assistants (“PDAs”), iPhone, smart phones, iPads, servers, embedded computing systems, and so forth.

System 912 can be any of a variety of computing devices capable of receiving data, such as a server, a distributed computing system, a desktop computer, a laptop, a cell phone, a rack-mounted server, and so forth. System 912 may be a single server or a group of servers that are at a same location or at different locations. The illustrated system 912 can receive data from client devices 904, 908 via input/output (“I/O”) interface 920. I/O interface 920 can be any type of interface capable of receiving data over a network, such as an Ethernet interface, a wireless networking interface, a fiber-optic networking interface, a modem, and so forth.

System 912 includes memory 924, a bus system 922, and a processing device 926. Memory 924 can include a hard drive and a random access memory storage device, such as a dynamic random access memory, machine-readable media, or other types of non-transitory machine-readable storage devices. A bus system 922, including, for example, a data bus and a motherboard, can be used to establish and to control data communication between the components of system 912. Processing device 926 may include one or more microprocessors and/or processing devices. Generally, processing device 926 may include any appropriate processor and/or logic that is capable of receiving and storing data, and of communicating over a network (not shown).

Referring to FIG. 31, system 912 implements process 950 in recommending a financial product to a consumer. In operation, system 912 compares (952) personal profile information of a consumer to financial product information for financial products. The personal profile information includes information indicative of one or more preferences of the consumer, e.g., pricing preferences that specify a desired price of the financial product, payment preferences that specify an amount of a monthly payment the consumer can afford, geographic preferences that specify a desired geographic location of a financial service provider, and so forth. The financial product information includes information indicative of attributes of the financial products, e.g., a price attribute, a payment amount attribute, a geographic location attribute, and so forth.

System 912 identifies (954), based on the comparing, one of the financial products with a higher relevance to the consumer relative to relevances of others of the financial products. In an example, relevance is measured by a number of matched between preferences and attributes. System 912 also generates (956), based on the identified financial product, a financial product recommendation specifically for the consumer.

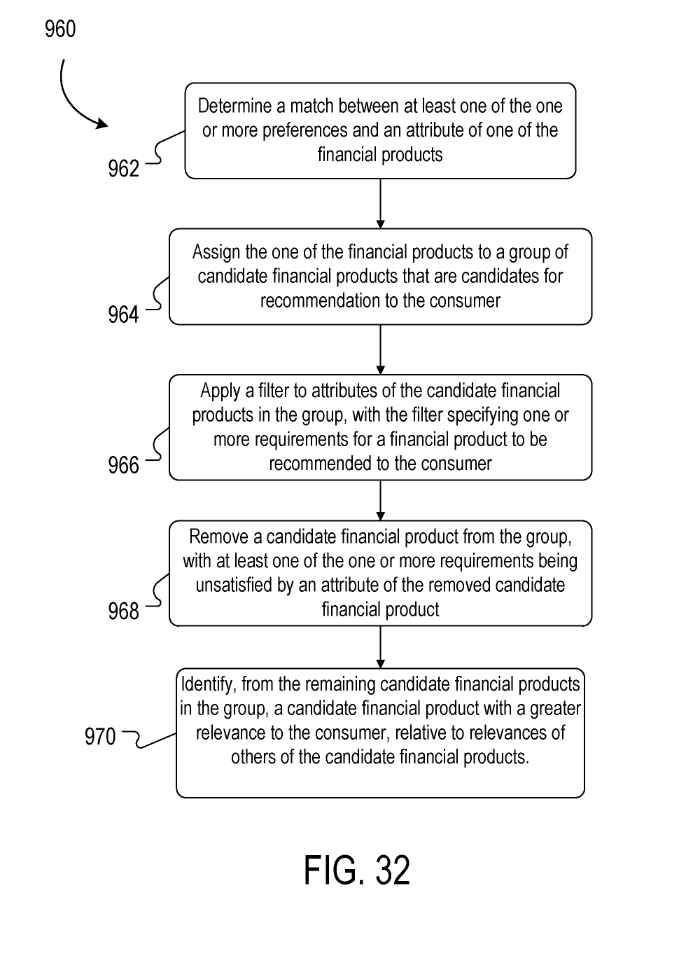

Referring to FIG. 32, system 912 implements process 960 in generating a recommendation for a financial product. In operation, system 912 determines (962) a match between at least one of the one or more preferences and an attribute of one of the financial products. System 912 assigns (964) the one of the financial products to a group of candidate financial products that are candidates for recommendation to the consumer. System 912 also applies (966) a filter to attributes of the candidate financial products in the group, with the filter specifying one or more requirements for a financial product to be recommended to the consumer. System 912 removes (968), based on application of the filter, a candidate financial product from the group, with at least one of the one or more requirements being unsatisfied by an attribute of the removed candidate financial product. System 912 identifies (970), from the remaining candidate financial products in the group, a candidate financial product with a greater relevance to the consumer, relative to relevances of others of the candidate financial products.

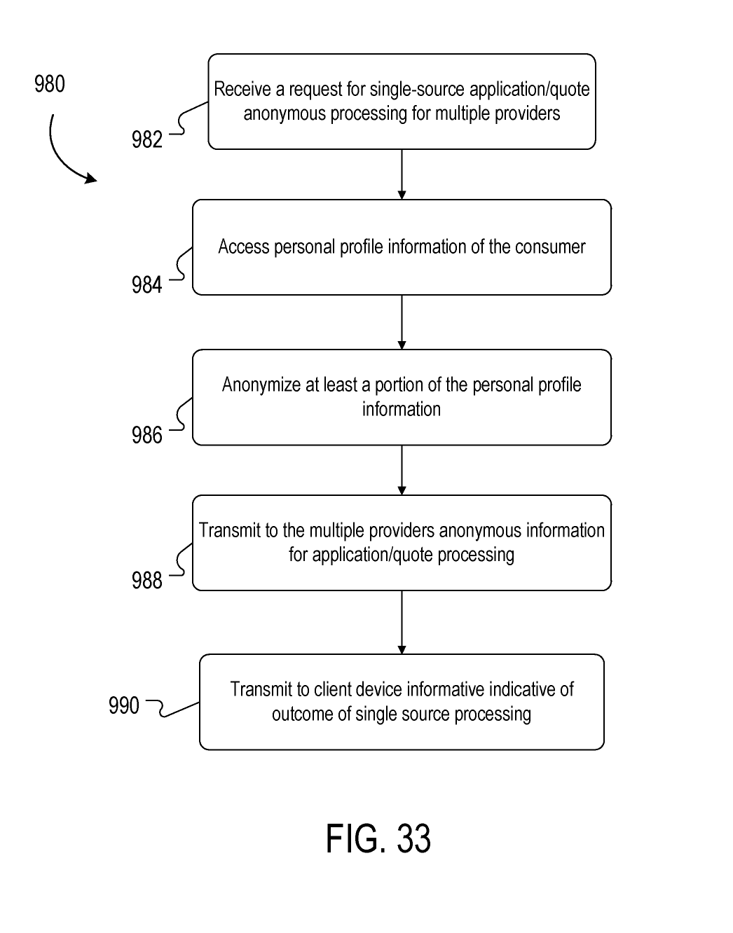

Referring to FIG. 33, system 912 implements process 980 in performing single-source application and/or anonymous processing for multiple service providers. In operation, system 912 receives (982) a request for single-source application/quote anonymous processing for multiple providers. In response to the request, system 912 accesses (984), from a database 914, personal profile information of the consumer. System 912 anonymizes (986) at least a portion of the personal profile information by removing, from the personal profile information, identifying information of the consumer. System 912 transmits (988) to the providers the anonymous information for application and/or quote processing. In response, system 912 receives (not shown), from devices associated with the multiple providers, information indicative of results of the application and/or quotation processing. Using this received information, system 912 transmits (990), to a client device of the consumer, information indicative of an outcome of the single source processing. In an example where the single source processing is single source application processing, the outcome includes an outcome of the application processing, e.g., approval and/or denial of the application. In an example where the single source processing is single source quotation processing, the outcome includes an outcome of the quotation processing, e.g., price quotes for various financial products of the financial service providers.

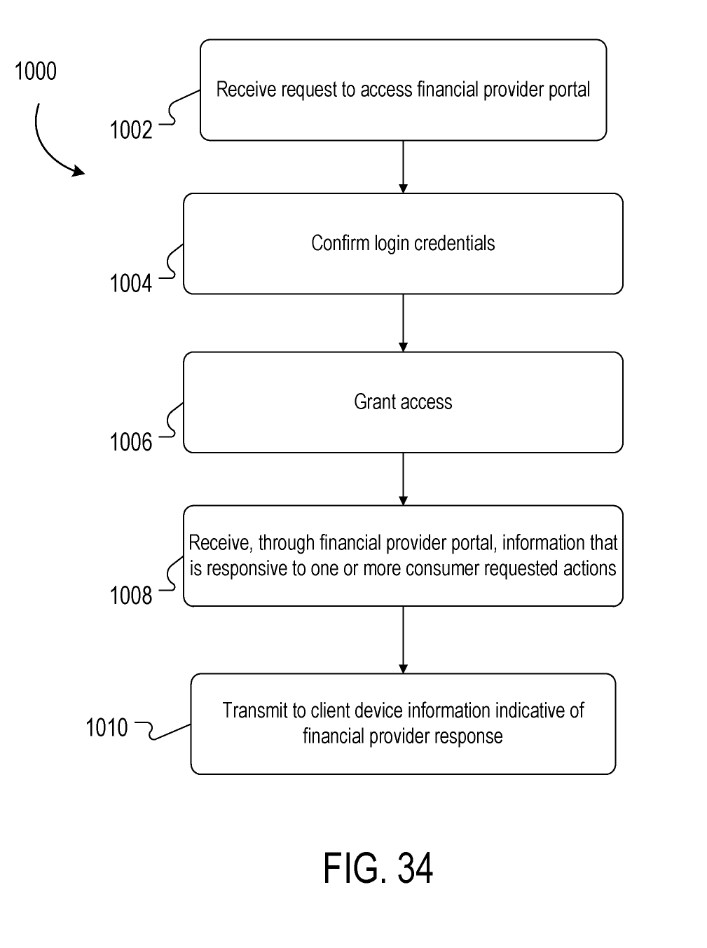

Referring to FIG. 34, system 912 performs process 1000 in enabling a financial service provider to interact with a provider portal. In operation, system 912 receives (1002), from a client device (e.g., client device 904), a request to access a financial provider portal. The request includes login credentials, e.g., a user name and a password. Using the received login credentials, system 912 confirms (1004) that the financial service provider is authorized to access the portal. In response to confirming, system 912 grants (1006) the service providers with access to the portal and with access to information within the portal that the service provider is authorized to view (e.g., applications for products of the service provider).

In this example, system 912 receives (1008), through the financial provider portal and from the financial service provider, information that is responsive to one or more consumer related requests. The responsive information may include information indicative of approval or denial of an application, information representing a price quotation, and so forth. System 912 transmits (1010), to a client device (e.g., client device 908) information indicative of the response.

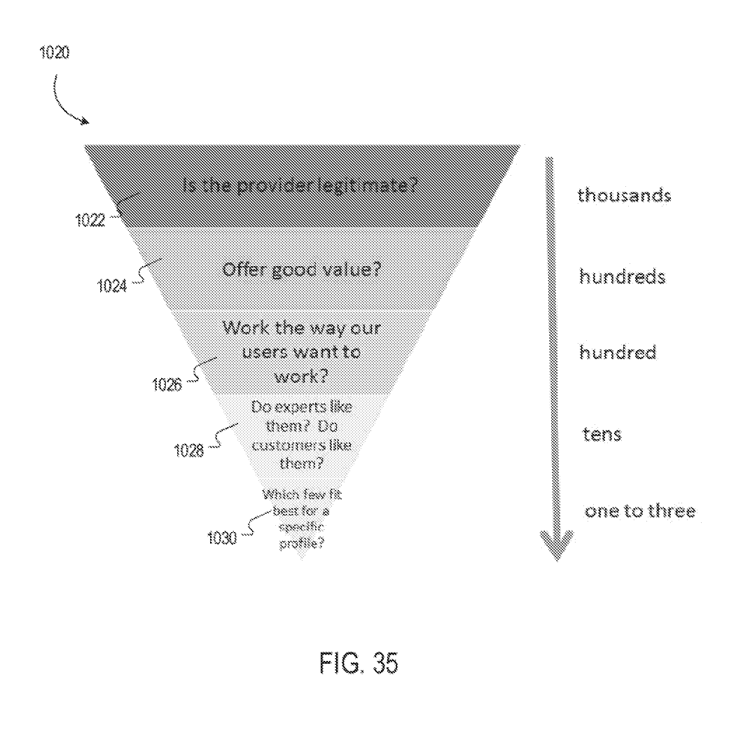

Referring to FIG. 35, system 912 implements process 1020 in curating financial products. Through a curation process, financial products are narrowed from thousands of financial products (e.g., by assessing whether a financial service provider meets baseline performance hurdles) to a few financial products that are dynamically matched to a user and discretely ranked to form a recommendation. If system 912 determines that a financial service provider does not meet baseline performance hurdles, then system 912 ceases evaluation of that service provider. As shown in FIG. 35, system 912 curates financial products by evaluating the financial product and/or provider along criteria 1022-1030. If a financial product and/or provider fails to satisfy one of the criteria, system 912 cease the curation process for that product.

In an example, system 912 implements a series of operations for the curation process, as shown in the below Table 1A.

TABLE 1A

| | | | Funnel |
|---|---|---|---|
| | | | (number of |
| Sequence | Steps | Data Sources | providers) |
| Step 0 | Define the specific mortgage | MBA | 1000+ |
| | options available | | |
| Step 1 | Secure the entire universe of | MBA | 300+ |
| | mortgages available | | |
| Step 2 | Screen for legitimate providers | MBA | 50+ |
| Step 3 | Screen for geographic location | MBA data (down to the county level) | 40+ |
| Step 4 | Score for pricing/value | Company Websites/Mystery Shopping | 10-20 |
| Step 5 | Score application and closing | Company Websites/Mystery Shopping/ | 5-15 |
| | process | MBA data | |
| Step 6 | Score reputation attributes of | Mystery Shopping, Social Media, | 5-15 |
| | provider | CFPB, BBB, FI sites | |
| Step 7 | Calculate the total Cinch score to | Cinch Scores | 5-10 |
| | determine Cinch Picks | | |
| Step 8 | Screen in for exceptions missed in | Cinch Research | 5+ |
| | the data and/or computation | | |
| Step 9 | Build links to Cinch formulas to | Company Websites/Mystery Shopping | 1-3 |
| | calculate customer specific pricing | | |

As described in the above Table 1A, system 912 implements steps 0-9 in curating financial products and providers. System 912 obtains data from various sources, including, e.g., mortgage banker's association (MBA) and the public filings required by the Home Mortgage Disclosure Act (HMDA). As shown above, the number of providers is narrowed or funneled from 1000+ providers to one or three providers, which are then scored. In this example, system 912 evaluates a financial provider based on the criteria specified in the various steps. For example, the scoring of the closing process is performed by system 912 through analysis of the closing attributes shown in the below Table 3. System 912 also evaluates other of the curation policies shown in Tables 1, 2 based on the attributes shown in the below Table 3.

In an improved example, system 912 implements the series of operations for the curation process shown in Table 1B, below:

TABLE 1B

| | | | Funnel |
|---|---|---|---|
| | | | (number of |
| Sequence | Steps | Data Sources | providers) |
| Step 0 | Identify the inventory of mortgage providers | HMDA/Melissa Data/Factset/FFIEC | 7000+ |
| Step 1 | Screen out non-retail and specialty lenders | HMDA/Melissa Data/Factset/FFIEC | 5000+ |
| Step 2 | Screen for legitimate providers | HMDA/Melissa Data/Factset/FFIEC | 2000+ |
| Step 3 | Filter by product type recommendation | HMDA/Melissa Data/Factset/FFIEC | 1000+ |
| Step 4 | Filter by geographic relevance (down to the town level) | HMDA/Melissa Data/Factset/FFIEC | 100+ |
| Step 5 | Filter by consumer mortgage preferences | Company Websites/Cinch Research | 50+ |
| Step 6 | Rank (score) based on lender performance | HMDA/Melissa Data/Factset/FFIEC/ | 20+ |
| | | Cinch Research | |
| Step 7 | Rank (score) reputation | Company Websites/Cinch Research | 20+ |
| Step 8 | Rank (score) business practices | Company Websites/Cinch Research | 20+ |
| Step 9 | Screen in exceptions missed in the data and/or computation | Cinch Research | 10+ |
| Step 10 | Recommend 1-3 lenders or expand geographic area and | Cinch scoring rubric | 1-3 |
| | re run engine | | |

As described in the above Table 1B, system 912 implements steps 0-10 in curating financial products and providers. System 912 obtains data from various sources, including, e.g., the public filings required by the Home Mortgage Disclosure Act (HMDA), third-party providers, and proprietary research. As shown above, the number of providers is narrowed or funneled from 7000+ providers to one or three providers, which are recommended based on their dynamic matching and discrete ranking (i.e., score). In this example, system 912 evaluates a financial provider based on the criteria specified in the various steps. For example, the scoring of the provider's performance is performed by system 912 through analysis of the geo-located performance attributes shown in the below Table 3. System 912 also evaluates other of the curation policies shown in Tables 1, 2 based on the attributes shown in the below Table 3.

As shown in the below Table 2A, system 912 implements various curation screening and scoring policies for a financial product, e.g., a mortgage.

TABLE 2A

| Curation Step | Policy |
|---|---|
| Product Segments | 2 products by Transaction type: Purchase and Refinance |
| Product Segments | 3 products by Transaction amount: Conforming, Jumbo, FHA |
| Product Segments | 3 products by Product type: 30 yr. fixed, 15 yr. fixed, 5/1 ARM |
| Providers | Provider score will be unique by state due to value differences at the state level |
| Providers | Must right in the covered DMA's |
| Weighting Scores | weight each segment equally |
| Weighting Scores | attributes weighted based on relative importance |
| Weighting Scores | Attributes where sentiment cant be derived receive a score of 75 |
| Legitimacy | Scale at least 50 bps market share |
| Legitimacy | Close Rate above average |
| Legitimacy | Denial Rate above average |
| Legitimacy | Exclude correspondent and broker, i.e. focus only on retail lenders |
| Geographic Coverage | Per research and if unknown assume county of incorporation for local providers |
| Value | Assume <80% LTV and adjust with fit score and screens for providers that don't |
| | serve low DP consumers |
| Value | Assume good credit (720) and adjust fit score accordingly for lower credit |
| Value | Use average loan amounts for conforming and jumbo to calculate fees and expected |
| | pricing for score-$201,000 and $75,000 |
| Value | Cinch includes lender and third party fees- they have the same impact on the consumer |
| Value | Compare 0% or lowest point mortgages for each provider |
| Value | Include cost of points if applicable as a component of the fee |
| Value | Include all provider and third party fees |
| Value | Amortize fees over a 5 year time horizon to match average mortgage duration |

As shown in the above Table 2A, system 912 curates (e.g., categories) the various products by various criteria, e.g., product segments, providers, weighting scores, legitimacy, geographic coverage and value. For example, system 912 groups into a product segment various types of products, e.g., products with a similar transaction amount or products with a denial rate about average, and so forth. That is, system 912 analyzes the attributes of the various financial products and curates them into various group based on similarities among the products. These curations are then used in answering the questions as shown in the above Table 1. In this example, the curations promote categorization of the various financial product and assist system 912 in answering the questions shown in the above Table 1.

As shown in the above Table 2A, system 912 determines values based on various policies. In this example, if a financial product fails to satisfy one of the value policies, system 912 determines that the financial product is not a good value. System 912 performs similar operations for the other curation policies.

An improved version of the process shown in Table 2A is set forth in Table 2B below.

TABLE 2A

| Curation Step | Policy |
|---|---|
| Screening | Include only direct retail lenders that market directly to consumers |
| Screening | Include niche market providers and disrupters with compelling value that have at least |
| | 2 years of business history |
| Screening | Require baseline scale, denial, growth and abandonment hurdles across at least one MSA |
| Screening | Exclude lenders based on regulatory and compliance thresholds |
| Scoring Rubric-Dynamic Matching | 2 by Transaction Type: Purchase and Refinance |
| Scoring Rubric-Dynamic Matching | 2 by Transaction Amount: Conforming and Jumbo |
| Scoring Rubric-Dynamic Matching | Lenders are included/excluded based on a user's application preferences |
| Scoring Rubric-Dynamic Matching | Lenders are included/excluded based on a user's company preferences |
| Scoring Rubric-Discrete Ranking | Relative ranking is used to determine which if the lenders that made it through filtering will be shown |
| Scoring Rubric-Discrete Ranking | Both quantitative and qualitative attributes are included in the discrete ranking based on expert review |
| Scoring Rubric-Discrete Ranking | Relocated performance constitutes 50% of the ranking |
| Scoring Rubric-Discrete Ranking | Lender reputation constitutes 30% of the ranking rubric |
| Scoring Rubric-Discrete Ranking | Business practices constitutes 20% of the ranking rubric |
| Scoring Rubric-Discrete Ranking | Optimized to user's demographic scenario (e.g. income) |
| Scaring Rubric-Discrete Ranking | Lenders with scores below 50 are automatically excluded from the final results |
| Scoring Rubric-Discrete Ranking | Only 3 lenders are ultimately recommended |
| Scoring Rubric-Discrete Ranking | If no lenders score >75 in given geography-region is expanded to county and or MSA level |
| Scoring Rubric-Discrete Ranking | Data is refreshed on a weekly, monthly, quarterly and annual basis as available |
| Scoring Rubric-Discrete Ranking | If historical data is incorporated the look back period is no longer than 4 year |
| Recommendation | Start at the most granular level, but dynamically increase analysis location to drive more accurate results |

As shown in the below Table 3, system 912 implements the below shown scoring rubric, which is stored in a data repository.

TABLE 3A
Mortgage Scoring Rubric

| | Weight | | | |
|---|---|---|---|---|
| Value | 25% | | | |
| Application | 25% | | | |
| Closing | 25% | | | |
| Reputation | 25% | | | |
| Segment | Attribute | Weight | Attribute Type | Data Source |
| Application | Easy to get started online with a simple website | 30% | Company | Cinch research |
| | Easy to get started over the phone | 20% | Company | Cinch research/mystery shopping |
| | Simple application form and documentation checklist | 20% | Company | Cinch research |
| | Dedicated point of contact (phone/email) | 15% | Company | Cinch research/mystery shopping |
| | Local Branches or offices | 15% | Company | Cinch research |
| Closing | Close Rate | 30% | Segment | MBA data |
| | Closing Costs are easy to understand, transparent and | 20% | Company | Cinch research/mystery shopping |
| | competitive | | | |
| | Offers multiple closing cost and point options | 20% | Company | Cinch research/mystery shopping |
| | Denial Rate | 20% | Segment | MBA data |
| | Percentage of loan assets retained | 10% | Segment | MBA data |
| Reputation | Customer churn trend | 40% | Company | MBA data |
| | Social Media Profile | 40% | Company | Cinch Research |
| | JD Power | 10% | Company | Cinch Research |
| | CFPB | 10% | Company | JD Power and CFPB data |
| Value | Pricing-Interest Rate | 60% | Product | Cinch research/mystery shopping |
| | Lender Closing Costs | 30% | Product | Cinch research/mystery shopping |
| | 3rd Party Closing Costs | 10% | Product | Cinch research/mystery shopping |

As shown in the above Table 3A, system 912 generates a score for a financial product by evaluating the financial product in four segments, e.g., an application segment, a closing segment, a reputation segment and a value segment. In calculating the final score, system 912 assigns weight to each of the segments, as shown in Table 3. Additionally, system 912 evaluates each segment by various attributes and individually weights each attribute within a segment. For example, system 912 evaluates the application among various attributes, including, e.g., an “easy to get started online with a simply website” attribute and other attributes as shown in Table 3. Each attribute is associated with an attribute type, e.g., company, segment, product. There are various data sources for an attribute, including, e.g., internal research (i.e., Cinch research) and external data sources, including, e.g., MBA data. In this example, system 912 only generates scores for particular financial products, e.g., financial products that pass one or more of the criteria of the curation process.

An improved version of the process shown in Table 3A is set forth in Table 3B below:

TABLE 3B
Mortgage Scoring Rubric

| Attribute Type | Segment | Weight | | |
|---|---|---|---|---|
| Dynamic Matching | Product | Dynamic by User Type | | |
| | Geolocation | Dynamic by User Type | | |
| | Consumer Behavior | Dynamic by User Type | | |
| | Consumer Preferences | Dynamic by User Type | | |
| Discrete Ranking | Gelocated Performance | 50% | | |
| | Reputation | 30% | | |
| | Business Practices | 20% | | |
| Attribute Type | Segment | Attribute | Weight in Segment | Data Source |
| Dynamic Matching | Product | Transaction Type | Dynamic by User Type | HMDA/Melissa Data/Factset/FFIEC |
| | | Transaction Amount | Dynamic by User Type | HMDA/Melissa Data/Factset/FFIEC |
| | Geolocation | Town | Dynamic by User Type | HMDA/Melissa Data/Factset/FFIEC |
| | Consumer Behavior | Application options | Dynamic by User Type | Cinch Research |
| | | Mobile application | Dynamic by User Type | Cinch Research |
| | | Branch vs. online | Dynamic by User Type | Cinch Research |
| | Consumer Preferences | Other products | Dynamic by User Type | Cinch Research |
| | | Lender type | Dynamic by User Type | Cinch Research/HMDA |
| | | Membership requirements | Dynamic by User Type | Cinch Research |
| | | Loan servicing | Dynamic by User Type | HMDA/Melissa Data/Factset/FFIEC |
| | | Product Breadth | Dynamic by User Type | HMDA/Melissa Data/Factset/FFIEC |
| Discrete Ranking | Geolocated Performance | Origination growth | 40% | HMDA/Melissa Data/Factset/FFIEC |
| | | Denial rate | 30% | HMDA/Melissa Data/Factset/FFIEC |
| | | Abandonment rate | 15% | HMDA/Melissa Data/Factset/FFIEC |
| | | Scale | 15% | HMDA/Melissa Data/Factset/FFIEC |
| | Reputation | Cinch-insider reviews | 50% | Factset |
| | | Compliance history | 33% | Factset |
| | | Consumer reviews | 8% | Aggregated Data |
| | | Complaints | 8% | CFPB/Aggregated Data |
| | Business Practices | Online functionality | 50% | Cinch Research |
| | | Phone/Branch accessibility | 50% | Cinch Research |

As shown in the above Table 3B, system 912 generates a score for a financial product by evaluating the financial product in seven ←I only count six?] segments, e.g., a product segment, a geolocation segment, a consumer preference segment, a geo-located performance segment, a reputation segment, and a business practices segment. In making a recommendation, each financial product or provider or both is included or excluded using a dynamic matching logic and then filtered products or providers or both are ranked by calculating the final score. System 912 assigns a score based on the weight of each discrete ranking attribute, as shown in Table 3. Additionally, system 912 evaluates each segment by various attributes and individually weights each attribute within a segment. For example, system 912 evaluates the reputation among various attributes, including, e.g., a “complaints” attribute and other attributes as shown in Table 3. Each attribute is associated with an attribute type, e.g., geo-located, performance, reputation, business practices. There are various data sources for an attribute, including, e.g., internal research (i.e., Cinch research) and external data sources, including, e.g., HMDA data. In this example, system 912 only generates scores for particular financial products, e.g., financial products that pass one or more of the criteria of the curation process.

As shown in the below Table 4A, each attribute is associated with a score range and requirement.

TABLE 4A

| | | | Score | |
|---|---|---|---|---|
| Segment | Attribute | Weight | Range | Requirement |
| Reputation | Customer churn trend | 0.4 | 95 | Increasing market share |
| | | | 75 | Flat YOY |
| | | | 50 | Decreasing Market Share |
| | Social Media Profile | 0.4 | 95 | Strong positive |
| | | | 75 | Average/No sentiment |
| | | | 50 | Strong Negative sentiment |
| | JD Rower | 0.1 | 95 | Best in class |
| | | | 85 | above average |
| | | | 75 | ayergage/not covered |
| | | | 50 | below average |
| | CFPB | 0.1 | 95 | top 5 proyider by complaints |
| | | | 85 | above average |
| | | | 75 | average/not included |
| | | | 50 | below average |
| Application | Easy to get started online | 0.3 | 95+ | Mortgage rate estimator, easy to naviate website, prequalification, pre-approval |
| | with a simple website | | | options, easily evaluate loan and closing cost option |
| | | | 85 | Mortgage Rate estimator, pre-qualification, pre-approval options, explanation |
| | | | | of the process, evaluate different loan options |
| | | | 75 | Mortgage rate estimator, online pre-approval, explanation of the process |
| | | | 60 | Online application, easy to find contact number |
| | | | 50 | Online application |
| | | | 40 | Contact us only-no online engagement |
| | Easy to get started over | 0.2 | 95 | Direct to mortgage loan of officer |
| | the phone | | 75 | IVR leading to mortage loan officer |
| | | | 50 | IVR leading to inbound customer support queue |
| | Simple application form | 0.2 | 95+ | Online/Mobile App that allows for transfer of documents |
| | and documentation | | 85 | Easy to understand checklist that users can print cut to prep for the |
| | checklist | | | application process |
| | | | 75 | Webpage with list that isn't in a checklist format |
| | Dedicated point of | 0.15 | 85 | Dedicated Contact |
| | contact (phone/email) | | 65 | Serviced by multi member team |
| | Local Branches or | 0.15 | 95 | Branches throughout state |
| | offices | | 80 | Branches in major metro areas |
| | | | 50 | No Branches in the state |
| Closing Process | Close Rate | 0.3 | 95 | top 5 provider |
| | | | 85 | providers 6-15 |
| | | | 75 | providers 15+ |
| | Closing Costs are easy to | 0.2 | 95+ | Lists all the lender and 3rd party fees |
| | understand, transparent | | 80 | Lists all the lender fees and some of the 3rd party fees |
| | and competitive | | 60 | Lists the lender fees |
| | | | 50 | Lists no fees |
| | Offers multiple closing | 0.2 | 95+ | Includes No Points/No Closing cost options in addition to |
| | cost and point options | | | other combinations |
| | | | 85 | Multiple options for paying or not paying points with increasing |
| | | | | credits for different rate tiers |
| | | | 50 | Includes manditory origination fee even if points are eliminated |
| | Denial Rate | 0.2 | 95 | top 5 provider |
| | | | 85 | providers 6-15 |
| | | | 75 | providers 15+ |
| | Percentage of loan | 0.1 | 100 | 100% retention |
| | assets retained | | 85 | 80%+ |
| | | | 75 | 50%-80% |
| | | | 65 | <50% |
| Value | Pricing-Interest Rate | 0.6 | 0-100 | Forced Rank within the competitive set |
| | Lender Closing Costs | 0.3 | 0-100 | Forced Rank within the competitive set |
| | 3rd Party Closing Costs | 0.1 | 0-100 | Forced Rank within the competitive set |
| Total Score | | | | |

As shown in the above Table 4A, for the reputation segment, system 912 determines whether a service provider has an increasing market share (in which case the service provider is assigning a 95 for score range), and so forth. In this example, system 912 determines a reputation score (e.g., a weighted reputation score) for each reputation attribute, in accordance with the below formula:

Reputation score=(w₁)(customer churn trend score)+(w₂)(social media profile score)+(w₃)(JDPower score)+(w₄)(CFPB score), where w is a weighted value.

System 912 uses similar techniques in computing a value score, a closing process score and an application score. System 912 then calculates a propriety score in accordance with the below equation:

Proprietary score=(w₁)(reputation score)+(w₂)(value score)+(w₃)(closing process score)+(w₄)(application score), where w is a weighted value.

As shown above, the proprietary score is based on an aggregate of a reputation score, a value score, a closing process score and an application score. In other implementations, the proprietary score is based on application one or more various mathematical operations to a reputation score, a value score, a closing process score and an application score. Also, in this example, the proprietary score is based on a reputation score, a value score, a closing process score and an application score. In other examples, the proprietary score is based on other types of scores that are based on other types of criteria, segments and attributes.

An improved version of Table 4A is shown below in Table 4B.

TABLE 4B

| | | | Score | |
|---|---|---|---|---|
| Segment | Attribute | Weight | Range | Requirement |
| Geolocated Performance | Origination growth | 20% | 100 | Fastest growth in market (county and/or MSA) |
| | | | 75 | Increasing market share |
| | | | 50 | Flat markets share |
| | | | 25 | Shrinking market share |
| | Denial rate | 15% | 100 | Lowest denial rate in local market (town and or/county) |
| | | | 75 | Top quartile denial rate |
| | | | 50 | Average denial rate |
| | | | 25 | Below average denial rate |
| | Abandonment rate | 10% | 100 | Lowest denial rate in local market (town and/or county) |
| | | | 75 | Top quartile denial rate |
| | | | 50 | Average denial rate |
| | | | 25 | Below average denial rate |
| | Scale | 5% | 100 | Lowest denial rate in local market (town and or/county) |
| | | | 75 | Top quartile denial rate |
| | | | 50 | Average denial rate |
| | | | 25 | Below average denial rate |
| Reputation | Compliance history | 10% | 100 | No violations or lawsuits to originations |
| | | | 75 | Low ratio of violations or lawsuits to originations |
| | | | 50 | Average ratio of violations and lawsuits to originations |
| | | | 25 | High ratio of violations and lawsuits to originations |
| | Consumer reviews | 5% | 100 | Highest ratio of positive reviews of originations |
| | | | 75 | Above average ratio of positive reviews to originations |
| | | | 50 | Average ratio of positive reviews to originations |
| | | | 25 | Below average ratio of positive reviews to originations |
| | Complaints | 5% | 100 | Highest ratio of complaints to originations |
| | | | 75 | Above average ratio of complaints to originations |
| | | | 50 | Average ratio of complaints to originations |
| | | | 25 | Below average ratio of complaints to originations |
| | Cinch-insider reviews | 15% | 100 | Top lender ranking within the relevant MSA |
| | | | 75 | Strong lender ranking within the relevant MSA |
| | | | 50 | Average lender ranking within the relevant MSA |
| | | | 25 | Weak lender ranking within relevant MSA |
| Business Practices | Online functionality | 10% | 100 | Highest quality UX, pre-approval process and application functionality |
| | | | 75 | Simple preapproval process online |
| | | | 50 | Includes online preapproval and application functionality |
| | | | 25 | No online preapproval and/or application |
| | Phone/Branch accessibility | 10% | 100 | Large branch coverage within the MSA and/or 24/7 phone support |
| | | | 75 | Above average branch coverage within the MSA and/or extended |
| | | | | hours phone support |
| | | | 50 | Average branch coverage and phone support |
| | | | 25 | Below average branch coverage and phone support |

The description of Table 4B is similar to the description for Table 4A except that the reputation score is defined as

Reputation score=(w₁)(compliance history)+(w₂)(consumer reviews)+(w₃)(complaints)+(w₄)(Cinch−insider reviews), where w is a weighted value,

and the proprietary score is defined as

Proprietary score=(w₁)(geolocated performance)+(w₂)(reputation)+(w₃)(business practices), where w is a weighted value.

As shown in the below Table 5A, once a score (e.g., a proprietary score) is calculated, system 912 uses the data in the below Table 5A to evaluate the financial product, e.g., relative to other financial products.

TABLE 5A

| Scoring Criteria | |
|---|---|
| 90-100 | In the top 10 |
| 80-90 | Better than average |
| 70-80 | Average |
| 60-70 | Below Average |
| <60 | In the bottom quartile |

Segments weighted equally
Attributes within each segment weighted by relative importance

For example, a score 90-100 indicates that the financial product is in the top 10. Depending on the user's specific needs, preferences, and situation, these provider and product ratings may have no, some, or significant impact to the matching system. For example, a provider may be highly rated because it offers face-to-face services in branch locations, but that high rating is only of relevance to those users that value face-to-face service interactions. The matching and recommendation system renders and displays to the user those idiosyncratic selection factors based on her preferences and situation as further described below.

An improved version of Table 5A is shown below as Table 5B:

TABLE 5B

| Scoring Criteria | |
|---|---|
| 75-100 | Eligible for inclusion as top recommendations |
| 50-75 | Eligible for inclusion in recommendations |
| <50 | Excluded from recommendations |

The description of Table 5B is similar to the description of Table 5A except that, for example, a score 75-100 indicates that the financial product is eligible for inclusion as a top recommendation.

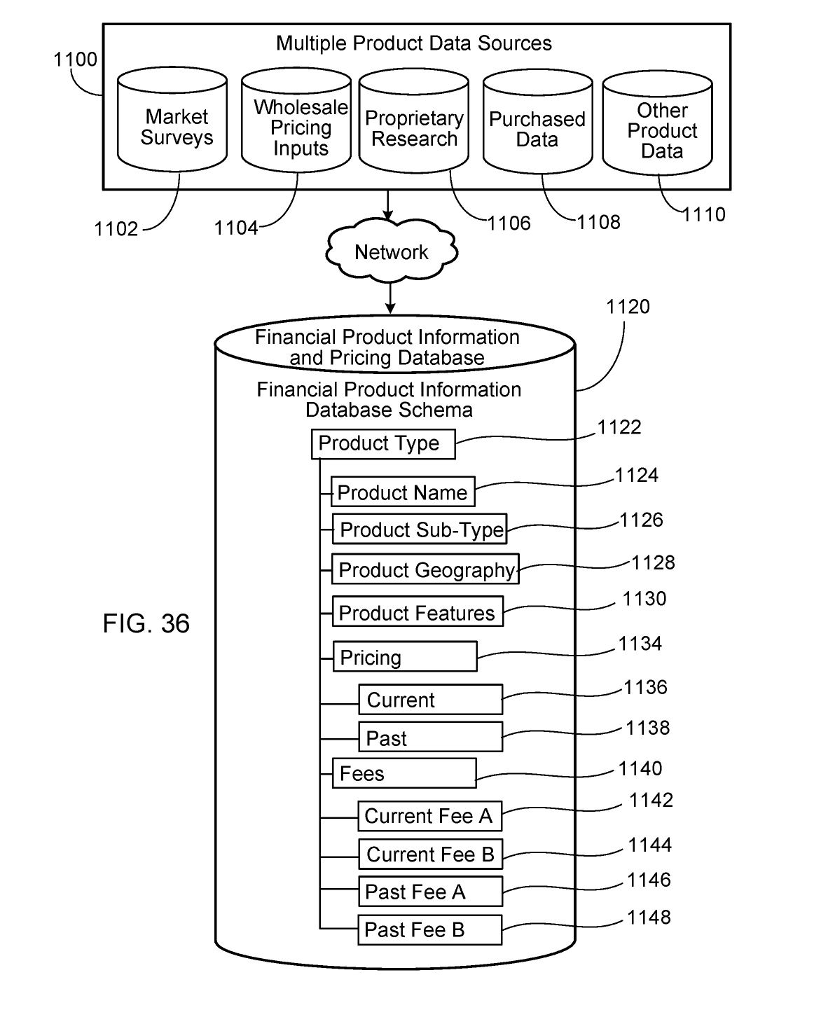

As shown in FIG. 36, in some implementations of the system that we are describing here, the financial product information and pricing database 1120 can include information that is provided from multiple product data sources 1100. The sources can include market surveys 1102, wholesale pricing inputs 1104, proprietary research 1106, purchased data 1108, and other product data 1110, among others. The database 1120 can include tables that capture a product type 1122, product names 1124, product subtypes 1126, product geography 1128, product features 1130, product pricing 1132, current product pricing 1134 in past product pricing 1136, fees associated with the product 1140, current fees A 1142, current fees B 1144, past fees A 1146, and past fees B 1148.

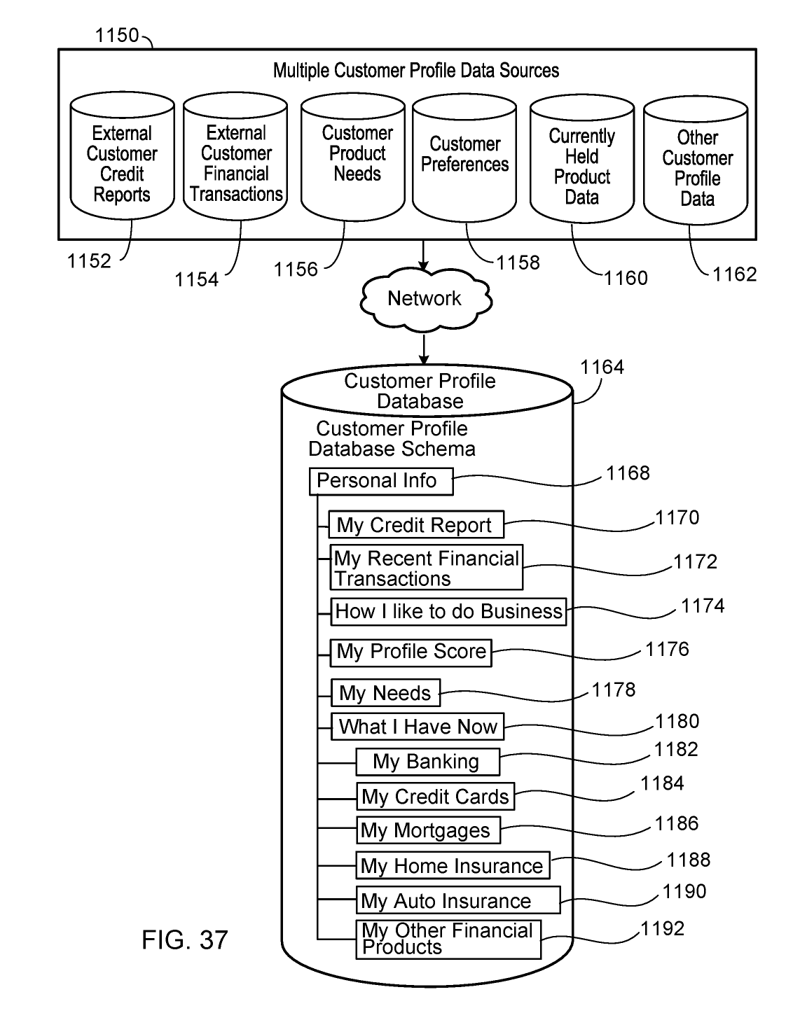

Also, as shown in FIG. 37, in some implementations of the system they we are describing here, the information in the customer profile database 1164 can be obtained from multiple customer profile data sources 1150, including external customer credit reports 1152, external customer financial transactions 1154, customer product needs 1156, customer preferences 1158, currently held product data 1160, and other customer profile data 1162.

A wide variety of systems, features, and applications can be provided based on combined uses of the two databases, the financial product information and pricing database 1120 in the customer profile database 1164.

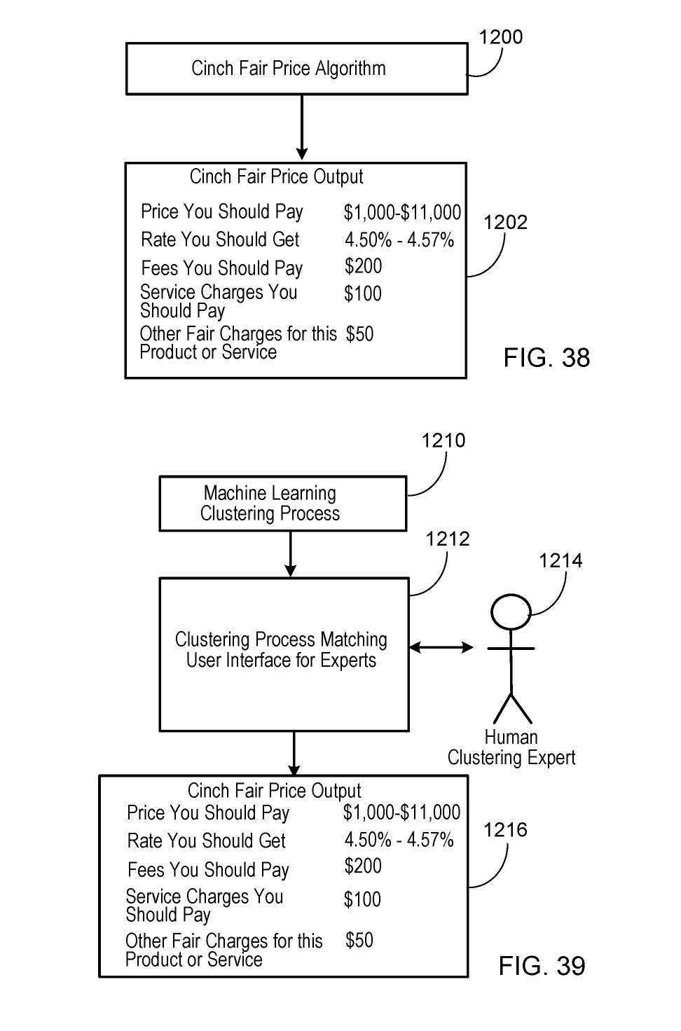

For example, as shown in FIG. 38, a fair price algorithm 1200 can be applied to the two databases to produce fair price outputs 1202 that can be displayed to users.

In some implementations the fair price (which we sometimes call a putative price) represents an estimate of pricing of the financial product (for example, the interest rate for a mortgage) and fees an estimate of fees for completing a transaction associated with the financial product (for example, origination fees, documentation fees, and other fixed and variable fees required to secure a financial product or loan). This is an estimate of pricing and fees that a specific anonymous user (we sometimes refer to the user as a consumer) in a highly competitive marketplace would pay for the specific financial product based on the user's specific situation. The user demand and demand specific situation may include identifications of current financial products held by the user, credit characteristics of the user, and certain anonymized user characteristics and needs. The fair price establishes the optimum (for example, the likely lowest) pricing and fees (or range of pricing and fees) for a product given specific inputs. The fair price is intended to help users negotiate and secure the best possible terms in a transaction to acquire the financial product, such as a loan, bank account, credit card, mortgage, cell phone plan, or other monthly bill.

The fair price can be rendered on a one-time basis, or on a periodic basis with the user alerted periodically to trigger a purchase alert that may affect the user's decision to engage in a transaction with respect to a particular financial product.

In some implementations, to generate a fair price, comprehensive pricing inputs are obtained by first creating a dynamic data set comprising a host of sources, including market surveys, purchased data, wholesale pricing inputs, proprietary research data, each of which may in change on a continuous basis and are monitored by an automated and manual system that takes the inputs and compares those values over a period of time to the new values resulting from a changing financial environment.

Among the multiple product data sources 1100, market surveys include pricing trends that are collected from providers of financial products. Purchased data include reports that describe components factoring into a final price, such as fees charged by providers. Wholesale pricing inputs include prevailing interest rates for specific risk and product types. Proprietary research data include quantitative reports based on data collection and interviews with providers.

Among the data derived from the multiple customer profile data sources 1150, are current products that the user already owns 1180. These current products may demonstrate preferences or needs related to the product currently needed. Data about demographic characteristics and needs may also be used. In some implementations, these two datasets 1120 and 1164 are then processed using software algorithms 1200 to render the fair price for particular products. Each fair price is rendered especially for a particular user, for the specific situation and need being experienced by the user at that time, and taking account of external pricing input factors such as the cost of money to lenders, the general risk environment, and the product type.

The pricing inputs used by the algorithm are delivered into the datasets using APIs, episodic direct file transfers, software bridges, and manual inputs into a portal. The data sets are updated on an automatic and manual basis.

The user profile represented by the customer profile database schema 1164 is comprised of some or all of the following five sources: 1) credit bureau data received through API links; 2) a user's answers to questions regarding, for example, underwriting criteria that are entered through a user interface; 3) if applicable, information about the user's product and personal preferences; 4) other enhancement data from third parties concerning the user's financial condition and preferences received through API links, and 5) for users of mobile phones, location-based and other relevant data for, e.g., the underwriting inputs describing physical location. This information is stored as part of the unique user profile in the database 1164. A series of algorithms then transforms these inputs into pricing factors for the product.

The algorithm takes each of these input factors described above for the user and creates a numerical value, or score, that is a mathematical expression of the input factor. A weighting is applied to the factor to establish relationships among the factors so that minor inputs can be distinguished from major inputs affecting the expected interest rates and fees for a financial product for a particular user. These factor weightings can change over time and vary with the situation at hand. In this way input factors are combined and weighted to generate an aggregate score for that user in that specific situation for that specific product as reflected by the profile inputs. This aggregate user score, a numerical value generated by the process described above, is then used to select interest rate pricing and fees (described above) from a table representing the most advantageous pricing offered in the marketplace for customers who belong to that specific profile type. □

In some implementations of the system, machine learning software is used to automatically first cluster, then group, consumer profiles and financial products. Then human experts match those consumer profiles to the specific financial products (without the creation of a decision tree algorithm, for example) through a user interface to the machine learning software. This process is used to aid, and may be combined with or replace, the decision tree algorithm development for matching the financial products to the customer profiles to reach an optimal financial product for a given consumer profile.

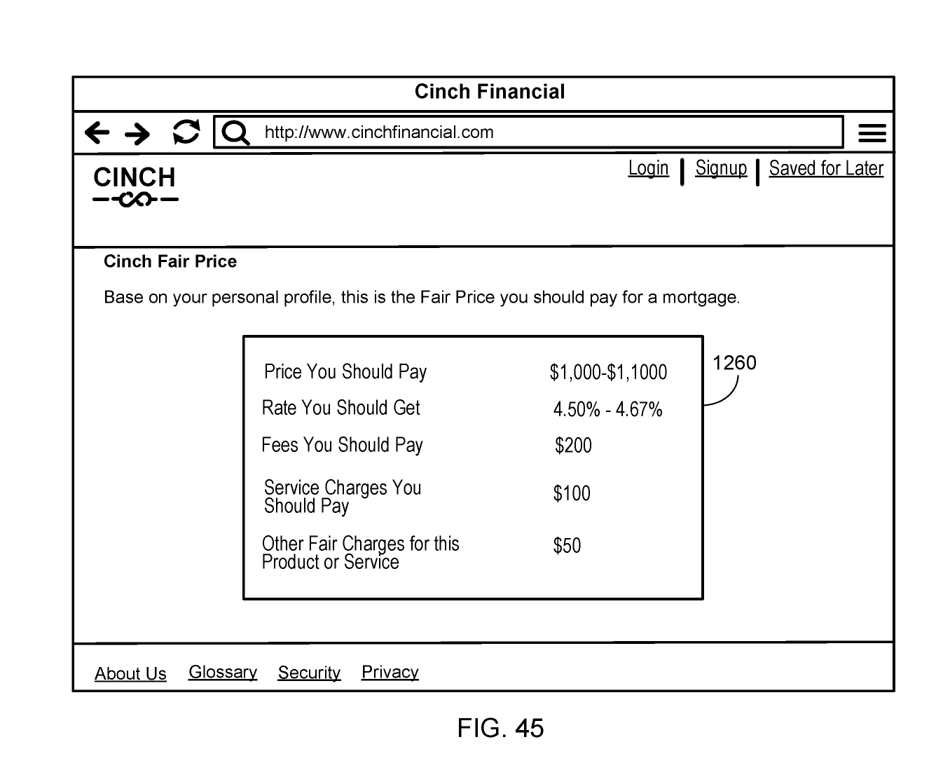

Software then renders the output of the algorithm or the machine learning process into a visual design as shown in FIG. 45 includes information 1260. The visual design can be transmitted to a computer, tablet, or smartphone screen, shared with other individuals using links to email, texting, and social media, as well as printed. The system can be programmed to re-run user profiles against financial products on a periodic basis to detect pricing changes of relevance to the user. An alert is automatically triggered to the user based on his or her communication preferences through email, text, push notification, or phone call.

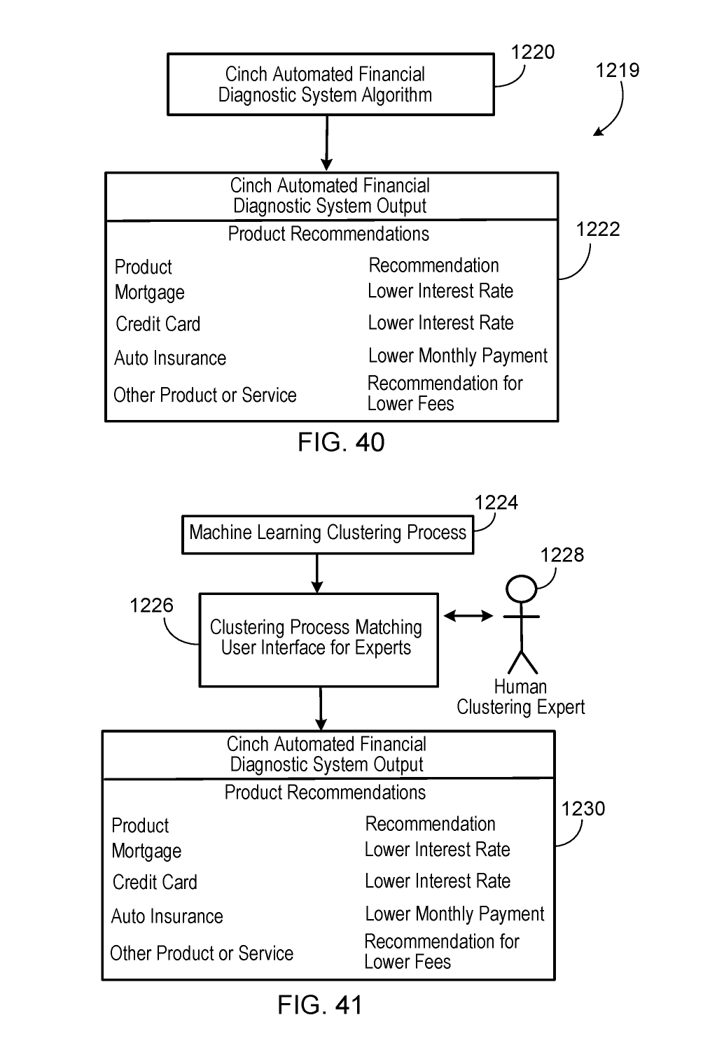

As shown in FIG. 40, in some implementations, a feature that we sometimes refer to as an automated financial diagnostic system 1219 analyzes a user's large monthly bills (e.g., mortgage, credit card, banking, lending, cell phone bills, or cable/internet) and provides an initial analysis of which financial products might be poorly priced or not aligned with the user's needs. The result of the analysis provides a starting point and prioritization of those financial products that require action to ensure they are optimal for the user. The analysis is intended as a simple scan of a user's largest bills to further engage the user in optimizing those financial products, and saving money. The output of the process is a snapshot report to the user delivered via email, text, push notification or other messaging service.

To support the analysis in the generation of the snapshot, the system obtains the user's transaction history for his or her primary and secondary payment accounts (e.g., checking account, credit card, etc.). The transaction history data are uploaded into the system. On a real-time basis, that is, as current data is stored, the system identifies the large monthly and other bills that are contained in the larger body of data and that correspond to the mortgage payment, credit card payment, banking, lending, cell phone, cable/internet, and other large bills of the user. The system generates a list of the accounts and the providers of the financial products to the user to confirm with the user that these indeed are the providers of these particular services.

Once confirmed by the user, the system creates a current profile of the user with respect to those types of services and the large bills paid to those providers. The current profile is then compared to other aggregate, model profiles that are generated on an ongoing basis to represent typical large payments made to providers of these types by a population of users. These aggregate profiles are used to compare, or benchmark, the amounts paid by the user for the products provided by those types of providers.

For example, if the system reveals that the user is paying $500 for her cell phone plan, and similarly situated users are only paying $200 (as demonstrated by the model profiles), the cell phone service will be flagged for the user as a priority item for further analysis. Once analyzed by the system, the user is provided a snapshot report detailing these interim findings with respect to all of the relevant large bills and providers, and suggesting action to address those items.

To perform the analysis and generate the snapshot, the system starts by identifying the user in a secure environment and requesting from the user the identification information for the primary and secondary transaction accounts.

This account identification information is transmitted through a secure software linkage to a third party bill aggregator. The aggregator receives the secure request and provides the transaction information from the accounts to the system after the user has provided his or her credentials. A software matching process operated by our system identifies the likely product providers (based on names or in other ways) from all of the transaction data and conveys that to its personal profile of the user in the database of the system for storage and analysis. A software algorithm 1220 then matches the user's transaction profile (that is, the portion of the user's personal profile that represents the stored transactions from the aggregator) to an appropriate corresponding aggregate model profiles that have been stored in a comparison database of the system to identify a best-match similar aggregate model profile. The matching to identify the best aggregate model profile is done by comparing demographic and other attributes of the user with demographic and other attributes of populations of users represented by the aggregate model profiles.

Over time, the system creates additional aggregate model profiles and fine-tunes existing aggregate model profiles based on its experience with users using machine learning techniques based on the spending behaviors, locations, situations, and other attributes of populations of users gleaned from the transaction accounts of the users. As shown in FIG. 41, the system uses a machine learning clustering process 1224 to cluster populations of users based on their attributes and to form aggregate model profiles for the respective clusters.

The machine learning techniques use specialized software to become more accurate and refined at identifying the appropriate matching aggregate model profile, and can be further trained, or “tuned” 1230 by expert human operators 1228 to discern more sensitively the matches between the model profiles and user attributes.

Once a best-match aggregate model profile is identified, it is then compared by an automated matching system to the user's transaction profile, and the financial product configurations (e.g., the terms and features of the products) and pricing of the user's transaction profile in the best-match aggregate model profile are compared. A meaningful difference that is identified in the provider or the product pricing for the individual user compared to the best-match aggregate model profile is then flagged in the user profile database.

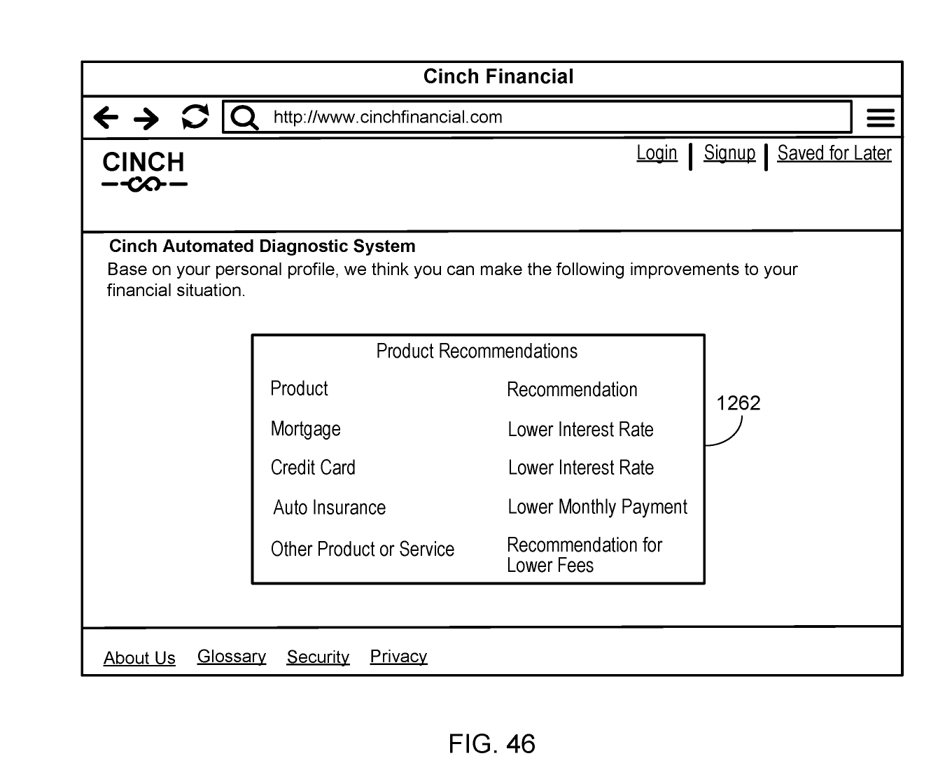

The system then uses software to generate the output 1230 of the matching algorithm and machine learning system as a visual design that can then be rendered on a computer, tablet, or smartphone screen, shared with other individuals through links to email, texting, and social media, or printed. 0 an example of an online presentation 1262 of the output 1230 is shown on FIG. 46.

The system can be programmed to repeat the analysis and snapshot generation process based on current user inputs, transaction histories, and other information. The repetition can be done on a periodic basis to detect pricing changes of relevance to the user represented by updated aggregate model profiles; and an alert can be automatically triggered to the user based on his or her communication preferences through email, text, push notification or phone call.

In some implementations, the system provides what we refer to as a virtual underwriter function. The virtual underwriter enables a user to simulate portions of an application for a financial product that requires underwriting and to get a virtual approval report back indicating whether the application would be underwritten. The process is arranged so that the submission of the virtual approval application will not negatively affect the user's credit score, or risk a “real” credit denial (which would be logged at the financial institution and on the user's credit report and may negatively impact the user's credit score). As an output, the virtual underwriter feature generates a user's virtual approval report, which can be used to develop an affordable budget of the user for acquiring the financial product and for use in provider negotiations by the user. This feature extends the SafeQuote capability described above.

The virtual underwriter feature operates by emulating portions of the underwriting system of an actual lender or other financial product provider. As one source of information, the system accesses credit bureau information in the role of a non-lender, that is, in a role such that the credit bureau will not treat the interaction as a “real” interaction by a lender making an actual underwriting decision. The system does this by providing the same types of information to the credit bureau that an underwriter would provide in the course of processing a real application for credit, but without the system being identified as a real lender. This results in no impact on the credit report generated by the credit bureau. The user's credit file received from the credit bureau is imported into a credit file profile portion of the user's personal profile.

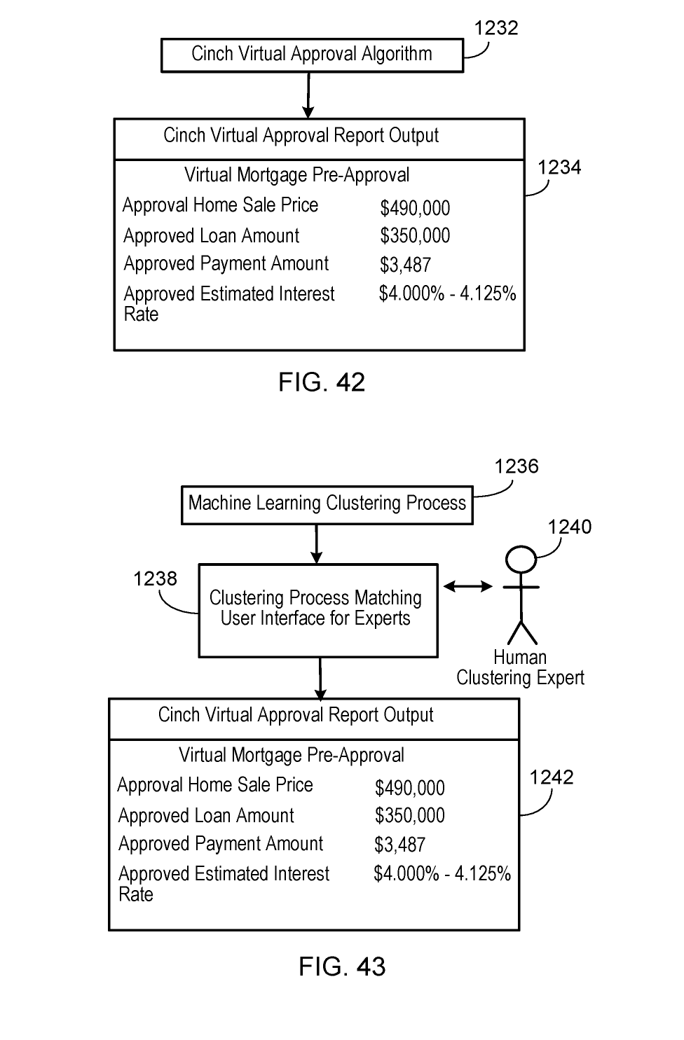

As shown in FIG. 42, the credit file information serves as an input to a virtual underwriter algorithm 1232. The user's personal profile provides inputs to the algorithm that include name, address, income, and last 4 digits of a user's social security number to secure a credit report. The credit file, and these other profile inputs, are transmitted to a software system which contains the algorithm 1232 that simulates an underwriting process used by a typical provider of the financial product involved.

The algorithm includes underwriting criteria that, in this example, a lender would use to approve credit based on the type of loan and credit spectrum involved. These criteria could include debt to income ratios, past payment performance, credit score, open credit lines, and number of credit inquiries from potential lenders (indicating a more intense need for borrowing).

The output of the algorithm is then processed to render a virtual approval report. In combination with fair price discussed earlier, the user then has a fair price (including interest rate, fees, and product type) providing a representation of what a good product and price looks like, and knows the likelihood that a lender will approve the user's application. In combination these reports provide the user with more bargaining power in negotiation with product providers, which will lead to lower prices or better terms or both.

As shown in FIG. 43, in some implementations of the system, machine learning software 1236 is used to first cluster, then group, user profiles and user credit reports, and then human experts 1240 match those user profiles to approval probabilities represented by the relevant clusters and groups (without the creation of a decision tree algorithm) through a user interface 1238 to the machine learning software. This process is used to aid, and may replace, the decision tree algorithm development for matching the optimal financial product to a profile.

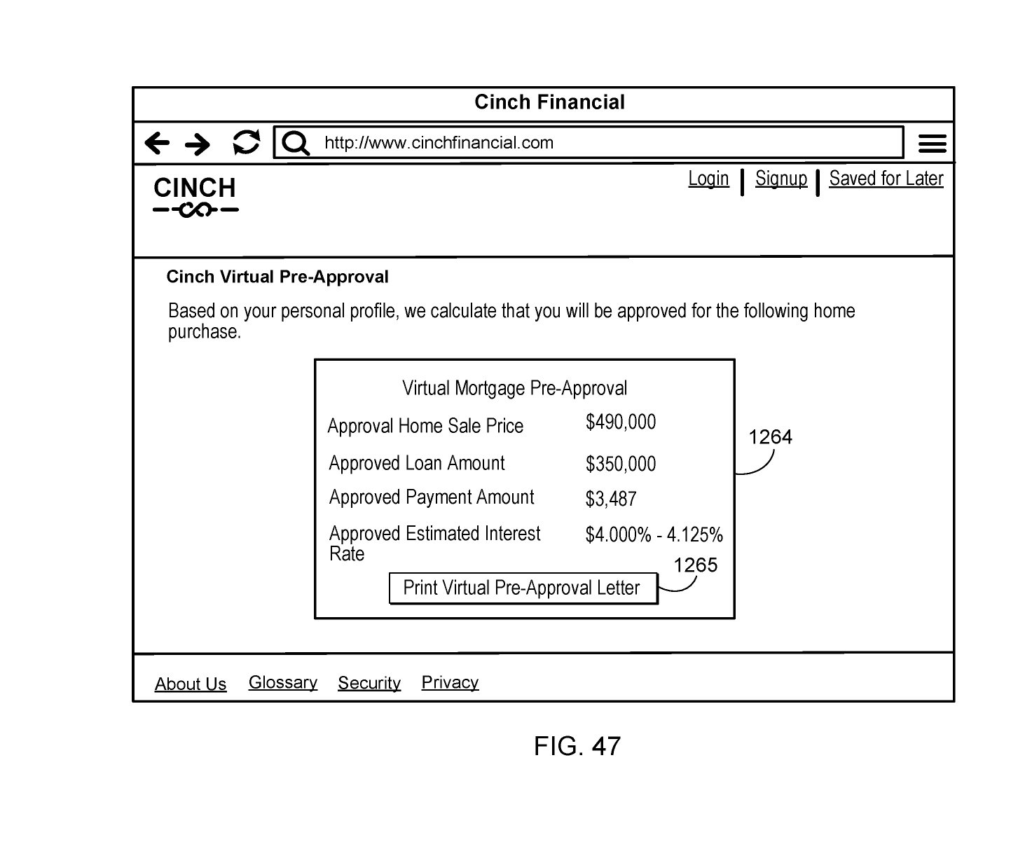

To render the virtual approval report 1242, underwriting inputs are conveyed to an underwriting profile portion of the user profile. The underwriting inputs are obtained from some or all of the following five sources: 1) credit bureau data delivered through API links; 2) a user's answers to questions required to access a credit report listed above that are entered through a user interface; 3) if applicable, information about the user's existing financial product and personal preferences; 4) other enhancement data from third parties concerning the user's financial condition and preferences delivered through API links, and 5) for users of mobile phones, location-based data for underwriting inputs describing physical location. This information is stored as part of the underwriting profile portion of the unique user profile in the database. An algorithm uses these five input sources to determine the pre-approval conditions rendered in the virtual approval report. Software then renders the algorithm output into a visual design which can then be rendered on a computer, tablet, or smartphone screen, shared with other individuals through links to email, texting, push notifications, and social media, as well as printed. An example of an online presentation includes the information in box 1264 and the print button 1265 shown in FIG. 47.

In some implementations, a dynamic matching system (DMS) allows a specific user to get insight into which is the best possible financial product for the user's specific situation and needs. In addition, DMS regularly monitors the user's situation and financial product inventory to ensure that a given financial product is the optimum product (for example, has the lowest price with the best features for the user's needs) given continuously changing personal situations and a shifting product marketplace. This means the user can always be sure the user has the best possible deal. The DMS system is robust because it can optimally match a specific product to a specific user in a fully dynamic and bias-free manner.

DMS operates by creating a user profile, generating a fair price (see above) for a given user profile, and then comparing the fair price to an inventory of available vetted products suitable for the user or a marketplace of providers willing to meet the terms of the fair price or both. User inputs can cover a broad range of possible user types and situations. Characteristics of user types would include various creditworthiness profiles, geographic locations, demographic profiles, and other defining features that will influence the financial products recommended. Situations would include the context of specific needs of the user, e.g., a first time homebuyer trying to get a mortgage; an unexpected expense that requires financing; or a purchase of a new car requiring a new insurance policy.

The output is a DMS report, provided through a software application, text, email, push in-application messaging, or similar communication medium, detailing optimum product matches.

In some implementations, product matches include a combination of preferences and pricing generated by a computer algorithm that optimizes price and feature tradeoffs. The computer algorithm uses user profile inputs that result in either including or excluding certain products based on the inputs. For example, if a user is attempting to get a mortgage for a property in Massachusetts, mortgage underwriters that do not write mortgages in Massachusetts are eliminated from consideration by the algorithm. Another example would be the algorithm eliminating credit card products that require a high income for those users with a lower income.

For initial DMS reports, this matching process happens at the user's request. For those users requesting ongoing monitoring to ensure optimum fit and pricing, the process is repeated on a monthly (or other periodic) basis. Users may determine the conditions under which they wish to be notified on a pricing or fit basis. Users whose circumstances change (e.g., a move to a different location) can re-initiate the process by providing new profile inputs, or by allowing the system to monitor key inputs (e.g., location) to generate proactive reports on savings opportunities. In some applications, based on information provided by a mobile application, or through other data linked to the user (e.g., a change in shopping habits, or change in product usage perceived by the system via linkage to the account), the system will determine that the current products held by the user are a mismatch, perhaps resulting in too-high price given the change in location or situation, totally unbeknownst to the user. The system perceives that and alerts the user proactively based on inputs the system has passively collected to help optimize the user's situation.

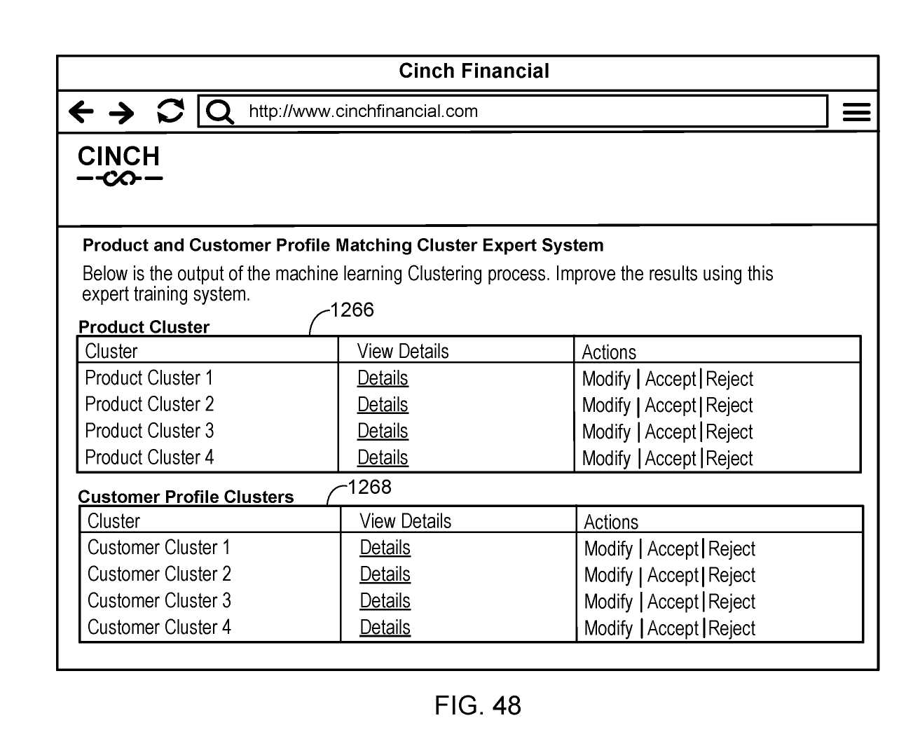

In some implementations of the system, machine learning software is used to first cluster, then group, profiles and products, and then human experts match those profiles to products (without the creation of a decision tree algorithm) through a user interface to the machine learning software. As shown in FIG. 48, the user interface lists product clusters 1266 and customer profile clusters 1268 and provides the user the opportunity to modify, accept, or reject each of them. This process is used to aid, and may replace, the decision tree algorithm development for matching the optimal product to a profile.

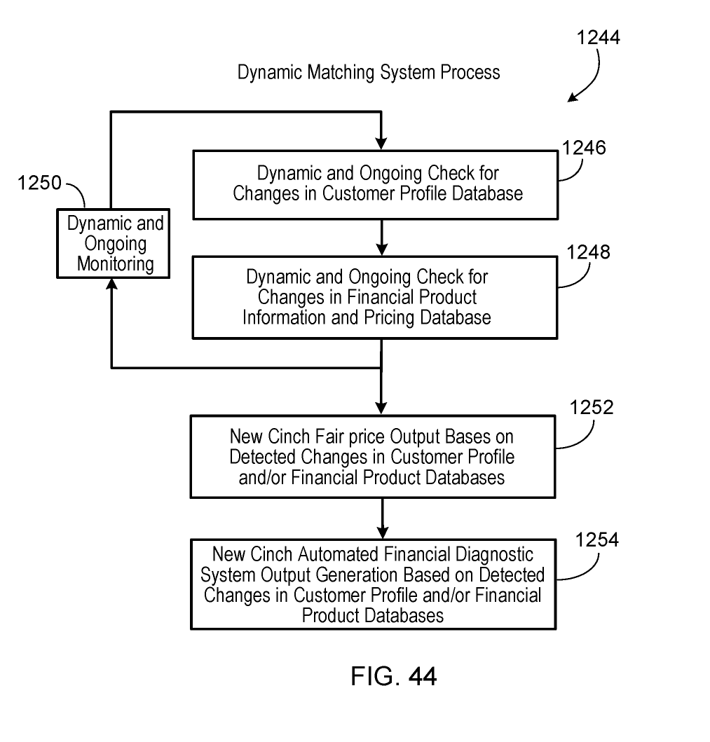

As shown in FIG. 44, in the dynamic matching system process 1244, there is dynamic and ongoing monitoring 1250 of user profiles and market information. The system engages in dynamic and ongoing checking for changes in the customer profile database 1246 and also engages in dynamic and ongoing checking for changes in financial product information and pricing database 1248. Based on detected changes in the customer profile of the financial product databases or both, new fair price outputs are generated 1252. In addition, based on detected changes in the customer profiles or the financial product databases or both, new fair price outputs are generated.

To render the DMS report, user profile inputs are conveyed to the user profile in the database from some or all of the following five sources: 1) credit bureau data delivered through API links; 2) a user's answers to questions regarding underwriting criteria that are entered through a user interface; 3) if applicable, information about the user's incumbent product and personal preferences; 4) other enhancement data from third parties concerning the user's financial condition and preferences delivered through API links, and 5) for users of mobile phones, location-based and other relevant data inputs useful to optimizing product matching. This information is stored as part of the unique user profile in the database. An algorithm uses these five input sources to determine the fair price (see above) for a particular user's situation and product need. Software then renders the algorithm output into a visual design which can then be rendered on a computer, tablet, or smartphone screen, shared with other individuals through links to email, texting, push notifications, and social media, as well as printed.

Although the system that we describe here and the techniques by which the system directly provide information and guidance to the users helps its users optimize their financial products, their costs, and more generally their financial lives. Effective dissemination of the advantages of the system may be difficult, however, when only a single provider offers them. Such dissemination will be improved by better engagement with users and potential users.

In some implementations, the system and its advantages can be deployed on a private label basis through trusted third parties, for example, third parties whose objectives are aligned with the goal of optimizing users' financial lives. Examples of trusted third parties that have relationships and engage effectively with end users include employers, personal financial management and investment companies, and other organizations that have an interest in saving money for their constituents.

To disseminate the system on a private label basis, the system can be deployed as a partner platform through engagements with the trusted third parties. We use the term platform broadly to include, for example, any system capable of supporting services through such trusted third parties (which we sometimes also called “partners”). This use of the system is distinct from the use of the system by a single brand for its own users, which we sometimes refer to as a retail deployment.

In some implementations, a partner platform is realized using the following features:
1. A user interface system capable of supporting and mimicking the brand, look, and feel of communications and presentations in use by a partner;
2. A modular design allowing a partner to modify the presentations with respect to financial products that have been analyzed or optimized by the system (e.g., a bank deploying a partner platform for the benefit of its employees may want to disable the bank financial product optimizer features);
3. A system fully deployable behind a partner firewall so that the platform partners do not have to transmit personal information about their constituents to the system;
4. A software system that allows a partner to request data from the system through an application program interface (API) using security credentials provided to the partner by the system.
5. Features of parts of the host dynamic matching system (DMS):

Part 1: The user interface for a platform partner is identical to the host system user interface from a design perspective, but it allows for a platform partner to add its own brand, company logo, and color scheme to the user interface that it presents to its users so that it is clear the partner is endorsing use of the platform by the partner's constituents. Software code renders the user interface to display on a computer, tablet, or phone screen. A partner software development kit (SDK) is provided to the partner. The SDK includes software code and instructions to allow the partner to fully customize its user interface (with logos, trademarks, and color schemes relating to the partner). That software code renders the functional user interface using this customized design, which is then deployed by the partner to its constituents.

Part 2: The modular design allows the partner to select only those financial products and types of financial products that it wants its constituents to optimize (e.g., to find the lowest price product with the best features). For example, a bank wishing to helps its employees save money on the bank's financial product and related bills may not want to suggest that its employees use another bank for their personal checking account needs. In such an implementation, the partner will access a partner control panel to determine which financial products and types of financial products it wishes its constituents to optimize or otherwise be exposed to through the user interface. Software code in the partner's system then modifies the financial product categories and financial products displayed in the user interface. In this example, the bank offering the platform as an employee benefit would de-select “Bank Accounts”, and the resulting user interface would be modified to eliminate this product category through software code controlling the rendering on the computer, tablet, or phone screen.

Part 3: Deploying the platform behind a partner's firewall: For privacy and regulatory reasons, partners may not want to deploy the system in a way that requires the partner to transmit any personal details about its constituents to the system hosts, or to any other third party. The partner system allows the platform to be deployed behind the Cinch partner's firewall so that the system host's storage systems never house the partner's constituents' personally identifiable data, such as name, address, and contact information. This is effected by creating a partner user profile database within the partner's own system. Software linkages between this private profile database and the system host's DMS inventory and selection software would allow for operation without the system host housing personally identifiable information while allowing full operation of the DMS.

Part 4: An application program interface is provided as a software system that allows the partner to securely access the Cinch system.

Part 5: The DMS described above.

In some implementations, a partner deploys the host system's user interface for its constituents using its own brand imagery, look, and feel. In all material respects this platform can be identical to the retail platform.

As described above, users create a personal profile. The profile draws information from some or all of the following six sources: 1) credit bureau data delivered through API links; 2) a user's answers to questions regarding underwriting criteria that are entered via a user interface; 3) if applicable, information about the user's incumbent product and personal preferences; 4) other enhancement data from third parties concerning the user's financial condition and preferences delivered through API links, 4) for users of mobile phones, location-based and other relevant data inputs useful to optimizing product matching. This information is stored as part of the unique user profile in a database, and 6) data from the partner's system that provides context on a user's situation or preferences.

For example, a partner that is a brokerage company would have information regarding the credit score of a partner user. In this situation, it would not be necessary to get a separate credit report on behalf of the user, because that information is already part of the partner's customer database. Unlike the retail platform, this partner system resides behind the firewall of the partner. This is done so that the host's system does not receive any personally identifiable information regarding the partner user. In this way the privacy policies and any regulatory restrictions on sharing information with third parties is avoided. In other respects, the host's system works as described above, for example, generating fair price and virtual underwriting reports and enabling dynamic matching. The software algorithms necessary to complete these operations are stored and operate outside of the partner firewall, but are completed on an anonymous basis using matching user codes generated by the partner system. In other respects the partner's system operates in a fashion similar to the retail platform.

As shown in FIGS. 55 through 59, in some implementations, interaction with an end user is done through a user interface of a mobile device 1300. In some examples, the interaction is conducted in a simple, easy, and conversational way using a digital assistant 1302 in the form of a helper called, for example, Alex. Messages 1303 from Alex to the user can appear in text on the screen of the mobile device or be spoken through the speaker of the mobile device or both. After the user logs in (registering first, if necessary, 1302), Alex asks questions 1306 to prompt the user to enter personal information that will be used by the system in way similar to the ones described earlier. When a specific question is asked, a text entry box 1308 can be displayed in the user can enter the requested information 1310 through the keyboard. In some cases, the questions can be asked audibly through the speaker of the mobile device and the user can respond by speaking to the device. Alex acknowledges 1312 the user's entry and in general conducts an interactive conversation with the user that makes the use of the system inviting, pleasant, and accurate.

In the discussion above, we have frequently made reference to machine learning. As shown in FIG. 60, in some implementations of machine learning useful for the techniques we have described here, two datasets (known inputs 1302 and known outputs 1304) are used to create robust matching algorithms 1306 that “learn” and get more accurate with repeated iterations in producing current appropriate outputs for given current inputs. The matching between those two datasets, reflected in those machine learning algorithms, expresses the underlying “connections” between the known inputs in the known outputs.

In a movie recommendation system, for example, the known input data set could contain data relating to characteristics of viewers and the known output data set could contain information about movies previously viewed by the viewers (in other words, past viewing habits of viewers). The main function of the movie recommendation system would be to provide (as current outputs 1308) suggestions for other movies the viewer might like.

These machine learning systems are a foundational element for most e-commerce platforms.

For consumer financial products, the known input data includes demographic and other information about the users and their circumstances and the known output data includes the products and features that they chose to acquire or use. The typical machine learning process described above does not work well or may be impossible, because, unlike the known outputs of which movies viewers decided to view, many, or most financial decisions consumers make about which products and features to acquire or use our erroneous because of information asymmetry, confusing mathematical concepts (e.g. the arithmetic difference between APR and interest rate), very advanced financial structures and lingo being beyond the ken of most people (e.g. 5/1 capped ARMs), and perceptual bias mistakes most consumers commit which are well documented by behavioral economists (e.g., inability to properly evaluate risk; economic impact of interest charges, etc.). In other words, the known outputs (the consumer's decisions about products and features) can be matched in the machine learning system with the demographics, characteristics, and circumstances of users but the matching is not helpful because what is learned is connections between known inputs and disadvantageous known outputs.

This situation can lead to great inefficiency in the consumer financial marketplace and frequent disadvantageous mismatches between customers and financial products.

To circumvent this situation, we use what we call a synthetic matching development tool (SMDT) that enables machine learning techniques to be applied to matching of consumers and products in context in which consumer decisions have the potential of being incorrect or incomplete. The SMDT enables machine learning to be applied effectively in the face of information-asymmetric, confusing, and behaviorally complex product categories such as consumer lending, selection of products with multiple comparison dimensions, and goal-based savings decisions. The SMDT is a prototyping tool to develop matching engines than can then be put into production.

As shown in FIG. 60, the SMDT 1310 operates by ingesting input data (known inputs) describing a consumer's personal profile (past spending, demographic detail such as household size and composition, credit performance information like credit score, and other preferences and attributes that should be deterministic of good product matches for a given product type. These data are ingested from various sources that we have described, including API linkages with third party data providers, and internal databases. The ingested information is housed in a personal profile database 1312. The process is repeated to create a consistent dataset for thousands, or millions, of customers.

A software computing process 1314 then finds clusters 1318 of profiles corresponding to key dimensions that apply to a given situation and product need. A given profile 1316 may have membership in several clusters 1318. For example, a given profile may join a cluster of similarly situated profiles for the purposes of optimizing a family cell phone account and dataplan because the household sizes tend to be similar, as well as in another cluster based on the locations where the cell phone is used.

These data comprise the SMDT input dataset. All profiles and cluster memberships are stored in a relational or unstructured database 1312 with corresponding access tools to extract data.

To create a synthetic output dataset 1320 required to implement a machine learning algorithm, financially correct, fully optimized product “decisions” or optimized outcomes, are loaded into the synthetic output database 1320 through a network. The sources 1322 for the product decision outputs that are loaded into the known outputs 1320 depend on the nature of the product, but may range from experts assembling product outputs, to specialized statistical algorithms that generate multiple product sets, each with varying features organized to express the optimal features efficiently using reductive mathematical principles.

For consumer debt products, for example, these inputs may be loaded directly from a screened set of providers as discussed earlier, each of which is annotated with identifiers corresponding to optimized use situations (e.g., long-term debt pay-down, short-term cash need, etc.). The output data is stored in a relational or unstructured database.

These known inputs and synthetic outputs are then matched using a machine learning algorithm, guided by a process utilizing product-specific experts providing guidance through an expert portal 1322 connected by API to the machine learning algorithm software service.

The result is an optimized matching process and algorithm using a normalized and correct approach to the outputs to eliminate error propagation. As the SNDT algorithm gains experience with actual profiles, and as other data sources are added, certainty continues to rise and the matching engine becomes more robust. This SMDT system is then connected by a network to a production matching software system for implementation after the prototyping and algorithm development are completed.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope of the claims.

1. A computer-implemented method comprising
regularly receiving through a communication network from providers of financial products or from an aggregator or both, current information about transactions that occur in accounts of consumers of financial products that are maintained with providers of the financial products,
storing the received current transaction information in a database of information about the respective consumers,
applying machine learning to the stored transaction information and other information about the consumers in the database to generate model profiles of transactions in accounts of corresponding categories of consumers for corresponding financial products,
as current information about transactions is received, analyzing transactions that have occurred in the accounts of the consumers of the financial products using the model profiles for the applicable categories of customers and financial products, and
alerting through a communication network each of the consumers for whom transactions occurred that did not conform to the corresponding model profile.

2. The method of claim 1 in which the analyzing of transactions comprises analyzing large transactions.

3. The method of claim 1 in which the alerting of each of the consumers comprises prioritizing the large transactions for action by the consumer.

4. The method of claim 1 in which the alerting of each of the consumers comprises delivering at least one of email, text, push notification, or other messaging medium, or a combination of any two or more of them.

5. The method of claim 1 comprising confirming with each of the consumers that the transactions are for accounts of the consumer.

6. The method of claim 1 in which the analyzing of the transactions comprises generating a profile of the consumers based on the database of information about the respective consumers and comparing the profiles consumer with the corresponding model profile.

7. The method of claim 1 in which the model profiles reflect prices paid by consumers in the respective categories for particular products.

8. The method of claim 1 in which the storing of the received transaction information in the database comprises identifying financial product providers and transactions that are expected to correspond to the respective consumers and storing those transactions in the database in association with the respective consumers.

9. The method of claim 1 in which the categories of the consumers are based on spending behaviors, locations, situations, other attributes, or combinations of two or more of them.

10. The method of claim 1 in which the analyzing of the transactions comprises identifying an appropriate one of the model profiles that corresponds to each of the consumers.

11. The method of claim 10 comprising training or tuning a machine learning environment to improve accuracy of the identification of the appropriate model profile.

12. The method of claim 1 comprising, based on changes in the information about the respective consumers, again analyzing transactions that have occurred in the accounts of the consumers of the financial products using the model profiles for the applicable categories of customers in financial products.

13. A computer-implemented method comprising
regularly receiving through a communication network current data related to prices available in a competitive market for a financial product,
storing in a database information about a prospective consumer of the financial product, the information comprising attributes of the consumer that relate to the financial product,
based on the attributes of the consumer with respect to the market prices for the financial product, by computer generating a putative price for the financial product, the putative price representing a price that the consumer ought to be willing to pay for the product in the competitive market.

14. The method of claim 13 comprising obtaining the information about the prospective consumer by interaction through a mobile device using a digital assistant.

15. The method of claim 13 in which the price comprises fixed and variable costs to engage in a transaction for the financial product.

16. The method of claim 13 in which the information comprising attributes of the consumer that relate to the financial product comprises current products held by the consumer, credit characteristics of the consumer, or anonymized characteristics and needs of the consumer, or combinations of any two or more of them.

17. The method of claim 13 in which the putative price comprises an optimum or likely lowest price.

18. The method of claim 13 comprising regenerating the putative price as current data about prices is received.

19. The method of claim 13 in which the regular receiving of current data comprises receiving current data from multiple sources, the current data including market surveys, purchased data, wholesale prices, proprietary research data, or a combination of two or more of them.

20. The method of claim 13 in which the regular receiving of current data comprises use of an API, episodic direct file transfer, a software bridge, manual input, or a combination of any two or more of them.

21. The method of claim 13 in which the storing in a database of information about a prospective consumer of the financial product comprises receiving information from multiple sources, the information comprising credit bureau data, underwriting criteria, the consumer's product and personal preferences, data provided from third parties concerning the consumer's financial condition and preferences, location-based information about the consumer, or a combination of any two or more of them.

22. The method of claim 21 comprising by computer transforming the stored information into pricing factors based on the financial product.

23. The method of claim 22 in which the transforming comprises quantifying and weighting parts of the information and combining them into a score.

24. The method of claim 23 comprising by computer applying the score to a table to select the putative price.

25. The method of claim 13 in which the generating of the putative price comprises applying machine learning processes to cluster and group financial products and profiles of consumers.

26. A computer-implemented method comprising
receiving from a consumer through a communication network information indicative of a request for a putative underwriting decision on a financial product,
accessing as a non-provider of the financial product, through a communication network, from a credit bureau, information that a provider of the financial product would use in making an actual underwriting decision on the financial product for the consumer,
generating by a computer the putative underwriting decision using the information from the credit bureau and personal information about the consumer that has been stored in a database, the putative underwriting decision simulating aspects of the actual underwriting decision in the financial product for the consumer, and
providing to the consumer through a communication network a report of the putative underwriting decision.

27. The method of claim 26 comprising obtaining the information indicative of the request for a putative underwriting decision by interaction through a mobile device using a digital assistant.

28. The method of claim 26 in which the accessing of the credit bureau as a non-provider of the financial product does not affect a credit reputation of the consumer.

29. The method of claim 26 in which the financial product comprises credit in the underwriting decision comprises whether to extend the credit to the consumer.

30. The method of claim 26 in which the personal information of the consumer that has been stored in the database comprises name, address, income, last four digits of the Social Security number, or a combination of two or more of them.

31. The method of claim 26 in which the putative underwriting decision is based on underwriting criteria that include debt to income ratio, past payment performance, credit score, open credit lines, number of inquiries from potential providers of the financial product, or a combination of two or more of them.

32. The method of claim 26 in which the putative underwriting decision is generated algorithmically.

33. The method of claim 26 comprising applying a machine learning process to cluster and group profiles of consumers and credit reports, and match the profiles to approval probabilities, and the putative underwriting decision is made by matching an optimal product to a profile of the consumer.

34. The method of claim 26 in which the personal information about the consumer that has been stored in a database comprises information provided by the consumer required to access a credit bureau, information about the consumer's incumbent product and personal preferences, information about the consumer's financial condition and preferences, location-based data, or a combination of two or more of them.

35. A computer-implemented method comprising
maintaining in a database current information about a particular consumer, the current information being related to transactions in financial products in which the consumer has engaged or indicative of suitable future transactions in which the consumer may engage,
maintaining a database of current information about financial products that are available in a competitive market, the information including prices and features,
using a computer to generate current putative prices for financial products, the putative price for each of the financial products representing a price that the consumer ought to be willing to pay for the financial product in a competitive market,
selecting by computer, from the database of current information about financial products that are available in the competitive market, a set of financial products that conform to the generated putative prices and to the current information about the particular consumer, and
providing to the consumer, through a communication network, information about the selected set of financial products and their putative prices.

36. The method of claim 35 in which the selecting of a set of financial products comprises selecting financial products that have the lowest prices, or the best features, or are otherwise optimal.

37. The method of claim 35 comprising repeating the selecting of the set of financial products in response to changes in information about the particular consumer or changes in financial products available in the competitive market, or both.

38. The method of claim 35 in which the information about the particular consumer comprises credit worthiness, geographic location, demographics, or a combination or two or more of them, that correspond to possible selections of the set of financial products.

39. The method of claim 35 in which the information about the particular consumer comprises information about the situation of the consumer including needs for financial products, changes in financial situation, changes in financial products that belong to the consumer.

40. The method of claim 35 in which the providing of the information to the consumer comprises sending a text, email, push in-application message, or a combination of two or more of them.

41. The method of claim 35 in which the selecting of a set of financial products comprises matching a combination of preferences and putative prices to optimize putative prices and features of the financial products.

42. The method of claim 35 in which the information about the particular consumer is indicative of the suitability for the consumer of certain products available in the competitive marketplace.

43. The method of claim 35 in which the selecting of a set of financial products is done algorithmically.

44. The method of claim 35 in which the selecting of a set of financial products comprises applying a machine learning process to cluster and group profiles of consumers and products, and matching the profiles to products.

45. A computer-implemented method comprising
serving from a server through a communication network to users of two different respective websites interactive user interface elements that portray financial products that are available on the market to particular customers, the suitability of the financial products for the particular customers, and putative prices for the financial products, and
presenting the interactive user interface elements with an appearance that conforms to respective branded appearances of other user interface elements that are presented by the respective websites, the respective branded appearances being associated with two different host entities.

46. The method of claim 45 in which presenting the interactive user interface elements comprises presenting a digital assistant through the interface of a mobile device.

47. The method of claim 45 in which a relationship between each of the host entities and its particular customers comprise employer and employee, financial advisors and customers being advised, or an entity whose purpose is to save money for its customers.

48. The method of claim 45 in which user interface elements included within the interactive of user interface are determined at least in part by each of the host entities.

49. The method of claim 45 in which the server is operated so that personal information about customers using the websites cannot be accessed by or delivered to third parties.

50. The method of claim 45 that comprising exposing a secured API through which each of the host entities can access information stored at the server.

51. A method comprising
maintaining input data that represents known characteristics of consumers of financial products,
generating output data that represents synthetic good decisions about acquiring or using available financial products or product features, the synthetic good decisions corresponding to respective clusters of the consumers based on the input data,
applying machine learning techniques to develop matching algorithms to match the input data to the output data that represents synthetic good decisions, and
using the developed matching algorithms to suggest good decisions about financial products to consumers based on their characteristics.
